(19) United States
(12) Patent Application Publication
(10) Pub. No.: US 2007/0259161 A1
(43) Pub. Date: Nov. 8, 2007

(54) Anti-Reflection Film and Polarizing Plate and Image Display Comprising Same

(75) Inventor: Shinya Kato, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/661,089

(22) PCT Filed: Aug. 25, 2005
(86) PCT No.: PCT/JP05/15955

§ 371 Date: Feb. 26, 2007

(30) Foreign Application Priority Data
Aug. 27, 2004 (JP) 2004-248501

(51) Int. Cl. G02B 1/11; B32B 7/02; G02B 5/30

(52) U.S. Cl. 428/212; 427/163.1; 428/447

(57) ABSTRACT

An anti-reflection film having excellent anti-reflection properties, a good white color and an excellent viewability is provided. The anti-reflection film has a transparent support and an anti-reflection layer containing at least one thin layer having a refractive index different from that of the transparent support such that the average value of specular reflectance is kept not greater than a specific value. The total amount I of scattering light from the surface of the anti-reflection film and the amount I₅₀ of light scattered in a specific direction satisfy a specific relationship.

### TECHNICAL FIELD

The present invention relates to an anti-reflection film, a polarizing plate comprising the anti-reflection film as at least one surface protective film and an image display comprising the polarizing plate.

### BACKGROUND ART

An anti-reflection film is disposed on the surface of the screen of various image displays such as liquid crystal display (LCD), plasma display panel (PDP), electroluminescence display (ELD) and cathode ray tube display (CRT) to prevent the drop of contrast due to the reflection of external light or image. To this end, the anti-reflection film is required to have a high transmission, a high physical strength (scratch resistance, etc.), a high chemical resistance and a high weathering resistance (heat and moisture resistance, light-resistance, etc.) besides high anti-reflection properties.

The anti-reflection layer to be incorporated in the anti-reflection film has heretofore been formed by a single or multi-layer thin film. The single thin film, if used, may be prepared by forming a layer (low refractive index layer) having a lower refractive index than that of the substrate to have an optical thickness of one fourth of the designed wavelength. In the case where further reduction of occurrence of reflection is needed, a layer (high refractive index layer) having a higher refractive index than that of the substrate may be formed between the substrate and the layer having a low refractive index layer.

As the multi-layer anti-reflection film there has been heretofore used a multi-layer film prepared by depositing thin transparent films of metal oxide on each other. In order to form thin transparent films of metal oxide, a chemical vapor deposition method (CVD) or a physical vapor deposition method (PVD), particularly vacuum deposition method, which is one of physical vapor deposition methods, has been heretofore used.

The multi-layer anti-reflection film may be formed also by a wet coating method. It has been keenly desired to form an anti-reflection layer by a wet coating method, which is suitable for mass production and cost reduction as compared with vacuum deposition method.

In the case where an anti-reflection film is prepared by a wet coating method, a coating composition prepared by dissolving or dispersing a film-forming composition having a refractive index in a solvent is coated over a substrate, dried, and then optionally cured.

Many examples wherein a fluorine-containing material or inorganic material is used as a material having a low refractive index to form a low refractive index layer have been disclosed.

It has been proposed that an inorganic particulate having a high refractive index be more finely divided and incorporated in a film in order that a high refractive index layer might be formed by a wet coating method (see, e.g., JP-A-2001-188104, JP-A-2003-262702, JP-A-2002-286907 and JP-A-2003-292831).

When the anti-reflection film prepared by a wet coating method is applied to an image display, however, it has heretofore been disadvantageous in that when the display is viewed obliquely, the black display looks white-colored black or gray. This phenomenon is expressed by the term “ill-settled black”, “ill-highlighted black”, “ill-toned and concentrated black”, “white-colored black” or “poor white color”. On the contrary, when black looks inherent black, this phenomenon is expressed by the term “well-settled black”, “well-highlighted black”, “non-highlighted black”, “well-toned and concentrated black”, “black-looking black” or “good white color”. This trouble leads to deterioration of contrast, even to impairment of high quality feeling and fidelity of display.

On the other hand, a technique of suppressing white color is disclosed in the art of anti-glare film or anti-glare anti-reflection film comprising an uneven surface for preventing reflection (see, e.g., JP-A-2001-281402, JP-A-2001-281403 and JP-A-2003-222713).

In recent years, there has been a growing demand for larger size and higher precision, i.e., higher quality in image displays. Therefore, it has been keenly desired to improve the white color of the anti-reflection film to be incorporated in the outermost layer of image display and render the color of reflected light neutral.

### DISCLOSURE OF THE INVENTION

An object of an illustrative, non-limiting embodiment of the invention is to provide an anti-reflection film that exhibits high anti-reflection properties, a good white color and an excellent viewability when incorporated in image displays.

Another object of an illustrative, non-limiting embodiment of the invention is to provide a method of producing such an anti-reflection film having excellent properties.

A further object of an illustrative, non-limiting embodiment of the invention is to provide a polarizing plate with anti-reflection properties having high anti-reflection properties, a good white color and an excellent viewability.

A further object of an illustrative, non-limiting embodiment of the invention is to provide an image display that is subjected to anti-reflection treatment to exhibit high anti-reflection properties, a good white color and an excellent viewability.

As a result of studies, the inventors found that the “poor white color” of an anti-reflection film can be eliminated to improve the “white color” when the total amount of scattering light from the surface of the anti-reflection film with respect to incident light in an incident direction and the amount of scattering light in a direction amond all the scattering light satisfy a relationship.

As a result of further studies, the inventors found that the “white color” can be further improved by providing the outermost surface of the anti-reflection film on the anti-reflection layer side thereof with a shape. The inventors consider that the “poor white color” is attributed to the fact that when the organic material, particularly fluorine-containing material, and the inorganic material to be used in the formation of the low refractive index layer as outermost surface of anti-reflection film are compounded, the inorganic material undergoes unnecessary agglomeration that causes the occurrence of fine roughness on the surface of the film on which light are excessively scattered and enter the area that should look black. It was further found that the shape can be attained by (a) the incorporation of specific inorganic particulate material in the low refractive index layer and the surface treatment of the inorganic particulate material and (b) the control over the drying speed.

As a result of further studies, it was further found that the “white color” is affected also by the internal scattering attributed to the high refractive index layer. It was therefore found that the incorporation of an inorganic particulate material having a range of size in the high refractive index layer makes it possible to further improve the “white color”.

In other words, the aforementioned objects of the invention are accomplished by the following constitutions.

(1) An anti-reflection film comprising:

a transparent support; and

an anti-reflection layer comprising at least one thin layer having a refractive index different from that of the transparent support,

wherein

the anti-reflection film has an average value of specular reflectance of 3% or less, and

scattering light from a surface of the anti-reflection film, with respect to incident light in an incident direction of −10° from a line normal to a surface of the transparent support, satisfy a relationship (1):
−Log(I₅₀/I)≧6.6
wherein I represents a total amount of the scattering light, and I₅₀ represents an amount of light scattered in a direction of +50° from the line normal to the surface of the transparent support.

(2) The anti-reflection film as defined in Clause (1), which has an outermost surface (a outer most surface on the anti-reflection layer-forming side) having: an arithmetic average roughness Ra of from 0.1 to 15 nm; a ratio of a ten point-average roughness Rz to the arithmetic average roughness Ra of 15 or less, and an average inclination angle of an unevenness profile of 3° or less.

(3) The anti-reflection film as defined in Clause (1) or (2), wherein the at least one thin layer comprises a low refractive index layer having a lower refractive index than that of the transparent support.

(4) The anti-reflection film as defined in Clause (3), wherein the low refractive index layer is a cured film formed by coating a low refractive index layer-forming composition comprising at least one selected from the group consisting of a thermosetting composition and a radiation-curable composition.

(5) The anti-reflection film as defined in any one of Clauses (1) to (4), wherein the average value of specular reflectance is 1% or less.

(6) The anti-reflection film as defined in Clause (3) or (4), wherein the low refractive index layer has a refractive index of from 1.20 to 1.49.

(7) The anti-reflection film as defined in any one of Clauses (3), (4) to (6), wherein a difference in refractive index between the low refractive index layer and a layer adjacent to the low refractive index layer is from 0.16 to 1.3.

(8) The anti-reflection film as defined in any one of Clauses (3), (4), (6) and (7), wherein the at least one thin layer further comprises at least one high refractive index layer having a higher refractive index than that of the transparent support, and the at least one high refractive index layer is between the transparent support and the low refractive index layer.

(9) The anti-reflection film as defined in any one of Clauses (3), (4) and (6) to (8), wherein

the at least one thin layer has a three-layer structure comprising: the low refractive index layer; a high refractive index layer having a higher refractive index than that of the transparent support; and a middle refractive index layer having an intermediate refractive index between refractive indexes of the transparent support and the high refractive index layer,

the anti-reflection film has such an arrangement that the transparent support, the middle refractive index layer, the high refractive index layer, and the low refractive index layer are stacked in this order, and

the middle refractive index layer, the high refractive index layer and the low refractive index layer satisfy relationships (2), (3) and (4), respectively, with respect to a designed wavelength λ of 400 to 680 nm:
(λ/4)×0.80<n₁d₁<(λ/4)×1.00 (2)
(λ/2)×0.75<n₂d₂<(λ/2)×0.95 (3)
(λ/4)×0.95<n₃d₃<(λ/4)×1.05 (4)
wherein n₁ represents a refractive index of the middle refractive index layer; d₁ represents a thickness in nm of the middle refractive index layer; n₂ represents a refractive index of the high refractive index layer; d₂ represents a thickness in nm of the high refractive index layer; n₃ represents a refractive index of the low refractive index layer; and d₃ represents a thickness in nm of the low refractive index layer.

(10) The anti-reflection film as defined in any one of Clauses (1) to (9), wherein specularly reflected light having a wavelength of from 380 nm to 780 nm, with respect to incident light having an incident angle of 5° from a CIE standard light source D65, has a* and b* values falling within ranges of from −8 to 8 and from −10 to 10, respectively, in CIE1976L*a*b* color space.

(11) The anti-reflection film as defined in any one of Clauses (3), (4), and (6) to (10), wherein the low refractive index layer comprises a particulate inorganic material having an average particle diameter of from 5 to 100 nm in an amount of from 5 to 80% by weight.

(12) The anti-reflection film as defined in Clause 11, wherein the particulate inorganic material is a material subjected to a treatment for improvement of dispersibility with at least one of a hydrolyzate and partial condensate of an organosilane represented by formula (1):
(R¹¹)_{α}—Si(Y¹¹)_{4-α}
wherein R¹¹ represents a substituted or unsubstituted alkyl or aryl group: Y¹¹ represents a hydroxyl group or hydrolyzable group; and α represents an integer of from 1 to 3.

(13) The anti-reflection film as defined in Clause 12, wherein the treatment for improvement of dispersibility is performed in the presence of at least one of an acid catalyst and at least one metal chelate compound comprising: at least one selected from the group consisting of alcohol represented by formula R⁰¹OH and a compound represented by formula R⁰²COCH₂COR⁰³ as a Igand; and a metal selected from the group consisting of Zr, Ti and Al as a central metal, wherein R⁰¹ represents a C₁-C₁₀ alkyl group, R⁰² represents a C₁-C₁₀ alkyl group; and R⁰³ represents a C₁-C₁₀ alkyl or alkoxy group.

(14) The anti-reflection film as defined in any one of Clauses (11) to (13), wherein the particulate inorganic material has a hollow structure.

(15) The anti-reflection film as defined in any one of Clauses (1) to (14), wherein the anti-reflection layer is a cured layer formed by drying at a rate of from 0.10 to 1.5 g/m² at a drying step.

(16) The anti-reflection film as defined in any one of Clauses (3), (4) and (6) to (15), which comprises an overcoat layer as an outermost layer, the overcoat layer comprising at least one compound selected from the group consisting of a fluorine-containing compound, a silicon-containing compound and a long chain alkyl-containing compound having four or more carbon atoms.

(17) The anti-reflection film as defined in any one of Clauses (8) to (16), wherein

the high refractive index layer comprises an inorganic particulate material comprising mainly titanium dioxide, the titanium dioxide containing at least one selected from the group consisting of cobalt, aluminum and zirconium, and

the high refractive index layer has a refractive index of from 1.55 to 2.50.

(18) The anti-reflection film as defined in any one of Claims (8) to (17), wherein the average primary particle diameter of the inorganic particulate material contained in the high refractive index layer is from 5 to 100 nm and there are incorporated no coarse particles having a primary particle diameter of 150 nm or more.

(19) A method of producing an anti-reflection film as defined in Clauses (1) to (18).

(20) A polarizing plate comprising: a polarizing layer; and at least one protective film, wherein the at least one protective film is an anti-reflection film as defined in any one of Clauses (1) to (18).

(21) A polarizing plate comprising: a polarizing layer; and two protective film, wherein one of the two protective film is an anti-reflection film as defined in any one of Clauses (1) to (18), and the other of the two protective film is an optically anisotropic optical compensation film.

(22) An image display comprising at least one of an anti-reflection film as defined in any one of Clauses (1) to (18) and a polarizing plate as defined in Clause (20) or (21), which is disposed on a surface of the image display.

(23) The image display as defined in Clause (22), which is a liquid crystal display, wherein the liquid crystal display is one of TN, STN, VA, IPS and OCB mode liquid crystal displays and is one of transmission type, reflection type and semi-transmission type liquid crystal displays.

The anti-reflection film of the invention is controlled so as to cause little scattering of light by the outermost surface of the low refractive index layer and thus exhibits high anti-reflection properties. An image display including the anti-reflection film of the invention exhibits a good white color and an excellent viewability. The anti-reflection film of the invention is also excellent in the neutrality of color of reflected light, the strength and the durability.

Further, a polarizing plate including the anti-reflection film of the invention as a surface protective film forms a polarizing plate including an anti-reflection film excellent in optical properties, physical strength and weathering resistance which can be provided on a large scale at low cost.

Moreover, the image display of the invention includes the aforementioned anti-reflection film or polarizing plate having excellent properties and thus exhibits excellent anti-reflection properties, viewability and display quality.

### BRIEF DESCRIPTION OF THE DRAWINGS

FIG. 1 is a sectional view diagrammatically illustrating a polarizing plate of an illustrative, non-limiting embodiment of the invention, in which the multi-layer anti-reflection film is used as a protective film on one side of the polarizing plate.

FIG. 2 is an illustrative, non-limiting example of the device configuration for use in the formation of a plurality of thin optical layers of the anti-reflection film of the invention at one step of feeding the support film, forming various thin optical layers and winding the film.

### DETAILED DESCRIPTION OF THE INVENTION

Exemplary Embodiments of the invention will be further described hereinafter.

<Layer Structure of Anti-Reflection Film>

An anti-reflection film of the invention is formed by providing on a transparent support an anti-reflection film including at least one thin layer having a refractive index different from that of the transparent support. Exemplary examples of the structure of the anti-reflection film will be described hereinafter in connection with the attached drawings.

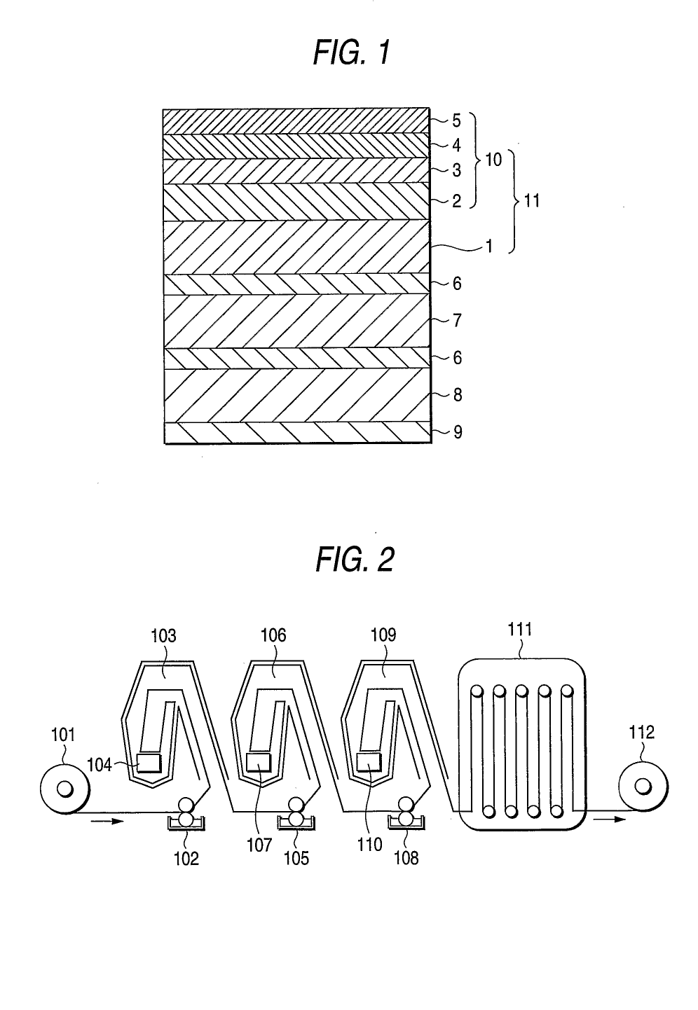

FIG. 1 is a sectional view giving an exemplary illustration of a polarizing plate having a multi-layer anti-reflection film having excellent anti-reflection properties provided on one side of the polarizing plate as a surface protective film (It is sometimes referred to as a “protective film” in the specification). A multi-layer anti-reflection film 11 comprises a transparent support 1 and an anti-reflection layer 10 formed on the surface thereof, the anti-reflection layer 10 including a hard coat layer 2, a middle refractive index layer 3, a high refractive index layer 4 and a low refractive index layer (outermost layer) 5 stacked in this order. The refractive index of the transparent support 1, the middle refractive index layer 3, the high refractive index layer 4 and the low refractive index layer 5 satisfy the following relationship:

Refractive index of high refractive index layer > refractive index of middle refractive index layer > refractive index of transparent support > refractive index of low refractive index layer

(Properties of Anti-Reflection Film)

(Relationship of refractive index and thickness of various layers)

In the layer structure as shown in FIG. 1, it is preferred that the middle refractive index layer, the high refractive index layer and the low refractive index layer satisfy the following numerical relationships (2′), (3′) and (4′), respectively, because an anti-reflection film 11 having better anti-reflection properties can be prepared as disclosed in JP-A-59-50401.
(m₁λ/4)×0.7<n₁d₁<(m₁λ/4)×1.3 (2′)
wherein m₁ represents a positive integer (normally 1, 2 or 3); n1 represents the refractive index of the middle refractive index layer; d1 represents the thickness (nm) of the middle refractive index layer; and λ represents the wavelength (nm) of visible light ranging from 380 nm to 680.
(m₂λ/4)×0.7<n₂d₂<(m₂λ/4)×1.3 (3′)
wherein m₂ represents a positive integer (normally 1, 2 or 3); n₂ represents the refractive index of the middle refractive index layer; d₂ represents the thickness (nm) of the middle refractive index layer; and λ represents the wavelength (nm) of visible light ranging from 380 nm to 680.
(m₃λ/4)×0.7<n₃d₃<(m₃λ/4)×1.3 (4′)
wherein m₃ represents a positive odd integer (normally 1); n₃ represents the refractive index of the middle refractive index layer; d₃ represents the thickness (nm) of the middle refractive index layer; and λ represents the wavelength (nm) of visible light ranging from 380 nm to 680.

In the layer structure as shown in FIG. 1, it is particularly preferred that the middle refractive index layer, the high refractive index layer and the low refractive index layer satisfy the following numerical relationships (2), (3) and (4), respectively. In these numerical relationship, λ is a designed wavelength ranging from 400 to 480 nm.
(λ/4)×0.80<n₁d₁<(λ/4)×1.00 (2)
(λ/2)×0.75<n₂d₂<(λ/2)×0.95 (3)
(λ/4)×0.95<n₃d₃<(λ/4)×1.05 (4)
(Amount of Light Scattered by Anti-Reflection Film)

In the invention, the total amount I of scattering light from the surface of the anti-reflection film in a specified incident direction and the amount of scattering light in a specified direction amond all the scattering light satisfy the following numerical relationship (1):
−Log(I₅₀/I)≧6.6 (1)

The amount of scattering light can be measured using a Type GP-5 goniophotometer (produced by MURAKAMI COLOR RESEARCH LABORATORY). As a light source there is used a halogen lamp (12 V, 50 W). I₅₀ is the amount of scattering light that is scattered from the surface of the anti-reflection film and in the direction of +500 from the line normal to the surface of the transparent support with respect to incident light in the direction of −10° from the line normal to the surface of the transparent support of the anti-reflection film. The total amount I of scattering light from the surface of the anti-reflection film with respect to the incident light is determined using a standard white plate. The total amount of scattering light from the surface of the standard white plate in the direction of from −85° to +95° from the line normal to the surface of the standard white plate is measured with respect to incident light in the incident direction of −10° from the line normal to the surface of the standard white plate.

In the invention, it is necessary that the value of −Log(I₅/I) be 6.6 or more, preferably 6.7 or more, more preferably 6.8 or more. When the value of −Log(I₅₀/I) falls below the above defined range, the resulting black display looks white-colored black or gray when viewed obliquely, making it impossible to attain a good viewability and a desired display quality.

(Surface Roughness and Average Inclination Angle of Anti-Reflection Film)

The outermost surface of the anti-reflection film of the invention preferably exhibits an arithmetic average roughness (Ra) of from 0.1 to 15 nm, more preferably from 0.1 to 10 nm, even more preferably from 0.5 to 10 nm, a ten point-average roughness/arithmetic average roughness ratio (Rz/Ra) of 15 or less, more preferably 12 or less, even more preferably 10 or less, and an unevenness profile average inclination angle (average angle of inclination with respect to specular surface) of 3° or less, more preferably 2.5° or less, even more preferably 2.0° or less. Most preferably, Ra is 7 or less and the average inclination angle is 2.0° or less. When Ra, Rz/Ra and the average inclination angle fall within the above defined range, the generation of white color due to the effect of surface unevenness can be inhibited, making it possible to give a good viewability and display quality.

The shape of surface unevenness of the anti-reflection film can be evaluated by “Micromapping” machine produced by Ryoka System Inc. or a Type SPI3800 scanning probe microscope (produced by Seiko Instruments Inc.).

There are some other measuring instruments. By way of example, a method of measuring the surface unevenness using a Type SPI3800 scanning probe microscope (produced by Seiko Instruments Inc.) will be described below.

The average inclination angle is the average of the height of the change of the average radius of islands (raised portion in unevenness) as calculated in terms of angle. In some detail, the average inclination angle is determined in the following procedure.

(1) The number N of islands and the total area S_{T} at a certain height are determined.

(2) The average S_{V} of the area of islands is determined.
S_{V}=S_{T}/N
(3) Supposing that the islands are circles, the average R_{V} of the radius of the islands is determined.

$${R}_{v} = \sqrt{\frac{{S}_{v}}{π}}$$

(4) With the height Z being varied, the steps (1) to (3) are repeated to determine the average radius R_{V}(Z) at various heights Z.
(5) The change ΔR_{V}(Z) of R^{V}(Z) with minute height ΔZ is determined. The change is then averaged over all the heights H (=maximum height difference).

$${R}_{VH} = \frac{1}{H} {\int }_{0}^{H} \vert \frac{ⅆ {R}_{v} ( Z )}{ⅆ Z} \vert ⅆ Z ( = \frac{1}{H} {\int }_{0}^{H} \vert \frac{ⅆ}{ⅆ Z} \sqrt{\frac{{S}_{T} ( Z )}{π \cdot N ( Z )}} \vert ⅆ Z )$$

(6) RVH is converted to average inclination angle (Δa).
Δa=acrctan(R_{VH}/ΔZ)
(Average Specular Reflectance and Color)

The specular reflectance of the anti-reflection film of the invention with respect to light incident thereon at an angle of 5° is 3.0% or less when averaged over a wavelength range of from 450 nm to 650 nm. When the average specular surface of the anti-reflection film falls within the above defined range, the deterioration of viewability due to reflection of external light on the surface of the display can be inhibited to a sufficient extent. The average specular reflectance is preferably 2% or less, more preferably 1% or less, particularly 0.8% or less.

Further, when the specularly reflected light in the wavelength range of from 380 nm to 780 nm with respect to light from CIE standard light source D₆₅ incident at an angle of 5° has a specific color, that is, a* and b* values fall within a range of from −8 to 8 and from −10 to 10, respectively, in CIE1976L*a*b* color space, the purplish red to purplish blue color of reflected light, which has been a problem with the related art multi-layer anti-reflection film, can be eliminated. Moreover, such a color can be drastically eliminated when a* and b* values fall within a range of from 0 to 6 and from −8 to 0, respectively, in CIE1976L*a*b* color space. A liquid crystal display comprising such an anti-reflection film incorporated therein gives a neutral and inoffensive color when it slightly reflects external light having a high luminance such as light from indoor fluorescent lamp.

In some detail, when a* is not greater than 8, the red color is not too strong to advantage. Further, when a* is not smaller than −8, the cyan color is not too strong to advantage. Moreover, when b* is not smaller than −8, the blue color is not too strong to advantage. When b* is not greater than 0, the yellow color is not too strong to advantage.

For the measurement of specular reflectance and color, a Type V-550 spectrophotometer (produced by JASCO) having a Type ARV-474 adapter attached thereto is used. The specular reflectance with respect to light which are incident at an angle of 5° and then reflected at an angle of −5° is measured in the wavelength range of from 380 nm to 780 nm. The average reflectance over a wavelength range of from 450 nm to 650 nm is then calculated to evaluate the anti-reflection properties. The reflection spectrum thus measured can be used to calculate L*, a* and b* values in CIE1976L*a*b* color space, which represents the color of specularly reflected light with respect to light from CIE standard light source D₆₅ incident at an angle of 5°, making it possible to evaluate the color of reflected light.

(Refractive Index of Anti-Reflection Layer)

For the measurement of the refractive index of the anti-reflection layer, various refractive layers are each formed on an optical substrate having a refractive index of 0.1 or more such as glass sheet. Using a Type V-550 spectrophotometer (produced by JASCO) having a Type ARV-474 adapter attached thereto, these refractive layers are each then measured for specular reflectance with respect to light which are incident at an angle of 5° and then reflected at an angle of −5° in the wavelength range of from 380 to 780 nm. The measurements are then subjected to fitting using a Cauchy model to determine the refractive index of the anti-reflection layer.

The difference in refractive index between the low refractive index layer and the layer adjacent to the low refractive index layer is preferably from 0.16 to 1.3, more preferably from 0.18 to 1.2, even more preferably from 0.20 to 1.0. When the difference of refractive index is 0.16 or more, sufficient anti-reflection properties can be obtained to advantage. Further, when the difference of refractive index is 1.3 or less, proper materials are easily available to advantage.

<Transparent Support>

The anti-reflection film of the invention is formed by forming on a transparent support an anti-reflection layer including at least one thin layer having a refractive index different from that of the transparent support. The light transmittance of the transparent support is preferably 80% or more, more preferably 86% or more. The haze of the transparent support is preferably 2.0% or less, more preferably 1.0% or less. The refractive index of the transparent support is preferably from 1.4 to 1.7.

As the transparent support, a plastic film is preferred to glass sheet. Examples of the material of plastic sheet include cellulose esters (e.g., cellulose triacetate, cellulose diacetate, cellulose propionate, cellulose butyrate, cellulose acetate propionate, nitrocellulose), polyamides, polycarbonates, polyesters (e.g., polyethylene naphthalate, polyethylene naphthalate, poly-1,4-cyclohexane dimethylene terephthalate, polyethylene-1,2-diphenoxyethane-4,4′-dicarboxylate, polybutylene terephthalate), polystyrenes (e.g., syndiotactic polystyrene), polysulfones, polyethersulfones, polyallylates, polyetherimides, polymethyl methacrylates, and polyetherketones. Preferred among these materials are cellulose esters, polycarbonates, polyethylene terephthalates and polyethylene naphthalates.

In the case of application to liquid crystal displays in particular, a film of cellulose acylate, which is an aliphatic ester of cellulose, is preferred among the aforementioned cellulose esters. A cellulose acylate is prepared by the esterification of cellulose. As the cellulose to be used herein there is used one obtained by the purification of linter, kenaf, pulp or the like.

As mentioned above, the cellulose acylate of the invention is an aliphatic acid ester of cellulose. A lower aliphatic acid ester is particularly preferred.

The term “aliphatic acid” as used herein is meant to indicate an aliphatic acid having 6 or less carbon atoms. A cellulose acylate having from 2 to 4 carbon atoms is preferred. Preferred among these cellulose acylates are cellulose acetates. A mixed aliphatic acid ester such as cellulose acetate propionate and cellulose acetate butyrate is preferably used as well.

The viscosity-average polymerization degree (DP) of cellulose acylate is preferably 250 or more, more preferably 290 or more. The cellulose acylate preferably has a sharp molecular weight distribution Mw/Mn (in which Mw is weight-average molecular weight and Mn is number-average molecular weight) as determined by gel permeation chromatography. In some detail, Mw/Mn is preferably from 1.0 to 5.0, more preferably from 1.0 to 3.0, particularly from 1.0 to 2.0.

As the transparent support of the invention there is preferably used a cellulose acylate having an acetylation degree of from 55.0 to 62.5%, more preferably from 57.0 to 62.0%, particularly from 59.0 to 61.5%. The term “acetylation degree” as used herein is meant to indicate the amount of acetic acid bonded per unit weight of cellulose. The acetylation degree is determined by the measurement and calculation of acylation degree according to ASTM: D-817-91 (testing method on cellulose acylate, etc.).

A cellulose acylate tends to have hydroxyl group substituted less in the 6-position rather than uniformly in the 2-position, 3-position and 6-position. The cellulose acylate to be used in the invention preferably has a cellulose substitution degree in the 6-position which is the same as or greater that that in the 2- and 3-positions. The proportion of the substitution degree in the 6-position in the sum of the substitution degree in the 2-, 3- and 6-positions is preferably from 30 to 40%, more preferably from 31 to 40%, most preferably from 32 to 40%.

The transparent support may comprise various additives incorporated therein for adjusting the mechanical properties (strength, curling resistance, dimensional stability, slipperiness, etc.) and durability (heat moisture resistance, weathering resistance, etc.) of the film. Examples of these additives include plasticizers (e.g., phosphoric acid esters, phthalic acid esters, esters of polyol with aliphatic acid), ultraviolet absorbers (e.g., hydroxybenzophenone-based compounds, benzotriazole-based compounds, salicylic acid ester-based compounds, cyano acrylate-based compounds), deterioration inhibitors (e.g., oxidation inhibitors, peroxide decomposers, radical inhibitors, metal deactivators, acid catchers, amines), particulate materials (e.g., SiO₂, Al₂O₃, TiO₂, BaSO₄, CaCO₃, MgCO₃, talc, kaolin), release agents, antistatic agents, and infrared absorbers.

For the details of these materials which are preferably used, reference can be made to Japan Institute of Invention and Innovation's Kokai Giho No. 2001-1745, issued on Mar. 15, 2001, pp. 17 to 22. The amount of the additives to be incorporated is preferably from 0.01 to 20% by weight, more preferably from 0.05 to 10% by weight based on the weight of the transparent support.

The transparent support may be subjected to surface treatment.

Examples of the surface treatment include chemical treatment, mechanical treatment, corona discharge treatment, flame treatment, ultraviolet irradiation, high frequency treatment, glow discharge treatment, active plasma treatment, laser treatment, mixed acid treatment, and ozone oxidation. For the details of these surface treatment methods, reference can be made to Japan Institute of Invention and Innovation's Kokai Giho No. 2001-1745, issued on Mar. 15, 2001, pp. 30 to 31, JP-A-2001-9973, etc.

Preferred among these surface treatment methods are glow discharge treatment, ultraviolet irradiation, corona discharge treatment and flame treatment, more preferably glow discharge treatment and ultraviolet treatment.

<Anti-Reflection Layer>

(High Refractive Index Layer)

The aforementioned high refractive index layer of the invention is composed of a cured film having a refractive index of from 1.55 to 2.50 formed by spreading a curable composition (hereinafter occasionally referred to as “high refractive index-forming composition) having an inorganic particulate compound (hereinafter occasionally referred to as “high refractive inorganic material”) and a matrix binder incorporated therein. The refractive index of the cured film is more preferably from 1.65 to 2.40, particularly from 1.70 to 2.20.

The surface of the high refractive index layer preferably forms a surface unevenness having such a fineness as to give no optical effects and has an arithmetic average surface roughness (Ra) of from 0.001 to 0.03 μm, more preferably from 0.001 to 0.015 μm, particularly from 0.001 to 0.010 μm as determined according to JIS B-0601-1994, a ten point-average roughness (Rz) of from 0.001 to 0.06 μm, more preferably from 0.002 to 0.05 μm, particularly from 0.002 to 0.025 μm and a maximum height (Ry) of 0.09 μm or less, more preferably 0.05 μm, particularly 0.04 μm or less.

Referring to the aforementioned surface unevenness having such a fineness as to give no optical effects, it is preferred that the ratio (Rz/Rz) of ten point-average roughness (Rz) to arithmetic average roughness (Ra) be 15 or less and the average interval (Sm) of surface unevenness of the high refractive index layer determined according to JIS B-0601-1994 be from 0.01 to 1 μm. The relationship between Ra and Rz indicates the uniformity of surface unevenness. The ratio (Rz/Ra) is more preferably 12 or less, even more preferably 7 or less. The average interval (Sm) is more preferably from 0.01 to 0.8 μm. When these factors fall within the above defined range, the surface conditions of the low refractive index layer spread over the high refractive index layer are so good as to show no defectives such as unevenness and streaking, enhancing white color. Further, the adhesion between the two layers can be enhanced. The shape of fallen portion and raised portion on the surface of the layer can be evaluated by atomic force microscope.

In order to form a high refractive cured layer having a refractive index of from 1.55 to 2.50 comprising a high refractive particulate material dispersed in a matrix binder, the mixing proportion of the particulate material is preferably from 40 to 80% by weight, more preferably from 45 to 75% by weight based on the total weight of the cured layer although it is determined by the refractive index of the particulate material used because the refractive index of a matrix binder is normally from 1.4 to 1.5.

In order that the mixing proportion of the high refractive particulate material is raised to enhance the strength of the high refractive index layer to be designed and the adhesion to the upper layer to be subsequently provided thereon, it is preferred that as the high refractive particulate material there be used one having an extremely small particle diameter and a uniform particle size, the particulate material be uniformly dispersed in the high refractive index layer and the layer thus formed have the aforementioned unevenness conditions. By predetermining the shape and distribution of unevenness of the entire surface of the high refractive index layer to fall within a specified range, the low refractive index layer, even if continuously provided as an upper layer on a film of continuous length, can be entirely and uniformly anchored to the high refractive index layer to improve the white color and keep the desired adhesion to advantage. Even after prolonged storage, there shows no change of adhesion to advantage.

The adhesion between the cured film of the high refractive index layer and the upper layer (low refractive index layer) provided thereon in the invention is preferably such that the abrasion loss in a Taber abrasion test according to JIS K-6902 is 50 mg or less, more preferably 40 mg or less. In some detail, Taber abrasion index is the abrasion loss after 500 rotations at a load of 1 Kg. When the abrasion loss falls within the above defined range, the resulting anti-reflection layer can be provided with a sufficient scratch resistance to advantage.

Referring to the anti-reflection layer comprising a high refractive index layer having the aforementioned surface shape, the number of brightness defects having a size of 50 μm or more, which are visually appreciable foreign matters, is preferably 20 or less per m²

(High Refractive Index Layer-Forming Composition)

(High Refractive Particulate Material)

The high refractive particulate material to be incorporated in the high refractive index layer preferably has a refractive index of from 1.80 to 2.80, more preferably from 1.90 to 2.80 and an average primary particle diameter of from 3 to 100 nm, more preferably from 5 to 100 nm, particularly from 10 to 80 nm. When the refractive index of the high refractive index layer is 1.80 or more, the refractive index of the high refractive index layer can be effectively enhanced to advantage. When the refractive index of the high refractive index layer is 2.80 or less, there occur no defectives such as coloration of particles to advantage. Further, when the average primary particle diameter of the high refractive particulate material is 100 nm or less, the resulting high refractive index layer shows no defectives such as loss of clarity dye to the rise of haze to advantage. When the average primary particle diameter of the high refractive particulate material is 3 nm or more, the resulting high refractive index layer can be provided with a high refractive index to advantage.

The particle diameter of the high refractive index layer is represented by the average primary particle diameter determined on photograph taken under transmission electron microscope (TEM). The average primary particle diameter is represented by the maximum average diameter of the particles. In the case where the particles have a major axis diameter and a minor axis diameter, the average of the major axis diameter of the particles is defined as average primary particle diameter.

Specific preferred examples of the high refractive particulate material employable herein include particles comprising as main components oxide, composite oxide and sulfide of titanium, zirconium, tantalum, indium, neodymium, tin, antimony, zinc, lanthanum, tungsten, cerium, niobium, vanadium, samarium and yttrium. The term “main components” as used herein is meant to indicate the components constituting the particle which are present in the highest content (% by weight). The high refractive particulate material which can be preferably used in the invention is a particulate material comprising as a main component an oxide or composite oxide comprising at least one metal element selected from the group consisting of titanium, zirconium, tantalum, indium and tin.

The high refractive particulate material to be used in the invention may comprise various elements (hereinafter occasionally referred to as “constituent elements”) incorporated therein. Examples of these constituent elements include lithium, tin, aluminum, boron, barium, cobalt, iron, mercury, silver, platinum, gold, chromium, bismuth, phosphorus, and sulfur. A high refractive particulate material such as particulate tin oxide and indium oxide preferably comprises constituent elements such as antimony, neodymium, phosphorus, boron, indium, vanadium and halogen incorporated therein to enhance the electrical conductivity thereof. Most preferably, antimony oxide is incorporated in the particulate material in an amount of from about 5 to 20% by weight.

A particularly preferred high refractive particulate material which can be used in the invention is an inorganic particulate material comprising as a main component titanium dioxide comprising at least one element selected from the group consisting of cobalt, zirconium and aluminum (hereinafter occasionally referred to as “specified oxide”). A particularly preferred constituent element is cobalt. The total content of cobalt, aluminum and zirconium is preferably from 0.05 to 30% by weight, more preferably from 0.1 to 10% by weight, even more preferably from 0.2 to 7% by weight, particularly from 0.3 to 5% by weight, most preferably from 0.5 to 3% by weight based on the weight of titanium. The constituent elements cobalt, aluminum and zirconium are present in the interior or on the surface of the high refractive particulate material comprising titanium dioxide as a main component. These constituent elements are preferably present in the interior of the high refractive particulate material comprising titanium dioxide as a main component, most preferably both in the interior and on the surface of the high refractive particulate material comprising titanium dioxide as a main component. Among these constituent elements, the metal elements may occur in the form of oxide.

Other preferred examples of the high refractive particulate material employable herein include particulate composite oxide of titanium with at least one metal element (hereinafter occasionally referred to as “Met”) selected from the group consisting of metal elements which exhibit a refractive index of 1.95 or more when oxidized, the composite oxide being doped with at least one metal ion selected from the group consisting of cobalt ion, zirconium ion and aluminum ion (hereinafter occasionally referred to as “specified composite oxide”). Examples of the metal elements which exhibit a refractive index of 1.95 or more when oxidized include tantalum, zirconium, indium, neodymium, antimony, tin, and bismuth. Particularly preferred among these metal elements are tantalum, zirconium, tin, and bismuth. The content of the metal ions with which the composite oxide is doped is preferably not more than 25% by weight, more preferably from 0.05 to 10% by weight, even more preferably from 0.1 to 5% by weight, most preferably from 0.3 to 3% by weight based on the total amount of all metal elements constituting the composite oxide (Ti+Met) from the standpoint of maintenance of refractive index.

The dope metal ions may occur in the form of metal ion or metal atom. The dope metal ions may be properly present in the region ranging from the surface to the interior of the composite oxide, preferably both on the surface and in the interior of the composite oxide.

The high refractive particulate material to be used in the invention preferably has a crystalline structure. The crystalline structure preferably comprises as a main component rutile, mixture of rutile and anatase or anatase, particularly rutile. In this arrangement, the aforementioned specified oxide or composite oxide which a high refractive particulate material exhibits a refractive index of from 1.90 to 2.80 to advantage. The refractive index of the high refractive particulate material is more preferably from 2.10 to 2.80, even more preferably from 2.20 to 2.80. In this arrangement, the photocatalytic activity of titanium dioxide can be suppressed, making it possible to remarkably improve the weathering resistance of the high refractive index layer of the invention itself and the upper and lower layers adjacent thereto to advantage.

The doping with the aforementioned specified metal elements or metal ions can be accomplished by any known methods. For example, doping can be carried out by the method disclosed in JP-A-5-330825, JP-A-11-263620, JP-T-11-512336 (the term “JP-T” as used herein means a published Japanese translation of a PCT patent application), European Patent Disclosure No. 0335773, etc., or ion implantation method as described in Shunichi Gonda, Junzo Ishikawa, Eiji Kamijo, “Ion Beam Application Technique”, CMC, 1989, Yasu Aoki, “Surface Science”, vol. 18 (5), page 262, 1998, and Shoichi Anpo et al, “Surface Science”, vol. 20 (2), page 60, 1999.

The high refractive particulate material to be used in the invention may be subjected to surface treatment. The surface treatment is intended to modify the surface of the particles with an inorganic compound and/or organic compound, making it possible to adjust the wettability of the surface of the high refractive particulate material and hence improve the fine division of the particulate material in an organic solvent and the dispersibility or dispersion stability of the particulate material in the high refractive index layer-forming composition. Examples of the inorganic compound to be physicochemically adsorbed to the surface of the particulate material include silicon-containing inorganic compounds (e.g., SiO₂), aluminum-containing inorganic compounds (e.g., Al₂O₃, Al(OH)₃), cobalt-containing inorganic compounds (e.g., CoO₂, CO₂O₃, CO₃O₄), zirconium-containing inorganic compounds (e.g., ZrO₂, Zr(OH)₄), and iron-containing inorganic compounds (e.g., Fe₂O₃).

As the organic compounds to be used in the surface treatment there may be used any known surface modifiers for inorganic filler such as metal oxide and inorganic pigment. For the details of these surface modifiers, reference can be made to “Ganryo Bunsan Anteika to Hyoumen Shori Giojutsu/Hyouka (Technique for Stabilization of Pigment Dispersion and Surface Treatment/Evaluation)”, Chapter 1, Technical Information Institute Co., Ltd., 2001.

Specific examples of these surface modifiers include organic compounds comprising a polar group having an affinity for the surface of the high refractive particulate material, and coupling compounds. Examples of the polar group having an affinity for the surface of the high refractive particulate material include carboxyl group, phosphono group, hydroxyl group, mercapto group, cyclic acid anhydride group, and amino group. An organic compound having at least one such a polar group is preferred. Examples of the organic compound include long-chain aliphatic carboxylic acids (e.g., stearic acid, lauric acid, oleic acid, linoleic acid, linolenic acid), polyol compounds (e.g., pentaerythritol triacrylate, dipentaerythritol pentaacrylate, ECD(epichlorohydrin)-modified glycerol triacrylate), phosphono group-containing compounds (e.g., EO(ethylene oxide)-modified phosphoric acid triacrylate), and alkanolamines (e.g., EO adduct (5 mols) of ethylenediamine).

As the coupling compound there may be used any known organic metal compound. Examples of such an organic metal compound include silane coupling agents, titanate coupling agents, and aluminate coupling agents. Most desirable among these organic metal compounds are silane coupling agents. Specific examples of these coupling compounds include those disclosed in JP-A-2002-9908 and JP-A-2001-310423 (paragraphs (0011) to (0015)).

These compounds to be used in the surface treatment may be used in combination of two or more thereof.

The aforementioned high refractive particulate material may be in the form of core/shell particle comprising a shell made of other inorganic compound formed on the high refractive particulate material as core. The shell is preferably made of an oxide of at least one element selected from the group consisting of aluminum, silicon and zirconium. For details, reference can be made to JP-A-2001-166104.

The shape of the aforementioned high refractive particulate material is not specifically limited but is preferably grain, sphere, cube, spindle or amorphous. The aforementioned high refractive particulate material may be used singly. However, two or more high refractive particulate materials may be used in combination.

(Dispersant)

In order to use the aforementioned high refractive particulate material as a stabilized predetermined ultrafine particulate material, a dispersant is preferably used. As such a dispersant there is preferably used a low molecular compound comprising a polar group having an affinity for the surface of the high refractive particulate material or a polymer compound.

Examples of the aforementioned polar group include hydroxyl groups, mercapto groups, carboxyl groups, sulfo groups, phosphono groups, oxyphosphono groups, —P(═O)(OR₁)(OH) groups, —O—P(═O)(OR₁)(OH) groups, amide groups (—CONHR₂, —SO₂NHR₂), cyclic acid anhydride-containing groups, amino groups, and quaternary ammonium groups.

In the aforementioned formulae, R₁ represents a C₁-C₁₈ hydrocarbon group (e.g., methyl group, ethyl group, propyl group, butyl group, hexyl group, octyl group, decyl group, dodecyl group, octadecyl group, chloroethyl group, methoxyethyl group, cyanoethyl group, benzyl group, methyl benzyl group, phenethyl group, cyclohexyl group). R₂ indicates a hydrogen atom or has the same meaning as R₁.

In the aforementioned polar group, the group having a dissociable proton may be in the form of salt thereof. The aforementioned amino group and quaternary ammonium group may be any of primary amino group, secondary amino group and tertiary amino group, preferably tertiary amino group or quaternary ammonium group. The group connected to the nitrogen atom in the secondary amino group, tertiary amino group or quaternary ammonium group is preferably a C₁-C₁₂ aliphatic group (including those listed above with reference to R₁ or R₂). The tertiary amino group may be a cyclic amino group containing nitrogen atom (e.g., piperidine ring, morpholine ring, piperadine ring, pyridine ring). Further, the quaternary ammonium group may be a quaternary ammonium of cyclic amino group. The group connected to the nitrogen atom in the secondary amino group, tertiary amino group or quaternary ammonium group is more preferably a C₁-C₆alkyl group.

Preferred examples of the counter ion of quaternary ammonium group include halide ions, PF₆ ions, SbF₆ ions, BF₄ ions, B(R₃)₄ ions (in which R₃ represents a hydrocarbon group such as butyl group, phenyl group, tollyl group, naphthyl group, butylphenyl group), and sulfonic acid ions.

As the polar group in the aforementioned dispersant there is preferably used an anionic group having pKa of 7 or less or salt of such a dissociable group. Particularly preferred examples of these polar groups include carboxyl groups, sulfo groups, phosphono groups, oxyphosphono groups, and salt of these dissociable groups.

The dispersant preferably further contains a crosslinkable or polymerizable functional group. Examples of the crosslinkable or polymerizable functional group include ethylenically unsaturated groups which can undergo addition reaction/polymerization reaction with radical seeds (e.g., (meth) acryloyl group, allyl group, styryl group, vinyloxy group, carbonyl group, vinyloxy group), cationic polymerizable groups (e.g., epoxy group, thioepoxy group, oxetanyl group, vinyloxy group, spiroorthoester group), and polycondesation reactive groups (hydrolyzable silyl group such as N-methylol group). Preferred among these crosslinkable or polymerizable functional groups are ethylenically unsaturated groups, epoxy groups, and hydrolyzable silyl groups.

Specific examples of these compounds include those disclosed in JP-A-2001-310423, paragraphs (0013) to (0015).

The dispersant to be used in the invention is preferably a polymer dispersant. In particular, a polymer dispersant containing an anionic group and a crosslinkable or polymerizable functional group is desirable. The weight-average molecular weight (Mw) of the polymer dispersant is not specifically limited but is preferably 1×10³ or more, more preferably from 2×10³ to 1×10⁶, even more preferably from 5×10³ to 1×10⁵, particularly from 8×10 to 8×10⁴ in polystyrene equivalence as determined by GPC method. When the weight-average molecular weight Mw of the polymer dispersant falls within the above defined range, the high refractive particulate material can be easily dispersed in the solvent. Further, a stable dispersion which undergoes neither agglomeration nor sedimentation can be obtained to advantage. For details, reference can be made to JP-A-11-153703, paragraphs (0024) to (0041).

(Dispersion Medium)

As the dispersion medium to be used in wet dispersion of the aforementioned high refractive particulate material there may be properly selected from the group consisting of water and organic solvents. A liquid having a boiling point of 50° C. or more is desirable. An organic solvent having a boiling point of from 60° C. to 180° C. is more desirable.

The dispersion medium is preferably used in a proportion such that the amount of all the components constituting the high refractive index layer containing a high refractive particulate material and a dispersant is from 5 to 50% by weight, more preferably from 10 to 30% by weight. When the proportion of the dispersion medium falls within the above defined range, dispersion can easily proceed. The resulting dispersion exhibits a viscosity such that a good workability can be obtained to advantage.

Examples of the dispersion medium employable herein include alcohols, ketones, esters, amides, ethers, etheresters, hydrocarbons, and halogenated hydrocarbons. Specific examples of these dispersion media include alcohols such as methanol, ethanol, propanol, butanol, benzyl alcohol, ethylene glycol, propylene glycol and ethylene glycol monoacetate, ketones such as methyl ethyl ketone, methyl isobutyl ketone, cyclohexanone and methyl cyclohexanone, esters such as methyl acetate, ethyl acetate, propyl acetate, butyl acetate, ethyl formate, propyl formate, butyl formate and ethyl lactate, aliphatic hydrocarbons such as hexane and cyclohexane, halogenated hydrocarbons such as methyl chloroform, aromatic hydrocarbons such as benzene, toluene and xylene, amides such as dimethyl formamide, dimethyl acetamide and n-methylpyrrolidone, ethers such as dioxane, tetrahydrofurane, ethylene glycol dimethyl ether and propylene glycol dimethyl ether, and ether alcohols such as 1-methoxy-2-propanol, ethyl cellosolve and methyl carbitol. These dispersion media may be used singly or in combination of two or more thereof. Preferred among these dispersion media are toluene, xylene, methyl ethyl ketone, methyl isobutyl ketone, cyclohexanone and butanol. Further, coating solvents mainly composed of ketone-based solvents (e.g., methyl ethyl ketone, methyl isobutyl ketone, cyclohexanone) are preferably used. The content of ketone-based solvents is preferably 10% by weight or more, more preferably 30% by weight or more, even more preferably 60% by weight or more based on the total weight of the solvents contained in the high refractive index layer-forming composition.

(Ultrafine Division of High Refractive Particulate Material)

When the curable high refractive index layer-forming composition to be used in the invention is an ultrafine dispersion of an inorganic particulate compound having an average primary particle diameter of 100 nm or less, the liquid stability of the composition can be enhanced. The high refractive index layer which is a cured layer formed by the curable composition comprises a high refractive particulate material finely and uniformly dispersed in the matrix of cured layer to form a transparent high refractive index layer having uniform optical properties. The size of the ultrafine particles present in the matrix of cured layer is such that the average primary particle diameter is preferably from 3 to 100 nm, more preferably from 5 to 100 nm, most preferably from 10 to 80 nm. It is more desirable that coarse particles having a primary particle diameter of 200 nm or more be not included. It is particularly desirable that coarse particles having a particle diameter of 150 nm or more be not included. In this arrangement, the surface of the cured layer of the high refractive index layer can be provided with the aforementioned specified unevenness to advantage. When the high refractive index layer comprises a high refractive particulate material having a size falling within the above defined range, the internal scattering due to the high refractive index layer can be controlled, making it possible to further improve the “white color” to advantage.

The dispersion of the aforementioned high refractive particulate material to an extent such that it is ultrafinely divided into a size excluding the coarse particle range can be attained by subjecting the high refractive particulate material to wet dispersion using a medium having an average particle diameter of less than 0.8 mm with the aforementioned dispersant.

Examples of the wet dispersing machine employable herein include known wet dispersing machines such as sand grinder mill (e.g., bead mill with pin), dinomill, high speed impellor mill, pebble mill, roller mill, attritor and colloid mill. In order to disperse the high refractive particulate material to be used herein to ultrafine particles, sand grinder mill, dinomill and high speed impellor mill are particularly preferred.

The medium to be used with the aforementioned dispersing machine preferably has an average particle diameter of less than 0.8 mm. The use of a medium having an average particle diameter falling within the above defined range makes it possible to keep the particle diameter of the aforementioned high refractive particulate material 100 nm or less and obtain ultrafinely divided particles having a uniform particle diameter. The average particle diameter of the medium is more preferably 0.5 mm or less, even more preferably from 0.05 to 0.3 mm. As the medium to be used in wet dispersion there is preferably used bead. Specific examples of the bead employable herein include zirconia bead, glass bead, ceramic bead, and steel bead. Zirconia bead having a size of from 0.05 to 0.2 mm is particularly preferred from the standpoint of durability against destruction of bead during dispersion and ease of ultrafine division.

The dispersion temperature at the dispersion step is preferably from 20° C. to 60° C., more preferably from 25° C. to 45° C. When the high refractive particulate material is ultrafinely dispersed at a temperature falling within the above defined range, the dispersed particles can be prevented from undergoing reagglomeration and precipitation to advantage. This is presumably because the dispersant is properly adsorbed to the inorganic particulate compound, making it possible to prevent the occurrence of defective in dispersion stability due to desorption of the inorganic particulate compound from the particulate dispersant at ordinary temperature. When the dispersion step is effected at a temperature falling within the above defined range, a high refractive index layer excellent in uniformity in refractive index causing no loss of clarity, strength, adhesion to adjacent layers, etc. can be formed.

The aforementioned wet dispersion step may be preceded by a predispersion step. Examples of the dispersing machine to be used in the predispersion step include ball mill, three-roll mill, kneader, and extruder.

Further, in order to remove coarse agglomerates from the dispersion thus obtained so that the particles dispersed in the dispersion can satisfy the aforementioned requirements for average particle diameter and monodispersibility of particle diameters, it is preferred that a filtering material be provided to precision-filter the beads off. The filtering material for precision filtration preferably comprises filtering particles having a size of 25 μm or less. The type of the filtering material for precision filtration is not specifically limited so far as it has the aforementioned properties. However, filament type, felt type and mesh type filtering materials may be used. The material constituting the filtering material for precision-filtering the dispersion is not specifically limited so far as it has the aforementioned properties and exerts no adverse effects on the resulting high refractive index layer-forming composition. For example, however, stainless steel, polyethylene, polypropylene, nylon, etc. may be used.

(Matrix of High Refractive Index Layer)

The high refractive index layer preferably comprises a high refractive particulate material and a matrix incorporated therein.

In a preferred embodiment, the matrix of the high refractive index layer is formed by spreading a high refractive index layer-forming composition containing at least one of:

(A) an organic binder; and

(B) an organic metal compound containing a hydrolyzable functional group and a partial condensate thereof, and then curing the coat layer.

(A) Organic binder

As the organic binder there may be used a binder formed by (a) a known thermoplastic resin, (b) a combination of known reactive curable resin and curing agent or (c) a combination of a binder precursor (e.g., curable polyfunctional monomer or polyfunctional oligomer described later) and a polymerization initiator.

It is preferred that the organic binder (a), (b) or (c) and the dispersion containing a high refractive particulate material and a dispersant be used to prepare the high refractive index layer-forming composition. The composition thus prepared is spread over a transparent support to form a coat layer which is then cured by a method according to the binder-forming components to form a high refractive index layer. The curing method is properly selected depending on the kind of the binder components. For example, a method which comprises subjecting a curable compound (e.g., polyfunctional monomer or polyfunctional oligomer) to at least one of heating and irradiation with light to cause crosslinking reaction or polymerization reaction thereof may be used. In particular, a method is preferred which comprises irradiating a curable compound comprising an organic binder (c) with light to cause the crosslinking reaction or polymerization reaction of the curable compound to form a cured binder.

Further, it is preferred that the dispersant contained in the dispersion of high refractive particulate material be allowed to undergo crosslinking reaction or polymerization reaction at the same time with or after the spreading of the high refractive index layer-forming composition.

The binder in the cured layer thus prepared comprises anionic groups of the aforementioned binder incorporated therein as a result of the crosslinking reaction or polymerization reaction of the dispersant with the curable polyfunctional monomer or oligomer which is a binder precursor. Further, since the anionic groups of the binder in the cured layer are capable of keeping the high refractive particulate material well dispersed in the binder, the crosslinked or polymerized structure renders the binder capable of forming a film, making it possible to enhance the physical strength, chemical resistance and weathering resistance of the cured layer containing a high refractive particulate material.

{Thermoplastic Resin (A-a)}

Examples of the aforementioned theromoplastic resin (a) include polystyrene resins, polyester resins, cellulose resins, polyether resins, vinyl chloride resins, vinyl acetate resins, vinyl chloride-vinyl oxide copolymer resins, polyacrylic resins, polymethacrylic resins, polyolefin resins, urethane resins, silicone resins, and imide resins.

{Combination of Reactive Curable Resin and Curing Agent (A-b)}

As the aforementioned reactive curable resin (b) there is preferably used a thermosetting resin and/or ionized radiation-curable resin. Examples of the thermosetting resin employable herein include phenolic resins, urea resins, diallyl phthalate resins, melamine resins, guanamine resins, unsaturated polyester resins, polyurethane resins, epoxy resins, amino alkyd resins, melamine-urea cocondensate resins, silicon resins, and polysiloxane resins. Examples of the ionized radiation-curable resin employable herein include resins containing functional groups such as radical-polymerizable unsaturated group {e.g., (meth) acryloyloxy group, vinyloxy group, styryl group, vinyl group} and/or cation-polymerizable group (e.g., epoxy group, thioepoxy group, vinyloxy group, oxetanyl group). Examples of these resins include polyester resins, polyether resins, (meth)acryl resins, epoxy resins, urethane resins, alkyd resins, spiroacetal resins, polybutadiene resins and polythiolpolyene resins having a relatively low molecular weight.

These reactive curable resins are used optionally in combination with a curing agent such as crosslinking agent (e.g., epoxy compound, polyisocyanate compound, polyol compound, polyamine compound, melamine compound), polymerization initiator (e.g., ultraviolet photopolymerization initiator such as azobis compound, organic peroxide compound, organic halogen compound, onium salt compound and ketone compound) and a known compound such as polymerization accelerator (e.g., organic metal compound, acid compound, basic compound). For the details of these compounds, reference can be made to Shinzo Yamashita and Tosuke Kaneko, “Kakyouzai Handobukku (Handbook of Crossinking Agents)”, Taiseisha, 1981.

{Combination of binder precursor and polymerization initiator (A-c)}

As a desirable method of forming a cured binder there will be described hereinafter a method which comprises subjecting a curable compound comprising the aforementioned combination (c) to crosslinking or polymerization reaction by irradiation with light to form a cured binder.

The functional group in the photocurable polyfunctional monomer or polyfunctional oligomer which is a binder precursor may be ether radical-polymerizable or cation-polymerizable.

Examples of the radical-polymerizable functional group include ethylenically unsaturated groups such as (meth)acryloyl group, vinyloxy group, styryl group and allyl group. Preferred among these radical-polymerizable functional groups is (meth)acryloyl group. There is preferably included a polyfunctional monomer containing two or more radical-polymerizable groups per molecule.

The radical-polymerizable polyfunctional monomer is preferably selected from the group consisting of compounds having at least two terminal ethylenically unsaturated bonds. The radical-polymerizable polyfunctional monomer is preferably a compound having from 2 to 6 terminal ethylenically unsaturated bonds per molecule. Such a group of compounds are well known in the art of polymer materials. In the invention, these compounds may be used without any limitation. These compounds may have a chemical morphology such as monomer, prepolymer (i.e., dimer, trimer, oligomer), mixture thereof and copolymer thereof.

Examples of the radical-polymerizable monomers include unsaturated carboxylic acids (e.g., acrylic acid, methacrylic acid, itaconic acid, crotonic acid, isocrotonic acid, maleic acid), and esters and amides thereof. Preferred examples of the radical-polymerizable monomers include esters of unsaturated carboxylic acids with aliphatic polyvalent alcohol compounds, and amides of unsaturated carboxylic acids with aliphatic polyvalent amine compounds.

Further, adducts of unsaturated carboxylic acid esters or amides having a nucleophilic substituent such as hydroxyl group, amino group and mercapto group with monofunctional or polyfunctional isocyanates or epoxies, dehydration condensation reaction products of these unsaturated carboxylic acid esters or amides with polyfunctional carboxylic acids, etc. are preferably used. Moreover, reaction products of unsaturated polyester carboxylic acid esters or amides having an electrophilic substituent such as isocyanate group and epoxy group with monofunctional or polyfunctional alcohols, amines or thiols are preferably used. By way of another example, compounds obtained in the same manner as mentioned above except that the aforementioned unsaturated carboxylic acids are replaced by unsaturated phosphonic acids, styrenes or the like may be used.

Examples of the aliphatic polyvalent alcohol compounds employable herein include alkane diol, alkane triol, cyclohexane diol, cyclohexane triol, inositol, cyclohexane dimethanol, pentaerythritol, glycerin, and diglycerin. Examples of polymerizable ester compounds (monoester or polyester) of these aliphatic polyvalent alcohols with unsaturated carboxylic acids include compounds as disclosed in JP-A-2001-139663, paragraphs (0026)-(0027).

Other preferred examples of polymerizable esters include vinyl methacrylates, allyl methacrylates, allyl acrylates, aliphatic alcohol-based esters as disclosed in JP-B-46-27926, JP-B-51-47334 and JP-A-57-196231, those having an aromatic skeleton as disclosed in JP-A-2-226149, and those having an amino group as disclosed in JP-A-1-165613.

Specific examples of polymerizable amides formed by aliphatic polyvalent amine compound and unsaturated carboxylic acid include methylene bis(meth)acrylamide, 1,6-hexamethylene bis(meth)acrylamide, diethylene triamine tris(meth)acrylamide, xylylene bis(meth) acrylamide, and those having a cyclohexylene structure as disclosed in JP-B-54-21726.

Further, there may be used vinyl urethane compounds having two or more polymerizable vinyl groups per molecule (as disclosed in JP-B-48-41708), urethane acrylates (as disclosed in JP-B-2-16765), urethane compounds having an ethylene oxide skeleton (as disclosed in JP-B-62-39418), polyester acrylates (as disclosed in JP-B-52-30490), and photocurable monomers and oligomers as disclosed in “Journal of the Adhesion Society of Japan”, vol. 20, No. 7, pp. 300-308, 1984.

Two or more of these radical-polymerizable polyfunctional monomers may be used in combination.

The compound containing a cation-polymerizable group which can be used to form the binder for the high refractive index layer (hereinafter also referred to as “cation-polymerizable compound” or “cation-polymerizable organic compound”) will be described hereinafter.

As the cation-polymerizable compound to be used herein there may be used any compound which undergoes polymerization reaction and/or crosslinking reaction when irradiated with active energy rays in the presence of an active energy ray-sensitive cation polymerization initiator. Representative examples of such a compound include epoxy compounds, cyclic thioether compounds, cyclic ether compounds, spiroorthoester compounds, vinyl hydrocarbon compounds, and vinyl ether compounds. In the invention, one or more of the aforementioned cation-polymerizable organic compounds may be used.

The cation-polymerizable group-containing compound preferably has from 2 to 10, particularly from 2 to 5 cation-polymerizable groups per molecule. The molecular weight of the cation-polymerizable group-containing compound is 3,000 or less, preferably from 200 to 2,000, particularly from 400 to 1,500. When the molecular weight of the cation-polymerizable group-containing compound is not smaller than the lower limit, no defectives such as evaporation at the film-forming step can occur. When the molecular weight of the cation-polymerizable group-containing compound is not greater than the upper limit, no problems such as deterioration of compatibility with the high refractive index layer-forming composition arise.

Examples of the aforementioned epoxy compounds include aliphatic epoxy compounds and aromatic epoxy compounds.

Examples of the aliphatic epoxy compounds include polyglycidyl ethers of aliphatic polyvalent alcohols or alkylene oxide adducts thereof, polyglycidinyl esters of aliphatic long-chain polybasic acids, and homopolymers and copolymers of glycidyl acrylates and glycidyl methacrylates. Further examples of the aliphatic epoxy compounds other than the aforementioned epoxy compounds include glycidyl esters of higher aliphatic acids, epoxylated soybean oil, butyl epoxystearate, octyl butylstearate, epoxylated linseed oil, and epoxylated polybutadiene. Examples of the alicyclic epoxy compound include cyclohexene oxide- or cyclopentene oxide-containing compounds obtained by the epoxylation of polyglycidinyl ether of polyvalent alcohol having at least one alicyclic group or compound containing an unsaturated alicyclic group (e.g., cyclohexene, cyclopentene, dicyclooctene, tricyclodecene) with a proper oxidizing agent such as hydrogen peroxide and peracid.

Examples of the aromatic epoxy compounds include monoglycidyl ethers or polyglycidyl ethers of monovalent or polyvalent phenols having at least one aromatic nucleus or alkylene oxide adducts thereof. Examples of these epoxy compounds include those disclosed in JP-A-11-242101, paragraphs (0084)-(0086), and those disclosed in JP-A-10-158385, paragraphs (0044)-(0046).

Preferred among these epoxy compounds are aromatic epoxides and alicyclic epoxides, particularly alicyclic epoxides, taking into account quick-curing properties. In the invention, the aforementioned epoxylated compounds may be used singly or in a proper combination of two or more thereof.

As the cyclic thioether compound there may be used a compound having a thioepoxy ring instead of epoxy ring of the aforementioned epoxy compound.

Specific examples of the compound an oxetanyl group as cyclic ether include those disclosed in JP-A-2000-239309, paragraphs (0024)-(0025). These compounds are preferably used in combination with epoxy group-containing compounds.

Examples of the spiroorthoester compounds include those disclosed in JP-T-2000-506908.

Examples of the vinyl hydrocarbon compounds include styrene compounds, vinyl-substituted alicyclic hydrocarbon compounds (e.g., vinyl cyclohexane, vinyl bicycloheptene), compounds listed above with reference to the radical-polymerizable monomer, propenyl compounds {as disclosed in “J. Polymer Science: Part A: Polymer Chemistry”, vol. 32, page 2,895, 1994}, alkoxyallene compounds {as disclosed in “J. Polymer Science: Part A: Polymer Chemistry”, vol. 33, page 2,493, 1995}, vinyl compounds {as disclosed in “J. Polymer Science: Part A: Polymer Chemistry”, vol. 34, page 1,015, 1996; JP-A-2002-29162}, and isopropenyl compounds {as disclosed in “J. Polymer Science: Part A: Polymer Chemistry”, vol. 34, page 2,051, 1996}.

Two or more of these vinyl hydrocarbon compounds may be used in proper combination.

As the aforementioned polyfunctional compound there is preferably used a compound containing at least one selected from the group consisting of the aforementioned radical-polymerizable groups and cation-polymerizable groups per molecule. Examples of such a compound include those disclosed in JP-A-8-277320, paragraphs (0031)-(0052), and those disclosed in JP-A-2000-191737, paragraph (0015). The compound to be used in the invention is not limited to these compounds.

It is preferred that the polyfunctional compound comprise the aforementioned radical-polymerizable compound and cation-polymerizable compound incorporated therein at a weight ratio of from 90:10 to 20:80, more preferably from 80:20 to 30:70.

The polymerization initiator to be used in combination with the binder precursor in the aforementioned combination (c) will be described hereinafter.

Examples of the polymerization initiator include heat polymerization initiators and photopolymerization initiators.

The aforementioned polymerization initiator is preferably a compound which generates a radical or acid when irradiated with light and/or heat. The aforementioned photopolymerization initiator preferably has a maximum absorption wavelength of 400 nm or less. By thus predetermining the absorption wavelength to fall within the ultraviolet range, handling can be conducted under white lamp. Further, a compound having a maximum absorption wavelength falling within the near infrared range can be used.

The radical-generating compound will be further described hereinafter.

The radical-generating compound which is preferably used in the invention indicates a compound which, when irradiated with light and/or heat, generates a radical that initiates and accelerates the polymerization of a compound having a polymerizable unsaturated group. Known polymerization initiators and compounds having a bond with a small bond dissociation energy may be properly selected. These radical-generating compounds may be used singly or in combination of two or more thereof.

Examples of the radical-generating compound employable herein include known heat radical polymerization initiators such as organic peroxide compound and azo-based polymerization initiator, and photoradical polymerization initiators such as organic peroxide compound (as disclosed in JP-A-2001-139663), amine compound (as disclosed in JP-B-44-20189), metalocene compound (as disclosed in JP-A-5-83588 and JP-A-1-304453), hexaaryl biimidazole compound (as disclosed in U.S. Pat. No. 3,479,185), disulfone compound (JP-A-5-239015 and JP-A-61-166544), organic halogen compound, carbonyl compound and organic phosphoric acid compound.

Specific examples of the aforementioned halogen compound include compounds as disclosed in Wakabayashi et al, “Bull. Chem. Soc. Japan”, vol. 42, page 2,924, 1969, U.S. Pat. No. 3,905,815, JP-A-5-27830, and M. P. Hutt, “J. Heterocyclic Chemistry”, vol. 1, No. 3, 1970. Particularly preferred examples of the aforementioned halogen atom include trihalomethyl-substituted oxazole compounds (s-triazine compounds). More preferably, s-triazine derivatives comprising at least one mono-, di- or trihalogen-substituted methyl group bonded to s-triazine ring are used.

As the aforementioned carbonyl compound there may be used any of compounds as disclosed in “Saishin UV Kouka Gijutsu (Modern UV Curing Technique)”, pp. 60-62, Technical Information Institute Co., Ltd., 1991, JP-A-8-134404, paragraphs (0015)-(0016), and JP-A-11-217518, paragraphs (0029)-(0031). Examples of these compounds include benzoin compounds such as acetophenone, hydroxyacetophenone, benzophenone, thioxane, benzoin ethyl ether and benzoin butyl ether, benzoic acid ester derivatives such as p-dimethylaminobenzoic acid ethyl and p-diethylaminobenzoic acid ethyl, benzyl dimethyl ketal, and acylphosphine oxide.

Examples of the aforementioned organic borate compounds include those disclosed in Japanese Patent No. 2,764,769, JP-A-2002-116539, and Kunz, Martin, “Rad. Tech, 98. Proceeding Apr. 19-22, 1998, Chicago”. Specific examples of these organic borate compounds include those disclosed in the above cited JP-A-2002-116539, paragraphs (0022)-(0027). Specific other examples of the organic borate compounds include organic boron transition metal-coordinated complexes disclosed in JP-A-6-348011, JP-A-7-128785, JP-A-7-140589, JP-A-7-306527, and JP-A-7-292014.

These radical-generating compounds may be added singly or in combination of two or more thereof. The amount of the radical-generating compounds to be added is from 0.1 to 30% by weight, preferably from 0.5 to 25% by weight, particularly from 1 to 20% by weight based on the total weight of the radical-polymerizable monomers. When the amount of the radical-generating compounds to be added falls within the above defined range, the resulting high refractive index layer-forming composition has no age stability problems and hence a high polymerizability.

The photo-acid generator which can be used as a photopolymerization initiator will be further described hereinafter.

Examples of the acid generator employable herein include known compounds such as photoinitiator for photocationic polymerization, photodecolorizing agent for dyes, photo-discoloring agent and known acid generator for use in microresist, etc., and mixture thereof. Further examples of the acid generator include organic halogen compounds, disulfone compounds, and onium compounds. Specific examples of the organic halogen compounds and disulfone compounds include those listed above with reference to the radical-generating compounds.

Examples of the onium compounds include diazonium salts, ammonium salts, iminium salts, phosphonium salts, iodonium salts, sulfonium salts, arsonium salts, selenonium salts. Specific examples of these onium compounds include those disclosed in JP-A-2002-29162, paragraphs (0058)-(0059).

As the acid generator, an onium salt is particularly preferred. Preferred among these onium salts are diazonium salts, iodoinium salts, sulfonium salts and iminium salts from the standpoint of photosensitivity of initiation of photopolymerization, material stability, etc.

Specific examples of the onium salts which can be preferably used in the invention include amylated sulfonium salts disclosed in JP-A-9-268205, diaryl iodonium salts and triaryl sulfonium

salts disclosed in JP-A-2000-71366, paragraphs (0010)-(0011), sulfonium salts of thiobenzoic acid S-phenylester disclosed in JP-A-2001-288205, paragraph (0017), and onium salts disclosed in JP-A-2001-133696, paragraphs (0030)-(0033).

Other examples of the acid generator include compounds such as organic metal/organic halide, photo-acid generator having o-nitrobenzyl type protective group and compound which undergoes photodecomposition to generate sulfonic acid (e.g., iminosulfonate) disclosed in JP-A-2002-29162, paragraphs (0059)-(0062).

These acid-generators may be used singly or in combination of two or more thereof. These acid-generators may be added in an amount of from 0.1 to 20% by weight, preferably from 0.5 to 15% by weight, particularly from 1 to 10% by weight based on the total weight of the cation-polymerizable monomers. When the amount of the acid-generators to be added falls within the above defined range, it is advantageous in the stability, polymerization-reactivity, etc. of the high refractive index layer-forming composition.

The high refractive index layer-forming composition of the invention preferably comprises a radical polymerization initiator or a cationic polymerization initiator incorporated therein in an amount of from 0.5 to 10% by weight, more preferably from 1 to 5% by weight or from 1 to 10% by weight, more preferably from 2 to 6% by weight based on the total weight of the radical-polymerizable compounds or cation-polymerizable compounds, respectively.

In the case where polymerization reaction involves ultraviolet irradiation, the high refractive index layer-forming composition to be used in the invention may comprise any known ultraviolet spectral sensitizer or chemical sensitizer incorporated therein. Examples of these sensitizers include Michler's ketones, amino acids (e.g., glycine), and organic amines (e.g., butylamine, dibutylamine).

In the case where polymerization reaction involves near infrared irradiation, a near infrared spectral sensitizer is preferably used. As the near infrared spectral sensitizer there may be used any light-absorbing material having an absorption band in at least a part of the wavelength range of 700 nm or more. A compound having a molecular absorptivity or 10,000 or more is preferred. A compound having absorption in the wavelength range of from 750 nm to 1,400 nm and a molecular absorptivity of 20,000 or more is more desirable. It is even more desirable that the near infrared spectral sensitizer show a minimum absorption in the visible light range of from 420 nm to 700 nm and hence be optically transparent.

As the near infrared spectral sensitizer there may be used any pigment or dye known as near infrared-absorbing pigment or near infrared-absorbing dye. Preferred among these near infrared spectral sensitizers are known near infrared absorbers. Commercially available dyes and known dyes disclosed in “Kagaku Kogyo (Chemical Industry)”, May 1986, pp. 45-51 (“Kinsekigai Kyushu Shikiso (Near Infrared-absorbing Dyes”), “90-nendai Kinoshikiso no Kaihatsu to Shijo Doko (Development and Market Trend of Functional Dyes in the 1990s)”, Clause 2.3 of Chapter 2, 1990, CMC, Ikemori and Hashiradani, “Tokushu Kino Shikiso (Special Functional Dyes)”, 1986, CMC, J. FABIAN, “Chem. Rev.”, vol. 92, pp. 1,197-1,226, 1992, catalog issued by Nihon Kanko Shikiso Kenkyujo in 1995, and laser dye catalogs and patents issued by Exciton Inc. in 1989 may be used.

(B) Organic metal compound containing a hydrolyzable functional group and a partial condensate thereof.

As the matrix of the high refractive index layer to be used in the invention there is preferably used a film obtained by subjecting an organic metal compound containing a hydrolyzable functional group to sol/gel reaction to form a coat layer which is then cured.

As the organic metal compound there may be used a compound made of silicon, titanium, zirconium, aluminum or the like. Examples of the hydrolyzable functional groups include alkoxy groups, alkoxycarbonyl groups, halogen atoms, and hydroxyl groups. Particularly preferred among these hydrolyzable functional groups are alkoxy groups such as methoxy group, ethoxy group, propoxy group and butoxy group. A preferred organic metal compound is an organic silicon compound represented by the following formula (2) or a partial hydrolyzate (partial condensate) thereof. It is a well known fact that an organic silicon compound represented by formula (2) can easily undergo hydrolysis followed by dehydration condensation reaction.
(R²¹)_{β}—Si(Y^{2l})_{4-β} (2)

In formula (2), R²¹ represents a substituted or unsubstituted C₁-C₃₀ aliphatic group or C₆-C₁₄ aryl group. Y²¹ represents a halogen atom (e.g., chlorine atom, bromine atom), OH group, OR²² or OCOR²² group (in which R²² represents a substituted or unsubstituted alkyl group). The suffix β represents an integer of from 0 to 3, preferably 0, 1 or 2, particularly 1, with the proviso that when β is 0, Y²¹ represents OR²² or OCOR²² group.

Preferred examples of the aliphatic group represented by Y²¹ in formula (2) include C₁-C₁₈aliphatic groups (e.g., methyl, ethyl, propyl, butyl, pentyl, hexyl, octyl, decyl, dodecyl, hexadecyl, octadecyl, benzyl, phenethyl, cyclohexyl, cyclohexylmethyl, hexenyl, decenyl, dodecenyl), more preferably C₁-C₁₂, particularly C₁-C₈ aliphatic groups. Examples of the aryl group represented by R²¹ include phenyl, naphthyl, and anthranyl. Preferred among these aryl groups is phenyl.

The substituents on these groups are not specifically limited. Preferred examples of these substituents include halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkylthio groups (e.g., methylthio, ethylthio), arylthio groups (e.g., phenylthio), alkenyl groups (e.g., vinyl, 1-propenyl), alkoxysilyl groups (e.g., trimethoxysilyl, triethoxysilyl), acyloxy groups (e.g., acetoxy, (meth)acryloyl), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (e.g., acetylamino, benzoylamino, acrylamino, methacrylamino).

Even more desirable among these substituents are hydroxyl groups, mercapto groups, carboxyl groups, epoxy groups, alkyl groups, alkoxysilyl groups, acyloxy groups, and acylamino groups. Particularly preferred among these substituents are epoxy groups, polymerizable acyloxy groups (e.g., (meth)acryloyl), and polymerizable acylamino groups (e.g., acrylamino, methacrylamino). These substituents may be further substituted.

As mentioned above, R²² represents a substituted or unsubstituted alkyl group which is not specifically limited. However, the alkyl group may be the same aliphatic group as listed with reference to R²¹. The substituents on the alkyl group are as defined with reference to R²¹.

The content of the compound represented by formula (2) is preferably from 10 to 80% by weight, more preferably from 20 to 70% by weight, particularly from 30 to 50% by weight based on the total solid content of the high refractive index layer.

Specific examples of the compound of formula (2) include those disclosed in JP-A-2001-166104, paragraphs (0054)-(0056).

The organic binder to be incorporated in the high refractive index layer preferably has a silanol group. When the binder has a silanol group, the resulting high refractive index layer exhibits further improvements in physical strength, chemical resistance and weathering resistance to advantage. The incorporation of the silanol group can be accomplished by incorporating an organic silicon compound having a crosslinkable or polymerizable functional group represented by formula (2) in the high refractive index layer-forming coating composition as a binder-forming component constituting the coating composition with a binder precursor (curable polyfunctional monomer, polyfunctional oligomer, etc.), a polymerization initiator and a dispersant to be incorporated in the dispersion of high refractive particulate material, spreading the coating composition over a transparent support, and then allowing the dispersant, the polyfunctional monomer or polyfunctional oligomer and the organic silicon compound represented by formula (2) to undergo crosslinking reaction or polymerization reaction.

The hydrolysis/condensation reaction for the purpose of curing the aforementioned organic metal compound is preferably effected in the presence of a catalyst. Examples of the catalyst employable herein include inorganic acids such as hydrochloric acid, sulfuric acid and nitric acid, organic acids such as oxalic acid, acetic acid, formic acid, trifluoroacetic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum, tetrabutoxy zirconium and tetrabutoxy titanate, and metal chelate compounds of β-diketones or β-ketoesters. Specific examples of these catalysts include compounds disclosed in JP-A-2000-275403, paragraphs (0071)-(0083).

The proportion of these catalyst compounds in the composition is from 0.01 to 50% by weight, preferably from 0.1 to 50% by weight, more preferably from 0.5 to 10% by weight based on the weight of the organic metal compound. The reaction conditions are preferably adjusted properly by the reactivity of the organic metal compound.

In the high refractive index layer, the matrix preferably has a specific polar group. Examples of the specific polar group include anionic groups, amino groups, and quaternary ammonium groups. Specific examples of the anionic groups, amino groups and quaternary ammonium groups include those listed above with reference to the dispersant.

The matrix having a specific polar group in the high refractive index layer is obtained, e.g., by compounding a high refractive index layer-forming coating composition with a dispersion containing a high refractive particulate material and a dispersant, a combination of a binder precursor having a specific polar group (e.g., curable polyfunctional monomer or polyfunctional oligomer having a specific polar group) and a polymerization initiator and at least any of organic silicon compounds having a specific polar group and a crosslinkable or polymerizable functional group represented by formula (2) as a cured layer-forming component and optionally a monofunctional monomer having a specific polar group and crosslinkable or polymerizable functional group, spreading the coating composition over a transparent support, and then allowing the dispersant, the monofunctional monomer, polyfunctional monomer or polyfunctional oligomer and/or organic silicon compound represented by formula (2) to undergo crosslinking or polymerization reaction.

The monofunctional monomer having a specific polar group can act as a dispersing aid for high refractive particulate material in the coating composition to advantage. After the spreading of the coating composition, the monofunctional monomer can further undergo crosslinking or polymerization reaction with the dispersant, the polyfunctional monomer or polyfunctional oligomer to form a binder that can keep the high refractive particulate material dispersed uniformly in the high refractive index layer, making it possible to prepare a high refractive index layer excellent in physical strength, chemical resistance and weathering resistance.

The amount of the monofunctional monomer having an amino group or quaternary ammonium group to be incorporated in the dispersant is preferably from 0.5 to 50% by weight, more preferably from 1 to 30% by weight. When the crosslinking or polymerization reaction is effected at the same time with or after the spreading of the high refractive index layer-forming coating composition to form a binder, the monofunctional monomer is allowed to perform effectively before the spreading of the high refractive index layer-forming coating composition.

Another example of the matrix of the high refractive index layer of the invention is one formed by curing an organic polymer containing a known crosslinkable or polymerizable functional group corresponds to the aforementioned organic binder (a). After the formation of the high refractive index layer, the polymer preferably has a crosslinked or polymerized structure. Examples of the polymer include polyolefins (made of saturated hydrocarbon), polyethers, polyureas, polyurethanes, polyesters, polyamides, polyamides, and melamine resins. Preferred among these polymers are polyolefins, polyethers and polyureas, more preferably polyolefins and polyethers. The uncured organic polymer preferably has a weight-average molecular weight of from 1×10³ to 1×10⁶, more preferably from 3×10³ to 1×10⁵.

The uncured organic polymer is preferably a copolymer of repeating units having a specific polar group and repeating units having a crosslinked or polymerized structure similar to the contents described above. The proportion of the repeating units having an anionic group in the polymer is preferably from 0.5 to 99% by weight, more preferably from 3 to 95% by weight, most preferably from 6 to 90% by weight based on the weight of the repeating units. The repeating units may have two or more same or different anionic groups.

The proportion of the repeating units having a silanol group, if any, is preferably from 2 to 98 mol-%, more preferably from 4 to 96 mol-%, most preferably from 6 to 94 mol-%. The proportion of the repeating units having an amino group or quaternary ammonium group, if any, is preferably from 0.1 to 50% by weight, more preferably from 0.5 to 30% by weight.

Even when a silanol group, an amino group and a quaternary ammonium group are contained in the repeating units having an anionic group or the repeating units having a crosslinked or polymerized structure, similar effects can be exerted.

The proportion of the repeating units having a crosslinked or polymerized structure in the polymer is preferably from 1 to 90% by weight, more preferably from 5 to 80% by weight, most preferably from 8 to 60% by weight.

The matrix comprising a crosslinked or polymerized binder is preferably formed by spreading a high refractive index layer-forming composition over a transparent support, and allowing the coat layer to undergo crosslinking or polymerization reaction at the same time with or after spreading.

(Other Compositions of High Refractive Index Layer)

The high refractive index layer of the invention may further properly comprise other compounds incorporated therein depending on the purpose. For example, in the case where the low refractive index layer is provided on the high refractive index layer, the refractive index of the high refractive index layer is preferably higher than that of the transparent support. When the high refractive index layer comprises an aromatic ring, halogen elements other than fluorine {e.g., bromine (Br), iodine (I), chlorine Cl}, and atoms such as sulfur (S), nitrogen (N) and phosphorus (P) incorporated therein, the refractive index of the organic compound is raised. Therefore, a binder obtained by the crosslinking or polymerization reaction of a curable compound comprising these components may be preferably used as well.

The high refractive index layer may comprise a resin, a surface active agent, an antistatic agent, a coupling agent, a thickening agent, a coloring inhibitor, a coloring agent (e.g., pigment, dye), anti-foaming agent, a leveling agent, a fire retardant, an ultraviolet absorber, an infrared absorber, an adhesion-providing agent, a polymerization inhibitor, an oxidation inhibitor, a surface modifier, an electrically-conductive particulate metal, etc. incorporated therein besides the aforementioned components (e.g., high refractive particulate material, polymerization initiator, sensitizer).

(Formation of High Refractive Index Layer)

The high refractive index layer is preferably formed by spreading the aforementioned high refractive index layer-forming composition over the aforementioned transparent support optionally with other layers interposed therebetween. The high refractive index layer-forming coating solution to be used in the invention is prepared by mixing a high refractive particulate material dispersion, a matrix binder solution and optional additives with a coating dispersant and diluting the solution in a predetermined concentration.

The coating solution to be spread is preferably filtered before spreading. As the filter for filtration there is preferably used one having a pore diameter as small as possible so far as the components in the coating solution are not removed. For the filtration, a filter having an absolute filtration precision of from 0.1 to 100 μm, preferably from 0.1 to 25 μm is preferably used. The thickness of the filter is preferably from 0.1 to 10 mm, more preferably from 0.2 to 2 mm. In this arrangement, filtration is preferably effected at a pressure of 1.5 MPa (15 kgf/cm²) or less, more preferably 1 MPa (10 kgf/cm²) or less, particularly 0.2 MPa (2 kgf/cm²) or less. The filtering member is not specifically limited so far as it has no effects on the coating solution. In some detail, the same filtering material as described with reference to the ultrafine division of high refractive particulate material may be used. It is also preferred that the coating solution thus filtered be subjected to ultrasonic dispersion shortly before being spread to help defoaming and help keep the dispersed particles fairly dispersed.

The high refractive index layer of the invention is prepared by spreading the aforementioned high refractive index layer-forming composition over the aforementioned transparent support by any known thin film forming method such as dip coating method, air knife coating method, curtain coating method, roller coating method, wire bar coating method, gravure coating method, microgravure coating method and extrusion coating method, drying the coat layer, and then irradiating the coat layer with light and/or heat. Curing by irradiation with light is preferably effected to advantage from the standpoint of curing speed. The coat layer is more preferably subjected to heat treatment at the latter half stage of photocure step.

As the source of light with which the coat layer is irradiated there may be used any light source which emits light in the ultraviolet or near infrared range. Examples of the ultraviolet light source include ultrahigh pressure, high pressure, middle pressure and low pressure mercury vapor lamps, chemical lamp, carbon arc lamp, metal halide lamp, xenon lamp, and sunlight. Light from various available lasers having a wavelength of from 350 nm to 420 nm may be multiplexed before irradiation. Examples of the near infrared light source include halogen lamp, xenon lamp, and high pressure sodium lamp. Light from various available lasers having a wavelength of from 750 nm to 1,400 nm may be multiplexed before irradiation. The near infrared light source, if used, may be combined with an ultraviolet light source or may be incident on the coat layer on the transparent support side thereof, which is opposite the high refractive index layer side. In this manner, the curing of the interior of the coat layer in the depth direction proceeds without delay from that of the region in the vicinity of the surface, making it possible to obtain a uniformly cured layer.

The photoradical polymerization by irradiation with light can be effected in the air or inert gas. In order to reduce the induction period of polymerization of radical-polymerizable monomer or sufficiently raise the percent polymerization, however, the photoradical polymerization by irradiation with light is preferably effected in an atmosphere having an oxygen concentration as low as possible. The luminous intensity of ultraviolet rays incident on the coat layer is preferably from about 0.1 to 100 mW/cm². The dose on the surface of the coat layer is preferably from 100 to 1,000 mJ/cm². The distribution of temperature of the coat layer at the irradiation step is preferably as uniform as possible and is preferably controlled to fall within the range of ±3° C., more preferably ±1.5° C. When the distribution of temperature of the coat layer falls within the above defined range, the polymerization reaction in the in-plane area of the coat layer and in the interior of the coat layer in the depth direction can proceed uniformly to advantage.

The hardness of the high refractive index layer is preferably not lower than H, more preferably not lower than 2H, most preferably not lower than 3H as determined by pencil hardness test according to JIS K5400. Referring to the scratch resistance of the high refractive index layer, the abrasion loss of a specimen prepared by spreading the high refractive index layer-forming composition is preferably as small as possible according to Taber abrasion test of JIS K-5400. The haze of the high refractive index layer is preferably as low as possible. The haze of the high refractive index layer is preferably 5% or less, more preferably 3% or less, particularly 1% or less.

The thickness of the high refractive index layer is preferably from 30 to 500 nm, more preferably from 50 to 300 nm. In the case where the high refractive index layer acts also as a hard coat layer, the thickness of the high refractive index layer is preferably from 0.5 to 10 μm, more preferably from 1 to 7 μm, particularly from 2 to 5 μm.

(Middle Refractive Index Layer)

As previously mentioned, the anti-reflection layer of the invention preferably has a middle refractive index layer. In some detail, the anti-reflection layer preferably has a layer structure comprising a middle refractive index layer 3, a high refractive index layer 4 and a low refractive index layer (outermost layer) 5 laminated on each other in this order. The middle refractive index layer has a refractive index intermediate between that of the transparent support and that of the high refractive index layer. Thus, the refractive index of the various refractive layers are relative to each other. The middle refractive index layer is formed by spreading a middle refractive index layer-forming composition in the same manner as the high refractive index layer.

The material constituting the middle refractive index layer of the invention may be any known material but is preferably the same as that of the high refractive index layer. The refractive index of the middle refractive index layer can be easily adjusted by the kind and amount of the inorganic particulate material to be used. The middle refractive index layer is formed to a thickness as small as 30 to 500 nm, preferably from 50 to 300 nm, in the same manner as described above with reference to the high refractive index layer.

(Low Refractive Index Layer)

The low refractive index layer of the invention is preferably a cured layer formed by spreading a thermosetting or photocurable or radiation(e.g., ionized radiation)-curable composition. The low refractive index layer of the invention is preferably formed as an outermost layer having scratch resistance and stainproofness. From the standpoint of the stainproofing effect, the cured layer is preferably a cured layer made of a crosslinkable fluoropolymer. When the content of the fluoropolymer is 50% by weight or more based on the total weight of the outermost layer, the resulting low refractive index layer has uniform surface conditions and exhibits stable properties to advantage. Further, the low refractive index layer is preferably composed of a cured layer made of an inorganic particulate compound and, as a matrix binder, a copolymer (hereinafter occasionally referred to as “functional fluoropolymer”) comprising as essential constituents repeating units derived from fluorine-containing vinyl monomer and repeating units having a (meth)acryloyl group in its side chain. The components derived from the copolymer preferably account for 60% by weight or more, more preferably 70% by weight or more, 80% by weight or more of the solid content of the low refractive index layer. From the standpoint of the accomplishment of both the reduction of refractive index and the enhancement of layer hardness, a curing agent such as polyfunctional (meth)acrylate may be used in an amount such that the compatibility thereof cannot be impaired to advantage.

The refractive index of the low refractive index layer is preferably from 1.20 to 1.49, more preferably from 1.25 to 1.48, particularly from 1.30 to 1.46.

(Low Refractive Index Layer-Forming Composition)

(Functional Fluoropolymer)

The functional fluoropolymer to be used in the low refractive index layer of the invention will be described hereinafter.

Examples of the fluorine-containing vinyl monomer include fluoroolefins (e.g., fluoroethylene, vinylidene fluoride, tetrafluoroethylene, hexafluoropropylene), partially or fully fluorinated alkylester derivatives of (meth)acrylic acid (e.g., Biscoat 6FM (produced by OSAKA ORGANIC CHEMICAL INDUSTRY LTD.), M-2020 (produced by DAIKIN INDUSTRIES, LTD.)), and fully or partially fluorinated vinyl ethers. Preferred among these fluorine-containing vinyl monomers are perfluoroolefins. Particularly preferred among these perfluoroolefins is hexafluoropropylene from the standpoint of refractive index, solubility, transparency, availability, etc.

As the percentage composition of these fluorine-containing vinyl monomers increases, the refractive index of the low refractive index layer can be reduced, but the strength of the low refractive index layer tends to fall. In the invention, the fluorine-containing vinyl monomers are preferably incorporated in such an amount that the fluorine content in the copolymer reaches a range of from 20 to 60% by weight, more preferably from 25 to 55% by weight, particularly from 30 to 50% by weight.

The functional fluoropolymer to be used in the invention preferably comprises as essential constituents repeating units having a (meth)acryloyl group in its side chain. As the percentage composition of these (meth)acryloyl group-containing repeating units increases, the strength of the low refractive index layer is raised, but the refractive index of the low refractive index layer tends to rise. Though depending on the kind of the repeating units derived from the fluorine-containing vinyl monomer, the (meth)acryloyl group-containing repeating units preferably account for from 5 to 90% by weight, more preferably from 30 to 70% by weight, particularly from 40 to 60% by weight of the functional fluoropolymer.

The functional fluoropolymer useful in the invention may be copolymerized properly with other vinyl monomers besides the aforementioned repeating units derived from fluorine-containing vinyl monomer and repeating units having a (meth)acryloyl group in its side chain from the standpoint of adhesion to substrate, Tg of polymer (contributing to layer hardness), solubility in solvent, transparency, slipperiness, dustproofness and stainproofness. A plurality of these vinyl monomers may be used in combination depending on the purpose. These vinyl monomers are preferably incorporated in a total amount of from 0 to 65 mol-%, more preferably from 0 to 40 mol-%, particularly from 0 to 30 mol-% based on the amount of the copolymer.

The vinyl monomer units which can be used in combination with the functional fluoropolymer are not specifically limited. Examples of these vinyl monomers include olefins (e.g., ethylene, propylene, isoprene, vinyl chloride, vinylidene chloride), acrylic acid esters (e.g., methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene and derivatives thereof (e.g., styrene, p-hydroxymethyl styrene, p-methoxystyrene), vinyl ethers (e.g., methyl vinyl ether, ethyl vinyl ether, cyclohexyl vinyl ether, hydroxy ethyl vinyl ether, hydroxy butyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethylacrylamide, N-t-butylacrylamide, N-cyclohexylacrylamide), methacryl amides (e.g., N,N-dimethylmethacrylamide), and acrylonitriles.

A preferred embodiment of the functional fluoropolymer to be used in the invention is a compound represented by the following formula (3): 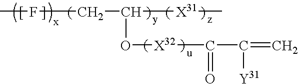
wherein the component (F) represents the following component (pf1), (pf2) or (pf3).

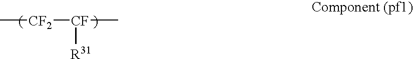

In the component (pf1), R³¹ represents a fluorine atom or C₁-C₃ perfluoroalkyl group.

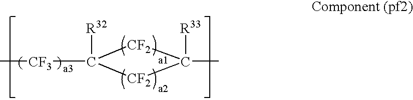

In the component (pf2), R³² and R³³ may be the same or different and each represent a fluorine atom or —CⱼF₂ⱼ₊₁ group (in which j represents an integer of from 1 to 4, preferably 1 or 2); a1 represents an integer of 0 or 1; a2 represents an integer of from 2 to 5; and a3 represents an integer of 0 or 1, with the proviso that when a1 and/or a3 is 0, the component (pf2) represents a single bond.

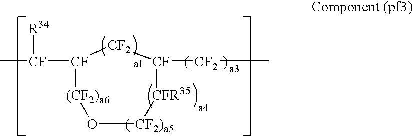

In the component (pf3), R³⁴ and R³⁵ each represent a fluorine atom or —CF₃; a1 and a3 each represent an integer of 0 or 1 as defined in the component (pf2); a4 represents 0 or an integer of from 1 to 4; a5 represents an integer of 0 or 1; and a6 represents 0 or an integer of from 1 to 5, with the proviso that when a3, a4, a5 and/or a6 is 0, the component (pf3) represents a single bond, and the sum of a4 a5 and a6 is an integer of from 1 to 6.

In the aforementioned formula (3), X³² represents a C₁-C₁₀, preferably C₁-C₆, particularly C₂-C₄ connecting group which may be straight-chain or have a branched structure or may have a cyclic structure. The connecting group may have hetero atoms selected from the group consisting of oxygen, nitrogen and sulfur. Preferred examples of the connecting B include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, and *—CH₂CH₂OCONH(CH₂)₃—** (in which * represents a connecting site on the polymer main chain side; and ** represents a connecting site on the (meth)acryloyl group side). The suffix u represents an integer of 0 or 1.

In formula (3), Y³¹ represents a hydrogen atom or methyl group, preferably a hydrogen atom from the standpoint of curing reactivity.

In formula (3), X³¹ represents a repeating unit derived from arbitrary vinyl monomer. This repeating unit is not specifically limited so far as it is a component constituting a monomer copolymerized with the monomer corresponding to the component (F) and can be properly selected from the standpoint of adhesion to the lower under the low refractive index layer, e.g., high refractive index layer, Tg of polymer (contributing to layer hardness), solubility in solvent, transparency, slipperiness, dustproofness and stainproofness. This repeating unit may be composed of a single vinyl monomer or a plurality of vinyl monomers depending on the purpose.

Preferred examples of X³¹ in formula (3) include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylic acid esters such as methyl (meth)acrylate, ethyl (meth)acrylate, hydroxyethyl (meth)acrylate, glycidyl methacrylate, allyl (meth)acrylate and (meth)acryloyloxy propyl trimethoxysilane, styrene and derivatives thereof such as styrene and p-hydroxymethylstyrene, unsaturated carboxylic acids such as crotonic acid, maleic acid and itaconic acid, and derivatives thereof. More desirable among these groups are vinyl ether derivatives and vinyl ester derivatives. Particularly preferred among these groups are vinyl ether derivatives.

The suffixes x, y and z each represent the molar percentage of the respective constituent and satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10, with the proviso that the sum of x, y and z is 100.

It is particularly preferred that the component (F) in formula (3) be the component (pf1), e.g., compound disclosed in JP-A-2004-45462, paragraphs (0043)-(0047).

(Organosilane Compound)

The low refractive index layer is preferably formed by a hydrolyzate of organosilane compound represented by formula (1) and/or partial condensate thereof in combination with the aforementioned functional fluoropolymer.

The organosilane compound represented by formula (1) will be described below.
(R¹¹)ₐ—Si(Y¹¹)_{4-α} (1)

In formula (1), R¹¹ represents a substituted or unsubstituted alkyl or aryl group. The alkyl group preferably has from 1 to 30, more preferably from 1 to 16, particularly from 1 to 6 carbon atoms. Examples of the alkyl group include methyl, ethyl, propyl, isopropyl, hexyl, decyl, and hexadecyl. Examples of the aryl group include phenyl, and naphthyl. Preferred among these alkyl groups is phenyl.

Y¹¹ represents a hydroxyl group or hydrolyzable group such as alkoxy group (alkoxy group having from 1 to 5 carbon atoms such as methoxy and ethoxy), halogen atom (e.g., chlorine, bromine, iodine) and group represented by R¹²COO (in which R¹² is preferably a hydrogen atom or C₁-C₅ alkyl group such as CH₃COO and C₂H₅COO). Preferred among these groups are alkoxy groups. Particularly preferred among these alkoxy groups are methoxy and ethoxy.

The suffix α represents an integer of from 1 to 3, preferably 1 or 2, particularly 1.

The plurality of R¹¹'s or Y¹¹'s, if any, may be each the same or different.

The substituents on R¹¹ are not specifically limited. Examples of these substituents include halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkylthio groups (e.g., methylthio, ethylthio), arylthio groups (e.g., phenylthio), alkenyl groups (e.g., vinyl, 1-propenyl), acyloxy groups (e.g., acetoxy, acryloyloxy, methacryloyloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (e.g., acetylamino, benzoylamino, acrylamino, methacryl amino). These substituents may be further substituted.

At least one of the plurality of R¹¹'s, if any, is preferably a substituted alkyl or aryl group.

Preferred among the organosilane compounds represented by formula (1) is an organosilane compound having a vinyl-polymerizable substituent represented by the following formula (1-1).

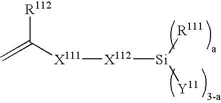

In formula (1-1), R¹¹² represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom, and chlorine atom. More desirable among these groups are hydrogen atom, methyl group, methoxycarbonyl group, fluorine atom, and chlorine atom. Particularly preferred among these groups are hydrogen atom and methyl group.

XIII represents a single bond or *—COO—**, *—CONH—** or *—O—**, preferably single bond, *—COO—** or *—CONH—**, more preferably single bond or *—COO—**, particularly *—COO—** in which * represents the position at which the group is connected to ═C(R¹¹²)— and ** represents the position at which the group is connected to X¹¹².

X112 represents a divalent connecting chain. Specific examples of the divalent connecting chain include substituted or unsubstituted alkyl group, substituted or unsubstituted arylene group, substituted or unsubstituted alkylene group having a connecting group thereinside (e.g., ether, ester, amide), and substituted or unsubstituted arylene group having a connecting group thereinside. Preferred among these groups are substituted or unsubstituted alkylene group, substituted or unsubstituted arylene group, and alkylene group having a connecting group thereinside. More desirable among these groups are unsubstituted alkylene group, unsubstituted arylene group and alkylene group having ether or ester connecting group thereinside. Particularly preferred among these groups are unsubstituted alkylene group and alkylene group having ether or ester connecting group thereinside. Examples of the substituents on these groups include halogen, hydroxyl group, mercapto group, carboxyl group, epoxy group, alkyl group, and aryl group. These substituents may be further substituted.

The suffix α represents 0 or 1. The plurality of Y¹¹'s, if any, may be the same or different. The suffix α is preferably 0. R¹¹¹ has the same meaning as R¹¹ in formula (1). Preferred among these groups are substituted or unsubstituted alkyl group and unsubstituted aryl group. More desirable among these groups are unsubstituted alkyl group and unsubstituted aryl group. Y¹¹ is as defined in formula (1). Preferred among these groups are halogen atom, hydroxyl group, and unsubstituted alkoxy group. More desirable among these groups are chlorine atom, hydroxyl group, and C₁-C₆alkoxy group. Even more desirable among these groups are hydroxyl group, and C₁-C₃ alkoxy group. Particularly preferred among these groups is methoxy group.

Two or more of the compounds of formula (1) and formula (1-1) may be used in combination. Specific examples of the compounds represented by formulae (1) and (1-1) will be given below, the invention is not limited thereto.

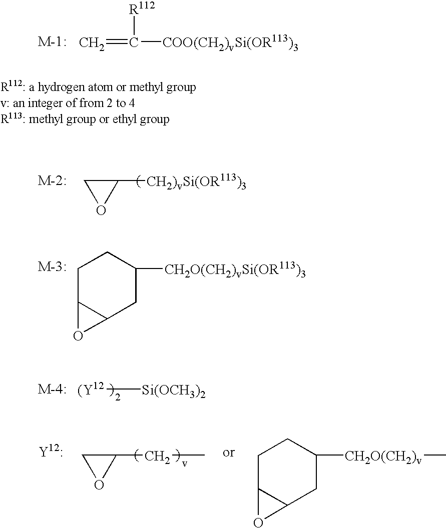

Particularly preferred among the compounds represented by formula (1) and formula (1-1) are 3-acryloxypropyl trimethoxysilane and 3-methacryloxyl propyl trimethoxysilane.

The hydrolyzate and/or partial condensate of organosilane compound is normally produced by treating the aforementioned organosilane compound in the presence of a catalyst. Examples of the catalyst employable herein include inorganic acids such as hydrochloric acid, sulfuric acid and nitric acid, organic acids such as oxalic acid, acetic acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, and metal chelate compounds comprising a metal such as zirconium, titanium and aluminum as a central metal. From the standpoint of production stability or storage stability of inorganic particulate material dispersion, an acid catalyst (inorganic acid, organic acid) and/or a metal chelate compound is preferably used in the invention. Preferred among these inorganic acids are hydrochloric acid and sulfuric acid. Preferred among these organic acids are those having an acid dissociation constant {pKa value (25° C.)} of 4.5 or less in water. More desirable among these organic acids are hydrochloric acid, sulfuric acid and organic acid having an acid dissociation constant of 3.0 or less in water. Particularly preferred among these organic acids are hydrochloric acid, sulfuric acid and organic acid having an acid dissociation constant of 2.5 or less in water. Even more desirable among these organic acids are those having an acid dissociation constant of 2.5 or less in water. In some detail, methanesulfonic acid, oxalic acid, phthalic acid and malonic acid are more desirable, particularly oxalic acid. As the metal chelate compound there is preferably used one selected from the group consisting of compounds represented by the following formulae:
Zr(OR⁰¹)ₚ₁₍R⁰²COCHCOR⁰³)ₚ₂;
Ti(OR⁰¹)_{q1}(R⁰²COCHCOR⁰³)_{q2}; and
Al(OR⁰¹)ᵣ₁(R⁰²COCHCOR⁰³)ᵣ₂
described later with reference to metal chelate compound. In the invention, the low refractive index layer-forming composition preferably comprises a β-diketone compound and/or β-ketoester compound incorporated therein. Specific examples of the β-diketone compound and/or β-ketoester compound include acetyl acetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Preferred among these compounds are ethyl acetoacetate and acetyl acetone. Particularly preferred among these compounds is acetyl acetone. These β-diketone compounds and/or β-ketoester compounds may be used singly or in combination of two or more thereof. In the invention, the β-diketone compound and/or β-ketoester compound is preferably used in an amount of 2 mols or more, more preferably from 3 to 20 mols per mol of metal chelate compound. From the standpoint of the storage stability of the compound thus obtained, the amount of the β-diketone compound and/or β-ketoester compound to be used per metal chelate compound preferably falls within the above defined range.

The hydrolyzate and/or partial condensate of organosilane compound is normally obtained in the form of sol.

The content of the sol component of organosilane per functional fluoropolymer in the low refractive index layer is preferably from 5 to 100% by weight, more preferably from 5 to 40% by weight, even more preferably from 8 to 35% by weight, particularly from 10 to 30% by weight. When the content of the sol component of organosilane is not greater than the above defined upper limit, the resulting low refractive index layer undergoes no such defectives as excessive rise of refractive index and deterioration of layer shape and conditions. When the content of the sol component of organosilane is not smaller than the above defined upper lower limit, the excellent effects of the invention can be exerted. Thus, the sol component of organosilane is preferably used in an amount falling within the above defined range.

(Polyfunctional Polymerizable Compound)

As previously mentioned, the aforementioned low refractive index layer-forming curable composition may further comprise a polyfunctional polymerizable compound incorporated therein.

The polyfunctional polymerizable compound may comprise two or more radical-polymerizable functional groups and/or cation-polymerizable functional groups. Examples of the radical-polymerizable functional group include ethylenically unsaturated groups such as (meth)acryloyl group, vinyloxy group, styryl group and allyl group. Preferred among these radical-polymerizable functional groups is (meth)acryloyl group. A polyfunctional monomer containing two or more radical polymerizable groups per molecule is preferably included.

The radical-polymerizable functional monomer having a radical-polymerizable group is preferably selected from the group consisting of compounds having at least two terminal ethylenically unsaturated bonds. Preferably, a compound having from 2 to 6 terminal ethylenically unsaturated bonds per molecule is used. Such a group of compounds is well known in the art of polymer material. In the invention, these compounds may be used without any limitation. Those listed above in the paragraph (A-c) with reference to matrix of high refractive index layer may be used. These compounds may have a chemical morphology such as monomer, prepolymer such as dimer, trimer and oligomer, mixture thereof and copolymer thereof.

As the cation-polymerizable compound to be used herein there may be used any compound which undergoes polymerization reaction and/or crosslinking reaction when irradiated with active energy rays in the presence of an active energy ray-sensitive cation polymerization initiator. Representative examples of such a compound include epoxy compounds, cyclic thioether compounds, cyclic ether compounds, spiroorthoester compounds, vinyl hydrocarbon compounds, and vinyl ether compounds. In the invention, one or more of the aforementioned cation-polymerizable organic compounds may be used. The cation-polymerizable group-containing compound preferably has from 2 to 10, particularly from 2 to 5 cation-polymerizable groups per molecule. Specific contents of these radical-polymerizable compounds and cation-polymerizable compounds include those of polyfunctional monomers or oligomers described above with reference to high refractive index layer.

The aforementioned radical-polymerizable compound and cation-polymerizable compound are preferably incorporated at a weight ratio of 90:10 to 20:80, more preferably 80:20 to 30:70. The content of the aforementioned polyfunctional polymerizable compound comprising a radical-polymerizable compound and a cation-polymerizable compound is preferably from 0.1 to 20 parts by weight based on 100 parts by weight of the aforementioned fluoropolymer.

(Inorganic Particulate Compound)

The inorganic particulate compound (hereinafter occasionally referred to as “inorganic particulate material”) which can be incorporated in the low refractive index layer of the invention will be described hereinafter.

The average particle diameter of the inorganic particulate material is preferably from 5 to 100 nm, more preferably from 10 to 90 nm, even more preferably from 15 to 85 nm. The inorganic particulate material is preferably incorporated in the low refractive index layer in an amount of from 5 to 80% by weight, more preferably from 10 to 70% by weight, even more preferably from 15 to 65% by weight. When the content of the inorganic particulate material is not smaller than the above defined lower limit, the resulting low refractive index layer exhibits an effectively improved scratch resistance. When the content of the inorganic particulate material is not greater than the above defined upper limit, the resulting low refractive index layer the resulting low refractive index layer undergoes no such defectives as fine roughness on the surface thereof and deterioration of external appearance such as black tone and density and integral reflectance. Thus, the content of the inorganic particulate material preferably falls within the above defined range.

The inorganic particulate material to be incorporated in the low refractive index layer preferably has a low refractive index. Examples of the inorganic particulate material include particulate magnesium fluoride and particulate silica. Particulate silica is particularly preferred from the standpoint of refractive index, dispersion stability and cost. Particulate silica may be either crystalline or amorphous or may be monodisperse or agglomerated so far as predetermined particle diameter can be reached. The shape of the inorganic particulate material is most preferably sphere but may be amorphous. For the measurement of the average particle diameter of the inorganic particulate material, a Coulter counter is used.

In order to further reduce the rise of the refractive index of the low refractive index layer, a hollow particulate silica (hereinafter referred to as “hollow particulate material”) is preferably used as inorganic particulate material. The refractive index of the hollow particulate material is preferably from 1.17 to 1.40, more preferably from 1.17 to 1.35, particularly from 1.17 to 1.30. Herein, the refractive index indicates the refractive index of the entire particle rather than the refractive index of only the silica component of the shell constituting the hollow particulate material. The refractive index of the hollow particulate material is preferably 1.17 or more from the standpoint of the strength of the particle and the scratch resistance of the low refractive index layer containing the hollow particulate material.

For the measurement of the refractive index of the hollow particulate material, an Abbe refractometer (produced by ATGO CO., LTD.) may be used.

Supposing that the radius of the void of the hollow particulate material is rᵢ and the radius of the shell of the particle is rₒ, the void w (%) of the hollow particulate material is calculated by the following numerical relationship (5):
w=(4πrᵢ³/3)/(4πrₒ³/3)×100=(ri/rₒ)³×100 (5)

The percent void of the hollow particulate material is preferably from 10 to 60%, more preferably from 20 to 60%, most preferably from 30 to 60%.

The inorganic particulate material may be subjected to physical surface treatment such as plasma discharge treatment and corona discharge treatment or chemical surface treatment with a surface active agent, coupling agent or the like to attain stability of dispersion in the dispersion or coating solution or enhance the affinity for and the bonding properties with respect to the binder component.

As the coupling agent there is preferably used an alkoxy metal compound (e.g., titanium coupling agent, silane coupling agent). In particular, silane coupling treatment is effective. A hydrolyzate and/or partial condensate of organosilane represented by formula (1) is particularly preferred.

Preferred among these silane coupling agents are those containing a hydroxyl group, mercapto group, carboxyl group, epoxy group, alkyl group, alkoxysilyl group, acyloxy group and acylamino group. Particularly preferred among these silane coupling agents are those containing an epoxy group, polymerizable acyloxy group ((meth)acryloyl) and polymerizable acylamino group (e.g., acrylamino, methacrylamino).

The aforementioned coupling agent is used as a surface treatment agent for inorganic particulate material in the low refractive index layer to effect surface treatment before the preparation of the coating solution of the low refractive index layer-forming composition. As previously mentioned, the coupling agent is preferably used as additive for the functional fluoropolymer during the preparation of the coating solution.

The coupling agent is preferably added in an amount of from 0.5 to 100% by weight, more preferably from 1 to 75% by weight, even more preferably from 5 to 45% by weight based on the weight of the inorganic particulate material. When the amount of the coupling agent falls within the above defined range, the inorganic particulate material is not agglomerated in the low refractive index layer to advantage.

The inorganic particulate material is preferably dispersed in the medium before surface treatment to reduce the burden of surface treatment.

(Catalyst for Improvement of Dispersibility)

In the invention, the improvement of the dispersibility of the inorganic particulate material to be incorporated in the low refractive index layer with a hydrolyzate and/or condensation product of organosilane is preferably effected in the presence of a catalyst. Examples of the catalyst employable herein include inorganic acids such as hydrochloric acid, sulfuric acid and nitric acid, organic acids such as oxalic acid, acetic acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, and metal chelate compounds comprising a metal such as zirconium, titanium and aluminum as a central metal. From the standpoint of production stability or storage stability of inorganic particulate material dispersion, an acid catalyst (inorganic acid, organic acid) and/or a metal chelate compound is preferably used in the invention. Preferred among these inorganic acids are hydrochloric acid and sulfuric acid. Preferred among these organic acids are those having an acid dissociation constant {pKa value (25° C.)} of 4.5 or less in water. More desirable among these organic acids are hydrochloric acid, sulfuric acid and organic acid having an acid dissociation constant of 3.0 or less in water. Particularly preferred among these organic acids are hydrochloric acid, sulfuric acid and organic acid having an acid dissociation constant of 2.5 or less in water. Even more desirable among these organic acids are those having an acid dissociation constant of 2.5 or less in water. In some detail, methanesulfonic acid, oxalic acid, phthalic acid and malonic acid are more desirable, particularly oxalic acid.

In the case where the hydrolyzable group of the organosilane is an alkoxy group and the acid catalyst is an organic acid, the carboxyl group or sulfo group of the organic acid supplies proton, making it possible to reduce the amount of water to be added. In this case, the amount of water to be added per mol of alkoxide group of organosilane is normally from 0 to 2 mols, preferably from 0 to 1.5 mols, more preferably from 0 to 1 mol, particularly from 0 to 0.5 mols. In the case where an alcohol is used as a solvent, it is also preferred that substantially no water be added.

The amount of the acid catalyst, if it is an inorganic acid, is from 0.01 to 10 mol-%, preferably from 0.1 to 5 mol-%. The optimum amount of the acid catalyst, if it is an organic acid, depends on the amount of water. In the case where water is added, the optimum amount of the acid catalyst is from 0.01 to 10 mol-%, preferably from 0.1 to 5 mol-% based on the amount of the hydrolyzable group. In the case where substantially no water is added, the optimum amount of the acid catalyst is from 1 to 500 mol-%, preferably from 10 to 200 mol-%, more preferably from 20 to 200 mol-%, even more preferably from 50 to 150 mol-%, particularly from 50 to 120 mol-% based on the amount of the hydrolyzable group.

The treatment is carried out by stirring the dispersion at a temperature of from 15° C. to 100° C. The treatment conditions are preferably adjusted by the reactivity of the organosilane.

(Metal Chelate Compound)

As the metal chelate compound to be used as a catalyst for dispersibility improvement treatment of inorganic particulate material by the hydrolyzate and/or condensation product of organosilane in the invention there may be preferably used one having an alcohol represented by formula R⁰¹OH (in which R⁰¹ represents a C₁-C₁₀alkyl group) and/or a compound represented by formula R⁰²COCH²COR⁰³ (in which R⁰² represents a C₁-C₁₀ alkyl group and R⁰³ represents a C₁-C₁₀ alkyl group or C₁-C₁₀ alkoxy group) as a ligand and a metal selected from the group consisting of zirconium, titanium and aluminum as a central metal without any limitation. Two or more metal chelate compounds may be used in combination if they fall within this category.

The metal chelate compound to be used in the invention is preferably selected from the group consisting of compounds represented by the following formulae:
Zr(OR⁰¹)ₚ₁₍R⁰²COCHCOR⁰³)ₚ₂;
Ti(OR⁰¹)_{q1}(R⁰²COCHCOR⁰³)_{q2}; and
Al(OR⁰¹)ᵣ₁(R⁰²COCHCOR⁰³)ᵣ₂
The metal chelate compound of the invention acts to accelerate the condensation reaction of the organosilane compound.

R⁰¹ and R⁰² in the metal chelate compound may be the same or different and each represent a C₁-C₁₀ alkyl group such as ethyl, n-propyl, i-propyl, n-butyl, s-butyl, t-butyl and n-pentyl or C₆-C₁₀ aryl group such as phenyl. R⁰³ represents the same C₁-C₁₀ alkyl group or C₆-C₁₀ aryl group as defined in R⁰¹ and R⁰² or C₁-C₁₀ alkoxy group such as methoxy, ethoxy, n-propoxy, i-propoxy, n-butoxy, s-butoxy and t-butoxy. The suffixes p1, p2, q1, q2, r1 and r2 in these formulae each represent an integer determined to make tetradentate or hexadentate coordination.

Specific examples of these metal chelate compounds include zirconium chelate compounds such as tri-n-butoxy ethyl acetoacetate zirconium, di-n-butoxybis(ethyl acetoacetate)zirconium, n-butoxytris(ethylaceto acetate)zirconium, tetrakis(n-propylacetoacetate) zirconium, tetrakis(acetylacetoacetate)zirconium and tetrakis(ethylacetoacetate)zirconium, titanium compounds such as diisopropoxy bis(ethylacetoacetate) titanium, diisopropoxy bis(acetylacetate)titanium and diisopropoxy bis(acetylacetone)titanium, and aluminum chelate compounds such as diisopropoxyethyl acetoacetate aluminum, diisopropoxyacetylacetonate aluminum, isopropoxy bis(ethylacetoacetate)aluminum, isoproposy bis(acetylacetonate)aluminum, tris(ethyl acetoacetate)aluminum, tris(acetylacetonate)aluminum and monoacetyl acetonate bis(ethylacetoacetate) aluminum.

Preferred among these metal chelate compounds are tri-n-butoxyethyl acetoacetate zirconium, diisopropoxy bis(acetylacetonate)titanium, diisopropoxy ethyl acetoacetate aluminum and tris(ethylacetoacetate) aluminum. These metal chelate compounds may be used singly or in combination of two or more thereof. Alternatively, these metal chelate compounds may be used in the form of partial hydrolyzate.

The metal chelate compounds of the invention are preferably used in an amount of from 0.01 to 50% by weight, more preferably from 0.1 to 50% by weight, even more preferably from 0.5 to 10% by weight based on the weight of the organosilane from the standpoint of speed of condensation reaction and strength of coat layer.

(Other Additives)

It is preferred that the low refractive index layer of the invention properly comprise a known stainproofing agent such as silicone-based compound and fluorine-based compound, lubricant, etc. incorporated therein besides the aforementioned components for the purpose of providing properties such as stainproofness, water resistance, chemical resistance and slipperiness. These additives, if any, are preferably added in an amount of from 0.1 to 20% by weight, more preferably from 0.05 to 10% by weight, particularly from 0.1 to 5% by weight based on the total solid content of the low refractive index layer-forming curable composition.

Preferred examples of the silicone-based compound include those containing a plurality of dimethyl silyloxy units as repeating units and having substituents at the end of chain and/or in side chains thereof. The compound chain containing dimethyl silyloxy as repeating unit may contain structural units other than dimethyl silyloxy. The substituents may be the same or different. It is preferred that there be a plurality of substituents. Preferred examples of the substituents include groups containing acryloyl group, methacryloyl group, aryl group, cinnamoyl group, epoxy group, oxetanyl group, hydroxyl group, fluoroalkyl group, polyoxyalkylene group, carboxyl group, amino group, etc.

The molecular weight of the silicone-based compound is not specifically limited but is preferably 100,000 or less, particularly 50,000 or less, most preferably from 3,000 to 30,000. The content of silicon atoms in the silicone-based compound, too, is not specifically limited but is preferably 18.0% by weight or more, particularly from 25.0 to 37.8% by weight, most preferably from 30.0 to 37.0% by weight.

Preferred examples of the silicone-based compound include X-22-174DX, X-22-2426, X-22-164B, X22-164C, X-22-170DX, X-22-176D and X-22-1821 (produced by Shin-Etsu Chemical Co., Ltd.), FM-0725, FM-7725, FM-4421, FM-5521, FM-6621 and FM-1121 (produced by Chisso Corporation), and DMS-U22, RMS-033, RMS-083, UMS-182, DMS-H21, DMS-H31, HMS-301, FMS121, FMS123, FMS131, FMS141 and FMS221(produced by Gelest, Inc.). However, the invention is not limited to these products.

As the fluorine-based compound there is preferably used a compound having a fluoroalkyl group. The fluoroalkyl group preferably has from 1 to 20 carbon atoms, more preferably from 1 to 10 carbon atoms, and may have a straight-chain structure (e.g., —CF₂CH₃, —CH₂(CF₂)₄H, —CH₂(CF₂)₈CF₃, —CH₂CH₂(CF₂)₄H), a branched structure (e.g., —CH(CF₃)₂, —CH₂CF(CF₃)₂, —CH(CH₃)CF₂CF₃, —CH(CH₃)(CF₂)₅CF₂H) or an alicyclic structure (preferably 5-membered or 6-membered ring such as perfluorocyclohexyl group, perfluorocyclopentyl group or alkyl group substituted thereby). The fluoroalkyl group may had an ether bond (e.g., —CH₂OCH₂CF₂CF₃, —CH₂CH₂OCH₂C4F₈H, —CH₂CH₂OCH₂CH₂C₈F₁₇, —CH₂CH₂OCF₂CF₂OCF₂CF₂H). A plurality of the fluoroalkyl groups may be incorporated in the same molecule.

The fluorine-based compound preferably further contain substituents contributing to the formation of bond to the low refractive index layer or the compatibility with the low refractive index layer. These substituents may be the same or different. It is preferred that there be a plurality of these substituents. Preferred examples of these substituents include acryloyl group, methacryloyl group, vinyl group, aryl group, cinnamonyl group, epoxy group, oxetanyl group, hydroxyl group, polyoxyalkylene group, carboxyl group, and amino group.

The fluorine-based compound may be used in the form of polymer or oligomer with a fluorine-free compound. The fluorine-based compound may be used without any limitation on the molecular weight. The content of fluorine atoms in the fluorine-based compound is not specifically limited but is preferably 20% by weight or more, particularly from 30 to 70% by weight, most preferably from 40 to 70% by weight. Preferred examples of the fluorine-based compound include R-2020, M-2020, R3833 and M-3833 (produced by DAIKIN INDUSTRIES, Ltd.), and Megafac F-171, Megafac F-172 and Megafac F-179A, Diffenser MCF-300 (produced by DAINIPPON INK AND CHEMICALS, INCORPORATED). However, the invention is not limited to these products.

The low refractive index layer of the invention may properly comprise a known dustproofing agent and antistatic agent such as cationic surface active agent and polyoxyalkylene-based compound incorporated therein for the purpose of providing properties such as dustproofness and antistatic properties. Referring to these dustproofing agents and antistatic agents, the aforementioned silicone-based compound or fluorine-based compound may have its structural unit to act partly to perform such a performance. These additives, if any, are preferably added in an amount of from 0.01 to 20% by weight, more preferably from 0.05 to 105 by weight, particularly from 0.1 to 5% by weight based on the total solid content of the low refractive index layer-forming composition. Preferred examples of these compounds include Megafac F-150 (produced by DAINIPPON INK AND CHEMICALS, INCORPORATED), and SH-3748 (produced by Toray Dow Corning Co., Ltd.). However, the invention is not limited to these products.

The low refractive index layer may further contain microvoids. For the details of microvoids, reference can be made to JP-A-9-222502, JP-A-9-288201 and JP-A-11-6902.

In the invention, an organic particulate material may be used. Examples of the organic particulate material include compounds disclosed in JP-A-11-3820, paragraphs (0020)-(0038). The shape of the organic particulate material is the same as that of the aforementioned inorganic particulate material.

The thickness of the low refractive index layer is preferably from 30 to 200 nm, more preferably from 50 to 150 nm, particularly from 70 to 100 nm.

(Properties of Low Refractive Index Layer)

The low refractive index layer of the invention preferably has a surface energy of 26 mN/m or less, more preferably from 15 to 25.8 mN/m. When the surface energy of the low refractive index layer falls within the above defined range, it is advantageous in stainproofness.

The surface energy of a solid material can be determined by contact angle method, wet heat method or adsorption method as disclosed in “Nure no Kiso to Oyo (Elements and Application of Wetting)”, Realize Co., Ltd., Dec. 10, 1989. In the case of the anti-reflection film of the invention, contact angle method is preferably used. In some detail, two solutions having a known surface energy are dropped onto the surface of the anti-reflection film provided as a transparent protective film on the polarizing plate. The internal angle formed by the tangent line of the droplet and the surface of the film at the point of crossing of the surface of the droplet with the surface of the film is defined to be contact angle which is then subjected to calculation to determine surface energy. The contact angle of the surface of the outermost layer with respect to water is preferably 90° or more, more preferably 95° or more, particularly 100° or more.

The dynamic friction coefficient of the surface of the low refractive index layer is preferably 0.25 or less, more preferably from 0.05 to 0.25, particularly from 0.03 to 0.15. The term “dynamic friction coefficient” as used herein is meant to indicate the dynamic friction coefficient of the surface of the low refractive index layer with respect to a stainless steel sphere having a diameter of 5 mm developed when the stainless steel sphere is moved along the surface of the low refractive index layer at a speed of 60 cm/min under a load of 0.98 N.

The haze of the low refractive index layer is preferably 3% or less, more preferably 2% or less, most preferably 1% or less. The hardness of the low refractive index layer is preferably H or more, more preferably 2H or more, most preferably 3H or more as determined by pencil hardness test according to JIS K-5400. The scratch resistance of the low refractive index layer is preferably as small as possible as determined by Taber test according to JIS K-6902.

(Formation of Low Refractive Index Layer)

The low refractive index layer is preferably formed by subjecting a coating composition having a functional fluoropolymer, an organosilane compound, a polyfunctional polymerizable compound, an inorganic particulate compound, a metal chelate compound and optional components dissolved or dispersed therein to irradiation with light or electron beam or heating at the same time with or after spreading to cause crosslinking reaction or polymerization reaction.

In particular, in the case where the low refractive index layer is formed by the crosslinking reaction or polymerization reaction of the ionized radiation-curable compound, the crosslinking reaction or polymerization reaction is preferably effected in an atmosphere having an oxygen concentration of 10 vol-% or less. When the low refractive index layer is formed in an atmosphere having an oxygen concentration of 10 vol-% or less, an outermost layer excellent in physical strength and chemical resistance can be obtained. The oxygen concentration of the atmosphere is preferably 6 vol-% or less, more preferably 4 vol-% or less, particularly 2 vol-% or less, most preferably 1 vol-% or less.

The adjustment of the oxygen concentration to 10 vol-% or less is preferably carried out by replacing the atmosphere (nitrogen concentration: approx. 79 vol-%; oxygen concentration: approx. 21 vol-%) by other gases, particularly nitrogen (purging with nitrogen).

As the low refractive index layer there may be used a thin metal oxide layer. The metal oxide is preferably silicon dioxide or magnesium fluoride, more preferably silicon dioxide. The thickness of the thin metal oxide layer is controlled to a range of from 50 to 120 nm. When the thickness of the thin metal oxide layer falls within the above defined range, the average specular reflectance of the anti-reflection film can be reduced to 3% or less, making it possible to satisfy the aforementioned numerical relationship (1).

The thin metal layer or thin metal oxide layer may be formed by sputtering method, vacuum metallizing method, ion plating method, plasma CVD method, plasma PVD method or particulate metal or metal oxide coating method. Preferred among these methods are sputtering method, vacuum metallizing method and ion plating method. Particularly preferred among these methods is sputtering method.

As the method of forming a thin metal layer using sputtering method there may be used DC magnetron sputtering method or RF magnetron sputtering method using a metal target.

As the method of forming a thin metal oxide layer using sputtering method there may be used DC magnetron sputtering method, RF magnetron sputtering method or AC magnetron sputtering method using a metal target or RF magnetron sputtering method using a metal oxide target. Taking into account the film forming speed and the stability of discharge, the thin metal oxide layer is preferably formed by AC magnetron sputtering method while the flow rate of oxygen being controlled by plasma emission monitoring method.

As previously mentioned, in the anti-reflection film of the invention, it is desirable for the improvement of white color that the agglomeration of the inorganic particulate material incorporated in the low refractive index layer be inhibited. It is also desirable for further improvement of white color that the outermost surface of the anti-reflection film on the anti-reflection film side thereof have a specific shape. The formation of a specific surface shape can be attained by (a) the incorporation of specific inorganic particulate material in the low refractive index layer and the surface treatment of the inorganic particulate material and (b) the control over the drying speed (described later).

In an embodiment where the anti-reflection film of the invention is formed by spreading a low refractive index layer-forming composition over the high refractive index layer, it is preferred that the surface of the high refractive index layer have a specific surface roughness as previously mentioned in (high refractive index layer). As previously mentioned in (ultrafine division of high refractive particulate material), it is preferred that the high refractive index layer comprise a high refractive particulate material having a specific size incorporated therein. It is preferred that the aforementioned low refractive index layer-forming composition be spread over the high refractive index layer. By spreading the low refractive index layer-forming composition over the high refractive index layer, the low refractive index layer can be formed more uniformly, making it possible to contribute to the improvement of white color to advantage.

(Overcoat Layer)

In the anti-reflection film of the invention, an overcoat layer containing at least one compound selected from the group consisting of fluorine-containing compound, silicon-containing compound and long-chain alkyl group-containing compound having four or more carbon atoms is preferably laminated on the low refractive index layer.

As the fluorine-containing compound to be incorporated in the overcoat layer there is preferably used a fluorine-containing surface active agent, fluorine-containing polymer, fluorine-containing ether or fluorine-containing silane compound.

The hydrophilic moiety of the fluorine-containing surface active agent may be anionic, cationic, nonionic or amphoteric. In the fluorine-containing surface active agent, some or whole of the hydrogen atoms in the hydrocarbon constituting the hydrophobic moiety are replaced by fluorine atom.

The fluorine-containing polymer is preferably synthesized by the polymerization reaction of an ethylenically unsaturated monomer containing fluorine atoms (fluorine-containing monomer). Examples of the fluorine-containing monomer include fluoroolefins (e.g., fluooroethylene, vinylidene fluoride, tetrafluoro ethyelne, hexafluoroethylene, hexafluoro propylene, perfluoro-2,2-dimethyl-1,3-dioxol), ester of fluorine-substituted alcohol with acrylic or methacrylic acid, and fluorinated vinyl ether.

As the overcoat layer-forming fluorine-containing polymer there may be used a copolymer of two or more fluorine-containing monomers. Alternatively, a copolymer of a fluorine-containing monomer with a fluorine atom-free monomer may be used. Examples of the fluorine atom-free monomer include olefines (e.g., ethylene, propylene, isoprene, vinyl chloride, vinylidene chloride), acrylic acid esters (e.g., methyl acrylate, methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrenes and derivatives thereof (e.g., styrene, divinyl benzene, vinyl toluene, α-methylstyrene), vinyl ethers (e.g., methyl vinyl ether), vinyl esters (e.g., vinyl acetate, vinyl propionate, vinyl cinnamate), acrylamides (e.g., N-t-butyl acrylamide, N-cyclohexylacrylamide), methacrylamides, and acrylonitriles and derivatives thereof.

The fluorine-containing polymer may comprise a repeating unit composed of polyorganosiloxane incorporated therein to provide the overcoat layer with slipperiness. The fluorine-containing polymer comprising a repeating unit composed of polyorganosiloxane incorporated therein can be obtained, e.g., by the polymerization of a polyorganosiloxane terminated by a reactive group with a fluorine-containing monomer. The reactive groups can be formed, e.g., by chemically bonding an ethylenically unsaturated monomer (e.g., acrylic acid and ester thereof, methacrylic acid and ester thereof, vinyl ether, styrene, derivatives thereof) to the end of the organosiloxane.

As the fluorine-containing polymer there may be used a commercially available fluorine-containing polymer such as Cytop and Lumiflron (produced by Asahi Glass Company), Teflon AF (produced by Du Pont Inc.) and Opstar (produced by JSR CO., LTD.).

A fluorine-containing ether is a compound that is normally used as a lubricant. Examples of the fluorine-containing ether include perfluoropolyethers and derivatives thereof.

Examples of the fluorine-containing silane compound include silane compounds containing perfluoroalkyl group (e.g., heptadecafluoro-1,2,2,2-tetradecyl)triethoxysilane). A commercially available fluorine-containing silane compound such as KBM-7803 and KP-801M (produced by Shin-Etsu Chemical Co., Ltd.) may be used.

The fluorine-containing compound to be incorporated in the overcoat layer preferably contains fluorine atoms in an amount of from 30 to 80% by weight, more preferably from 40 to 75% by weight.

As the overcoat layer, a fluorine-containing polymer is particularly preferred. The fluorine-containing polymer is preferably further crosslinked. In some detail, the fluorine-containing polymer may comprise a crosslinkable group incorporated therein or may be crosslinked with a crosslinking agent. The crosslinkable group is preferably incorporated in the fluorine-containing polymer as a side chain. During the synthesis of the fluorine-containing polymer, a monomer having a crosslinkable group can be copolymerized to introduce the crosslinkable group into the fluorine-containing polymer as a side chain. Alternatively, by reacting a compound having two or more crosslinkable groups (crosslinking agent) with the side chain of the fluorine-containing polymer, the fluorine-containing polymer can be crosslinked. The crosslinkable group is preferably a functional group that, when irradiated with radiation such as light (preferably ultraviolet rays) and electron beam (EB) or heated, undergoes reaction to crosslink the fluorine-containing polymer. The crosslinkable group is more preferably a functional group that, when irradiated with radiation, undergoes reaction to crosslink the fluorine-containing polymer. The crosslinkable group is most preferably a functional group that, when irradiated with ultraviolet rays, undergoes reaction to crosslink the fluorine-containing polymer. In other words, when the crosslinking reaction temperature is low, the planarity of the support is little deteriorated, making it possible to reduce the length of the heating line at the production step. The irradiation with ultraviolet rays is also advantageous in that it requires relatively inexpensive facilities.

Examples of the crosslinkable group include acryloyl groups, methacryloyl groups, allyl groups, isocyanate groups, epoxy groups, alkoxysilyl groups, aziridine groups, oxazoline groups, aldehyde groups, carbonyl groups, hydrazide groups, carboxyl groups, methylol groups, and active methylene groups. The thickness of the overcoat layer is preferably from 2 to 50 nm, more preferably from 5 to 30 nm, most preferably from 5 to 20 nm.

(Hard Coat Layer)

The hard coat layer may be provided on the surface of the transparent support to provide the anti-reflection film with physical strength. It is particularly preferred that the hard coat layer be provided interposed between the transparent support and the aforementioned high refractive index layer (or middle refractive index layer).

The hard coat layer is preferably formed by the crosslinking reaction or polymerization reaction of an ionized radiation-curable compound, e.g., by spreading a coating composition containing an ionized radiation-curable polyfunctional monomer or polyfunctional oligomer over a transparent support, and then allowing the polyfunctional monomer or polyfunctional oligomer to undergo crosslinking reaction or polymerization reaction,

The functional group in the ionized radiation-curable polyfunctional monomer or polyfunctional oligomer is preferably photopolymerizable, electron ray-polymerizable or radiation-polymerizable, particularly photopolymerizable. Examples of the photopolymerizable functional group include unsaturated polymerizable functional groups such as (meth)acryloyl group, vinyl group, styryl group and allyl group. Preferred among these unsaturated polymerizable functional groups is (meth)acryloyl group.

Specific examples of the photopolymerizable polyfunctional monomer having a photopolymerizable functional group include those listed with reference to the high refractive index layer. The polymerization is preferably effected in the presence of a photopolymerization initiator or photosensitizer. The photopolymerization reaction is preferably carried out by the irradiation with ultraviolet rays after the spreading and drying of the hard coat layer coating composition.

The hard coat layer may comprise an oligomer and/or polymer having a weight-average molecular weight of 500 or more incorporated therein to render itself brittle. Examples of the oligomer and polymer include (meth)acrylate-based, cellulose-based and styrene-based polymers, urethane acrylate, and polyester acrylate. Preferred examples of the oligomer and polymer include polyglycidyl (meth)acrylate and polyallyl (meth)acrylate having a functional group in its side chain.

The content of the oligomer and/or polymer in the hard coat layer is preferably from 5 to 80% by weight, more preferably from 25 to 70% by weight, particularly from 35 to 65% by weight based on the total weight of the hard coat layer.

The hardness of the hard coat layer is H or more, more preferably 2H or more, most preferably 3H or more as determined by pencil hardness test according to JIS K5400. The abrasion loss of the specimen between before and after the test as determined according to JIS K5400 is preferably as small as possible.

In the case where the hard coat layer is formed by the crosslinking reaction or polymerization reaction of the ionized radiation-curable compound, the crosslinking reaction or polymerization reaction is preferably effected in an atmosphere having an oxygen concentration of 10 vol-% or less. When the hard coat layer is formed in an atmosphere having an oxygen concentration of 10 vol-% or less, a hard coat layer excellent in physical strength and chemical resistance can be formed. The crosslinking reaction or polymerization reaction of the ionized radiation-curable compound is preferably effected in an atmosphere having an oxygen concentration of 6 vol-% or less, more preferably 4 vol-% or less, particularly 2 vol-% or less, most preferably 1 vol-% or less.

The adjustment of the oxygen concentration to 10 vol-% or less is preferably carried out by replacing the atmosphere (nitrogen concentration: approx. 79 vol-%; oxygen concentration: approx. 21 vol-%) by other gases, particularly nitrogen (purging with nitrogen).

The hard coat layer is preferably formed by spreading a hard coat layer-forming coating composition over the surface of a transparent support.

As the coating solvent there is preferably used a ketone-based solvent exemplified with reference to the high refractive index layer. The use of such a ketone-based solvent makes it possible to further improve the adhesion between the transparent support (particularly triacetyl cellulose support) and the hard coat layer. Particularly preferred examples of the ketone-based solvent include methyl ethyl ketone, methyl isobutyl ketone, and cyclohexanone. The coating solvent may contain solvents other than the ketone-based solvents exemplified with reference to the high refractive index layer. The coating solvent preferably contains such a ketone-based solvent in an amount of 10% by weight or more based on the total weight of the solvents contained in the coating composition. The content of the ketone-based solvent is more preferably 30% by weight or more, more preferably 60% by weight or more.

(Other Additives)

The hard coat layer may comprise at least one of additives such as coupling agent, leveling agent, thixotropic agent, antistatic agent, inorganic material and organic material incorporated therein in particulate or other form.

(Other Layers in Anti-Reflection Film)

The anti-reflection film may comprise other layers incorporated therein besides the aforementioned layers as necessary. Further, an adhesion layer, a shield layer, a slip layer or an antistatic layer may be provided. The shield layer is provided to block electromagnetic wave or infrared rays.

(Method of Producing Anti-Reflection Film)

The various layers in the anti-reflection film can be formed by a coating method such as wire bar coating method, gravure coating method, microgravure coating method and die coating method. In order to minimize the wet spread and hence eliminate drying unevenness, microgravure coating method or gravure coating method is preferred.

It is desirable from the standpoint of production cost that at least two of the plurality of optical thin layers of the anti-reflection film of the invention be formed at a step of feeding the support film once, forming the various optical thin layers and winding the film. In the case where the anti-reflection layer has a three-layer structure, it is more desirable that the three layers be formed at one step. This type of production method can be attained by providing longitudinally a coating station and sets of drying and curing zone in a plurality of numbers, preferably the same number as that of the optical thin layers, between the point of feeding of support film and the point of winding of support film in the coating machine.

FIG. 2 illustrates an example of the device configuration. The example shown in FIG. 2 comprises a first coating station (102), a first drying zone (103), a first UV emitter (104), a second coating station (105), a second drying zone (106), a second UV emitter (107), a third coating station (108), a third drying zone (109) a third UV emitter (110) and a post-drying zone (111) in one step between feeding (101) of roll film and winding (112) of roll film. In this arrangement, three or less functional layers, e.g., middle refractive index layer, high refractive index layer and low refractive index layer or hard coat layer, high refractive index layer and low refractive index layer can be formed at one step. In other preferred embodiments, a device configuration wherein the number of coating stations is reduced to two may be formed such that only two layers, i.e., middle refractive index layer and high refractive index layer are formed at one step. The results of examination of the surface conditions, thickness, etc. are fed back to raise the yield. Alternatively, a device configuration wherein the number of coating stations is raised to four is formed such that a hard coat layer, a middle refractive index layer, a high refractive index layer and a low refractive index layer are formed at one step to drastically reduce the coating cost.

(Drying Speed)

In the preparation of the anti-reflection film of the invention, the drying speed at the step of drying the coat layer is preferably controlled. In a particularly preferred embodiment, the drying speed at the drying step during the process of forming the low refractive index layer is controlled. In some detail, the drying speed is preferably from 0.10 to 1.5 g/m², more preferably from 0.12 to 1.5 g/m², even more preferably from 0.15 to 1.0 g/m². When the drying speed is not greater than the upper limit, no such defectives as drying unevenness and brushing due to latent heat of evaporation occur to advantage. Further, when the drying speed is not smaller than the lower limit, there occur no such defectives as agglomeration of inorganic particulate material in the coat layer causing the occurrence of fine roughness on the surface of the film resulting in the rise of scattering of light by the surface of the film and hence the occurrence of white color that can impair the viewability and display quality. Accordingly, when the drying speed falls within the above defined range, the entire surface of the cured layer can be provided with desired uniform surface shape and the dispersion of inorganic particulate material in the cured layer can be sufficiently maintained.

The drying speed can be determined in the following manner.

The solvent in the coating solution is previously evaporated. The percent composition in the concentration of solid content is then determined by gas chromatography. The coat is sampled at an arbitrary time after coating. The concentration of solid content of the coat thus sampled is then used to determine the evaporation speed.

The drying speed can be controlled by the concentration of the material of the coat layer and the coating solution, the drying temperature, the drying air flow rate, etc.

<Protective Film for Polarizing Plate>

In order to use an anti-reflection film as a surface protective film for polarizing layer (protective film for polarizing plate) during the preparation of the polarizing plate of the invention, it is preferred that the transparent support be hydrophilicized on the side thereof opposite the anti-reflection layer, i.e., the side on which it is stuck to the polarizing layer to improve the adhesion to the polarizing layer mainly composed of polyvinyl alcohol.

In the case where as the protective film for polarizing plate there is used an anti-reflection film, it is particularly preferred that as the transparent support for anti-reflection film there be used a triacetyl cellulose film.

As methods of preparing the protective film for polarizing plate of the invention there can be proposed two methods, i.e., (1) method which comprises spreading the coating solution of the aforementioned layers (e.g., high refractive index layer, hard coat layer, outermost layer) over one side of a transparent support which has been previously saponified and (2) method which comprises spreading the coating solution of the aforementioned layers (e.g., high refractive index layer, hard coat layer, outermost layer) over one side of a transparent support, and then saponifying the transparent support on the side thereof on which it is stuck to the polarizing layer. From the standpoint of assurance of adhesion between the support and the layer provided thereon, e.g., hard coat layer, it is preferred that the method (2), which prevents the transparent support from being hydrophilicized on the side thereof on which the hard coat layer is provided, be used.

(Saponification)

(1) Dipping Method

This is a method which comprises dipping the anti-reflection film in an alkaline solution under proper conditions to saponify the entire surface of the film having reactivity with alkali. This method is advantageous in cost because it requires no special facilities. The alkaline solution is preferably an aqueous solution of sodium hydroxide. The concentration of the alkaline solution is preferably from 0.5 to 3 mols/l, particularly from 1 to 2 mols/l. The temperature of the alkaline solution is preferably from 30° C. to 70° C., particularly from 40° C. to 60° C.

The aforementioned combination of saponifying conditions is preferably a combination of relatively mild conditions but can be predetermined by the material and configuration of the anti-reflection film and the target contact angle. It is preferred that the anti-reflection film which has been dipped in the alkaline solution be thoroughly washed with water or dipped in a dilute acid to neutralize the alkaline component so that the alkaline component is not left in the film.

When the anti-reflection film is saponified, the transparent support is hydrophilicized on the side thereof opposite the anti-reflection layer. The protective film for polarizing plate is used in such an arrangement that the hydrophilicized surface of the transparent support comes in contact with the polarizing layer. The hydrophilicized surface of the transparent support is effective for the improvement of the adhesion to the adhesive layer mainly composed of polyvinyl alcohol.

Referring to saponification, the contact angle of the surface of the transparent support on the side thereof opposite the anti-reflection layer with respect to water is preferably as small as possible from the standpoint of adhesion to the polarizing layer. On the other hand, since the dipping method is subject to damage by alkali even on the surface of the transparent support on the anti-reflection layer side thereof, it is important to use minimum required reaction conditions. In the case where as an index of damage of anti-reflection layer by alkali there is used the contact angle of the surface of the transparent support on the side thereof opposite the anti-reflection layer, i.e., on the side on which it is stuck to the polarizing layer of the anti-reflection film with respect to water, the contact angle is preferably from 200 to 50°, more preferably from 30° to 50°, even more preferably from 40° to 50°, if the support is a triacetyl cellulose film in particular. When the contact angle is 50° or less, the resulting transparent support exhibits a good adhesion to the polarizing layer to advantage. On the contrary, when the contact angle is 20° or more, the resulting anti-reflection layer doesn't undergo too much damage and is not subject to loss of physical strength and light-resistance.

(2) Alkaline Solution Coating Method

As a method of avoiding the damage of the anti-reflection layer in the aforementioned dipping method there is preferably used an alkaline solution coating method which comprises spreading an alkaline solution only over the surface of the transparent support on the side thereof opposite the anti-reflection layer, and heating, rinsing and drying the coat layer. The term “spreading” as used herein is meant to indicate that the alkaline solution or the like comes in contact with only the surface of the transparent support to be saponified. It is preferred that the saponification be effected such that the contact angle of the surface of the transparent support on the side thereof on which it is stuck to the anti-reflection film with respect to water is from 10° to 50°. Besides spreading, spraying and contact with a belt or the like impregnated with an alkaline solution are included. Since the use of these methods requires the provision of separate facilities and steps for spreading the alkaline solution, the dipping method (1) is preferred from the standpoint of cost. However, since the coating method involves the contact with only the surface of the transparent support to be saponified, it is advantageous in that the opposite side of the transparent support can be made of a material which is easily affected by alkaline solution. For example, the vacuum deposit or sol-gel layer is subject to various effects such as corrosion, dissolution and exfoliation by alkaline solution and is preferably not formed by the dipping method but may be formed by the coating method without any problems because it requires no contact with the alkaline solution.

Both the aforementioned saponification methods (1) and (2) can be conducted after the formation of the various layers on the support unwound from the roll. Therefore, these saponification methods can be each conducted as a continuous step following the aforementioned step of producing the anti-reflection film. Further, by subsequently conducting the step of sticking the film to a polarizing layer of continuous length unwound, the polarizing plate can be prepared more efficiently than the similar process conducted in the form of sheet.

<Polarizing Plate>

The preferred polarizing plate of the invention has an anti-reflection film of the invention provided on at least one side thereof as a protective film for polarizing layer (protective film for polarizing plate) as shown in FIG. 1. In FIG. 1, the surface of the transparent support 1 of the anti-reflection film 11 having the anti-reflection layer 10 formed by the middle refractive index layer 3, the high refractive index layer 4 and the low refractive index layer 5 on the side thereof free of anti-reflection layer 10 is bonded to the polarizing layer 7 with the adhesive layer 6 made of polyvinyl alcohol interposed therebetween. The protective film 8 for polarizing layer is bonded to the main surface of the polarizing layer 7 on the side thereof on which it is bonded to the anti-reflection film 11 with the adhesive layer 6 interposed therebetween. The sticking agent layer 9 is provided on the main surface of the other protective film 8 on the side thereof opposite the main surface on which it is bonded to the polarizing layer.

The use of the anti-reflection film of the invention as a protective film for polarizing plate makes it possible to prepare a polarizing plate having an anti-reflection capacity excellent in physical strength and light-resistance and drastically reduce the cost and thickness of display.

Examples of the other protective film 8 include related art films known as protective films for the porlarizing plate. Plastic films illustrated in “Transparent Support” may be used.

Further, the constitution of a polarizing plate comprising an anti-reflection film of the invention as one protective film for polarizing plate and an optical compensation film having an optical anisotropy described later as the other protective film for polarizing layer makes it possible to prepare a polarizing plate that provides a liquid crystal display with an improved contrast in the daylight and a drastically raised horizontal and vertical viewing angle.

<Optical Compensation Film>

The optical compensation film (retarder film) is used to improve the viewing angle properties of a liquid crystal display screen. As an optical compensation film there may be used any material known as such. In respect to the rise of viewing angle, there is preferably used an optical compensation film having an optically anisotropic layer made of a compound having a discotic structural unit wherein the angle of the discotic compound with respect to the support has a local randomness but changes with the distance from the transparent support. This angle preferably has a local randomness but changes with the rise of the distance from the support side of the optically anisotropic layer.

In the case where the optical compensation film is used as a protective film for polarizing layer, the optical compensation film is preferably saponified on the side thereof on which it is stuck to the polarizing layer. The saponification of the optical compensation film is preferably conducted in the same manner as mentioned above.

Other preferred embodiments include a configuration wherein the optically anisotropic layer further comprises a cellulose ester, a configuration wherein an alignment layer is formed interposed between the optically anisotropic layer and the transparent support, and a configuration wherein the transparent support of the optical compensation film having an optically anisotropic layer has an optical anisotropy such that the optical anisotropy of the optical compensation film can be compensated.

<Image Display>

The polarizing plate having an anti-reflection film can be applied to an image display such as liquid crystal display (LCD) and electroluminescence display (ELD). A polarizing plate having an anti-reflection film of the invention as shown in FIG. 1 is bonded to the glass of liquid crystal cell of liquid crystal display directly or with other layers interposed therebetween.

The polarizing plate comprising an anti-reflection film of the invention is preferably used in transmission type, reflection type or semi-transmission type liquid crystal displays of mode such as twisted nematic (TN), supertwisted nematic (STN), vertical alignment (VA), in-plane switching (IPS) and optically compensated bend cell (OCB).

(TN Mode Liquid Crystal Display)

A TN mode liquid crystal cell is most widely used as a color TFT liquid crystal display. For details, reference can be made to various literatures. Referring to the alignment in the liquid crystal cell during the black display of TN mode, rod-shaped liquid crystal molecules are oriented vertically at the central part of the cell but horizontally in the vicinity of the substrate of the cell.

(OCB Mode Liquid Crystal Display)

An OCB mode liquid crystal cell is a liquid crystal cell of bend alignment mode wherein rod-shaped liquid crystal molecules are oriented in substantially opposing directions (symmetrically) from the upper part to the lower part of the liquid crystal cell. A liquid crystal display comprising a bend alignment mode liquid crystal cell comprises devices disclosed in U.S. Pat. Nos. 4,583,825 and 5,410,422 oriented symmetrically with each other from the upper part to the lower part of the liquid crystal cell. Therefore, the bend alignment mode liquid crystal cell has a self optical compensation capacity. Accordingly, this liquid crystal mode is also called OCB (optically compensated bend) liquid crystal mode.

In OCB mode liquid crystal cell, too, rod-shaped liquid crystal molecules are oriented vertically at the central part of the liquid crystal cell but are oriented horizontally in the vicinity of the substrate of the cell during black display as in TN mode.

(VA Mode Liquid Crystal Display)

In a VA mode liquid crystal cell, rod-shaped liquid crystal molecules are oriented vertically oriented when no voltage is applied.

VA mode liquid crystal cells include (1) liquid crystal cell in VA mode in a narrow sense in which rod-shaped liquid crystal molecules are oriented substantially vertically when no voltage is applied but substantially horizontally when a voltage is applied (as disclosed in JP-A-2-176625). In addition to the VA mode liquid crystal cell, there have been provided (2) liquid crystal cell of VA mode which is multidomained to expand the viewing angle (MVA mode) (as disclosed in SID97, Digest of Tech. Papers (preprint) 28 (1997), 845), (3) liquid crystal cell of mode in which rod-shaped molecules are oriented substantially vertically when no voltage is applied but oriented in twisted multidomained mode when a voltage is applied (n-ASM mode, CAP mode) (as disclosed in Preprints of Symposium on Japanese Liquid Crystal Society Nos. 58 to 59, 1988 and (4) liquid crystal cell of SURVALVAL mode (as reported in LCD International 98).

(IPS Mode Liquid Crystal Display)

An IPS mode liquid crystal cell is arranged such that liquid crystal molecules are always rotated in a horizontal plane with respect to the substrate and, when no voltage is applied, are oriented at some angle with respect to the longitudinal direction of the electrode. When an electric field is applied, the liquid crystal molecules are oriented in the direction of electric field. The disposition of polarizing plates having a liquid crystal cell interposed therebetween at a predetermined angle makes it possible to change the light transmission. As the liquid crystal molecule there is used a nematic liquid crystal having a positive dielectric anisotropy Δ∈. The thickness (gap) of the liquid crystal layer is from more than 2.8 μm to less than 4.5 μm. This is because when the retardation Δn·d ranges from more than 0.25 μm to less than 0.32 μm, there can be provided transmission properties showing little or no wavelength dependence in the visible light range. By properly combining polarizing plates, a maximum transmission can be obtained when the liquid crystal molecules are rotated at an angle of 45° from the rubbing direction to the direction of electric field. The thickness (gap) of the liquid crystal layer is controlled by polymer beads. It goes without saying that the same gap can be obtained also by the use of glass beads, glass beads or columnar space made of resin. The liquid crystal molecule is not specifically limited so far as it is a nematic liquid crystal. The greater the dielectric anisotropy Δ∈ is, the more can be reduced the driving voltage. The smaller the refractive anisotropy Δn is, the greater can be the thickness (gap) of the liquid crystal layer, the shorter can be the time required to enclose liquid crystal and the less can be the gap dispersion.

(Other Liquid Crystal Modes)

For ECB mode and STN mode liquid crystal displays, the polarizing plate of the invention can be provided with the same conception as described above.

Further, in the case where the polarizing plate of the invention is used in a transmission type or semi-transmission type liquid crystal display, it can be used in combination with a commercially available brightness enhancement film (e.g., polarization separating film having a polarization selective layer such as “D-BEF” (produced by Sumitomo 3M Co., Ltd.)) to obtain a display having a higher viewability.

Moreover, when combined with a λ/4 plate, the polarizing plate of the invention can be used as a polarizing plate for reflective liquid crystal or surface protective plate for organic EL display to reduce the amount of light reflected by the surface and interior of the display.

### EXAMPLE

The invention will be further described in the following examples, but the scope of the invention should not be construed as being limited thereto.

### Example 1 and Comparative Example 1

(Preparation of Anti-Reflection Film (AF))

(Preparation of Coating Solution for Hard Coat Layer (HCLL))

The following compositions were put in a mixing tank wherein they were then stirred to prepare a hard coat layer coating solution.

To 750.0 parts by weight of trimethylolpropane triacrylate “TMPTA” (produced by NIPPON KAYAKU CO., LTD.) were added 270.0 parts by weight of a poly (glycidylmethacrylate) having a weight-average molecular weight of 15,000, 730.0 parts by weight of methyl ethyl ketone, 500.0 parts by weight of cyclohexanone and 50.0 parts by weight of a photopolymerization initiator “Irgacure 184” (produced by Ciba Specialty Chemicals Inc.). The mixture was then stirred. The mixture was then filtered through a polypropylene filter having a pore diameter of 0.4 μm to prepare a coating solution for hard coat layer (HCLL).

(Preparation of Coating Solution for Hard Coat Layer (HCLL-2))

The following compositions were put in a mixing tank wherein they were then stirred to prepare a hard coat layer coating solution.

To 742 parts by weight of pentaerythritol triacrylate “PET-30” (produced by NIPPON KAYAKU CO., LTD.) were added 277 parts by weight of a poly (glycidylmethacrylate) having a weight-average molecular weight of 15,000, 112 parts by weight of a silane coupling agent “KBM-5103” (produced by Shin-Etsu Chemical Co., Ltd.), 728 parts by weight of methyl ethyl ketone, 503 parts by weight of cyclohexanone, 51 parts by weight of a photopolymerization initiator “Irgacure 184” (produced by Ciba Specialty Chemicals Inc.) and 1.5 parts by weight of a fluorine-based surface modifier “F-476” (produced by DAINIPPON INK AND CHEMICALS, INCORPORATED; The mixture was then stirred. The mixture was then filtered through a polypropylene filter having a pore diameter of 0.4 μm to prepare a coating solution for hard coat layer (HCLL-2).

(Preparation of Coating Solution for Hard Coat Layer (HCLL-3))

The following compositions were put in a mixing tank wherein they were then stirred to prepare a hard coat layer coating solution.

To 100 parts by weight of a particulate zirconia-containing hard coat layer composition solution “DeSolite Z7404” (produced by JSR Co., Ltd.) were added 31 parts by weight of an ultraviolet-curing resin “DPHA” (produced by NIPPON KAYAKU CO., LTD.), 10 parts by weight of a silane coupling agent “KBM-5103” (produced by Shin-Etsu Chemical Co., Ltd.), 8.9 parts by weight of “KE-P150” (particulate silica having an average particle diameter of 1.5 μm; produced by NIPPON SHOKUBAI CO., LTD.; 30% MIBK dispersion; used after 20 minutes of dispersion at 10,000 rpm by a polytron dispersing machine), 3.4 parts by weight of MXS-300 (particulate crosslinked PMMA having an average particle diameter of 3 μm; produced by Soken Chemical & Engineering Co., Ltd.; 30% MIBK dispersion; used after 20 minutes of dispersion at 10,000 rpm by a polytron dispersing machine), 29 parts by weight of methyl ethyl ketone and 13 parts by weight of methyl isobutyl ketone. The mixture was then stirred. The mixture was then filtered through a polypropylene filter having a pore diameter of 0.4 μm to prepare a coating solution for hard coat layer (HCLL-3).

{Preparation of Particulate Titanium Dioxide}

A cobalt-containing particulate titanium dioxide doped with cobalt was prepared in the same manner as in Example 3 of JP-A-2003-327430 except that the weight ratio of the various elements (TiO₂:CO₃O₄:Al₂O₃:ZrO₂) was changed to 90.5:3.0:4.0:0.5. The particulate titanium dioxide thus prepared was observed to have a rutile crystalline structure and had an average primary particle diameter of 40 nm and a specific surface area of 44 m²/g.

{Preparation of Dispersion of Particulate Titanium Dioxide (TL-1)}

257.1 g of the aforementioned particulate titanium dioxide, 41.1 g of a polymer dispersant having a weight-average molecular weight of 45,000 having the following structure and 701.8 g of cyclohexanone were mixed. The mixture was then subjected to dispersion with zirconia beads having a particle diameter of 0.1 mm using a dinomill. The dispersion was effected at a temperature of from 20° C. to 30° C. for 5 hours. Thus, a titanium dioxide dispersion (TL-1) having an average primary particle diameter of 45 nm wherein the proportion of particles having a particle diameter of 150 nm or more is 0% as observed on photograph taken under transmission type electron microscope (TEM) was prepared.

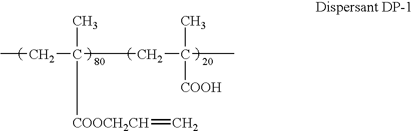

Mw:4.5×10⁴ (composition ratio by weight)

{Preparation of Dispersion of Particulate Titanium Dioxide (TL-2)}

A dispersion of particulate titanium dioxide (TL-2) was prepared in the same manner as in the preparation of the dispersion of particulate titanium dioxide (TL-1) except that the dispersion time was effected for 3 hours.

The dispersion of particulate titanium dioxide (TL-2) thus obtained comprised particles having a particle diameter of 150 nm or more in a proportion of 2.5% and particles having a particle diameter of 200 nm or more in a proportion of 0.5% and had an average primary particle diameter of 65 nm.

(Preparation of Coating Solution for Middle Refractive Index Layer (MLL-1))

To 99.1 parts by weight of the aforementioned titanium dioxide dispersion (TL-1) were added 68.0 parts by weight of a mixture of dipentaerythritol pentaacrylate and dipentaerythritol hexaacrylate “DPHA”, 3.6 parts by weight of a photopolymerization initiator “Irgacure 907”, 1.2 parts by weight of a photosensitizer “Kayacure DETX” (produced by NIPPON KAYAKU CO., LTD.), 279.6 parts by weight of methyl ethyl ketone and 1,049.0 parts by weight of cyclohexanone. The mixture was then thoroughly stirred. The mixture was then filtered through a polypropylene filter having a pore diameter of 0.4 μm to prepare a coating solution for middle refractive index layer (MLL-1).

(Preparation of Coating Solution for Middle Refractive Index Layer (MLL-2))

A coating solution for middle refractive index layer (MLL-2) was prepared in the same manner as in the preparation of the coating solution for middle refractive index layer (MLL-1) except that the aforementioned titanium dioxide dispersion (TL-2) was used.

(Preparation of Coating Solution for High Refractive Index Layer (HLL-1))

To 469.8 parts by weight of the aforementioned titanium dioxide dispersion (TL-1) were added 40.0 parts by weight of a mixture of dipentaerythritol pentaacrylate and dipentaerythritol hexaacrylate “DPHA”, 3.3 parts by weight of a photopolymerization initiator “Irgacure 907” (produced by Ciba Specialty Chemicals Inc.), 1.1 parts by weight of a photosensitizer “Kayacure DETX” (produced by NIPPON KAYAKU CO., LTD.), 526.2 parts by weight of methyl ethyl ketone and 459.6 parts by weight of cyclohexanone. The mixture was then stirred. The mixture was then filtered through a polypropylene filter having a pore diameter of 0.4 μm to prepare a coating solution for high refractive index layer (HLL-1).

(Preparation of Coating Solution for High Refractive Index Layer (HLL-2))

A coating solution for high refractive index layer (HLL-2) was prepared in the same manner as in the preparation of the coating solution for high refractive index layer (HLL-1) except that the aforementioned titanium dioxide dispersion (TL-2) was used.

(Preparation of Coating Solution for Low Refractive Index Layer (LLL))

{Synthesis of Functional Fluorine-Containing Polymer}

In a 100 ml stainless steel autoclave with stirrer were charged 40 ml of ethyl acetate, 14.7 g of hydroxyethyl vinyl ether and 0.55 f of dilauroyl peroxide. The air in the system was evacuated and replaced by nitrogen gas. 25 g of hexafluoropropylene (HFP) was then introduced into the autoclave which was then heated to 65° C. The pressure in the autoclave developed when the temperature in the autoclave reached 65° C. was 0.53 MPa (5.4 kg/cm²). The temperature in the autoclave was then kept at 65° C. where the reaction was continued for 8 hours. When the pressure in the autoclave reached 0.31 MPa (3.2 kg/cm²), heating was suspended so that the autoclave was allowed to cool. When the internal temperature of the autoclave reached to room temperature, the unreacted monomers were then removed. The autoclave was then opened to withdraw the reaction solution. The reaction solution thus obtained was then poured into a large excess of hexane. By removing the solvent by decantation, the precipitated polymer was withdrawn. The polymer thus obtained was dissolved in a small amount of ethyl acetate. The solution was then twice reprecipitated from hexane to remove thoroughly the residual monomers. After dried, a polymer was obtained in an amount of 28 g. Subsequently, 20 g of the polymer thus obtained was dissolved in 100 ml of N,N-dimethylacetamide. To the solution was then added dropwise 11.4 g of acrylic acid chloride under ice cooling. The mixture was then stirred at room temperature for 10 hours. To the reaction solution was then added ethyl acetate. The reaction solution was then washed with water. The organic phase was then extracted. The residue was then concentrated. The polymer thus obtained was then reprecipitated from hexane to obtain 19 g of a perfluoroolefin copolymer (1) having the following structure which is a functional fluorine-containing polymer. The refractive index of the polymer thus obtained was 1.421. 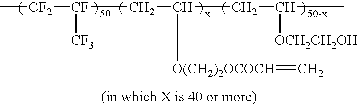
(Preparation of Sol a)

Into a reaction vessel equipped with an agitator and a reflux condenser were charged 120 parts by weight of methyl ethyl ketone, 100 parts by weight of acryloyl oxypropyl trimethoxysilane “KBM-5103” (produced by Shin-Etsu Chemical Co., Ltd.) and 3 parts by weight of diisopropoxy aluminum ethyl acetoacetate (trade name: Kelope EP-12, produced by Hope Chemical Co., Ltd.). The mixture was then stirred. To the mixture were then added 30 parts by weight of deionized water. The reaction mixture was allowed to undergo reaction at 60° C. for 4 hours, and then allowed to cool to room temperature to obtain a sol a. The compound thus obtained had a weight-average molecular weight of 1,600. The proportion of components having a molecular weight of from 1,000 to 20,000 in the oligomer components or high components was 100%. The gas chromatography of the reaction product showed that none of the acryloyloxy propyl trimethoxysilane as raw material remained.

(Preparation of Hollow Silica Dispersion a)

To 500 parts by weight of a hollow silica dispersion a {particle size: approx. 40 to 50 nm; shell thickness: 6 to 8 nm; refractive index: 1.31; solid concentration: 20%; main solvent: isopropyl alcohol; prepared according to Preparation Example 4 of JP-A-2002-79616 except that the particle size was varied} were added 30.5 parts by weight of acryloyloxy propyl trimethoxysilane and 1.51 parts by weight of diisopropoxy aluminum ethyl acetoacetate (trade name: Kelope EP-12, produced by Hope Chemical Co., Ltd.). The mixture was then stirred. To the mixture were then added 9 parts by weight of deionized water. The reaction mixture was allowed to undergo reaction at 60° C. for 8 hours, and then allowed to cool to room temperature. To the mixture were then added 1.8 parts by weight of acetyl acetone to obtain a dispersion. Thereafter, solvent substitution by distillation under reduced pressure was conducted at a pressure of 30 Torr while cyclohexanone was being added such that the silica content reached substantially constant. Finally, concentration adjustment was conducted to obtain a hollow silica dispersion a having a solid concentration of 20% by weight. The gas chromatography of the dispersion thus obtained showed that the amount of residual IPA was 0.5% by weight or less.

{Preparation of Coating Solution for Low Refractive Index Layer (LLL-1)}

62.5 parts by weight of the aforementioned perfluoroolefin copolymer (1), 1.9 parts by weight of a methacrylate-terminated silicone resin “X-22-164C” (produced by Shin-Etsu Chemical Co., Ltd.) and 4.7 parts by weight of a photo-radical generator “Irgacure 907” (produced by Ciba Specialty Chemicals Inc.) were added to a mixture of 1.390 parts by weight of methyl ethyl ketone and 43 parts by weight of cyclohexanone. The mixture was then stirred. The mixture was then filtered through a polypropylene filter having a pore diameter of 0.4 μm to prepare a coating solution for low refractive index layer (LLL-1).

{Preparation of Coating Solution for Low Refractive Index Layer (LLL-2)}

13.2 parts by weight of a mixture of dipentaerythritol pentaacrylate and dipentaerythritol hexaacrylate “DPHA” (produced by NIPPON KAYAKU CO., LTD.), 160 parts by weight of a hollow silica dispersion a, 2.8 parts by weight of “RMS-033” (silicone-based compound produced by Gelest, Inc.), 0.8 parts by weight of a photo-radical generator “Irgacure 907” (produced by Ciba Specialty Chemicals Inc.) and 24.8 parts by weight of a sol a were added to a mixture of 1,162.4 parts by weight of methyl ethyl ketone and 36 parts by weight of cyclohexanone. The mixture was then stirred. The mixture was then filtered through a polypropylene filter having a pore diameter of 0.4 μm to prepare a coating solution for low refractive index layer (LLL-2).

{Preparation of Coating Solution for Low Refractive Index Layer (LLL-3)}

5.6 parts by weight of a mixture of dipentaerythritol pentaacrylate and dipentaerythritol hexaacrylate “DPHA” (produced by NIPPON KAYAKU CO., LTD.), 22.4 parts by weight of the aforementioned perfluoroolefin copolymer (1), 80 parts by weight of a hollow silica dispersion a, 2.8 parts by weight of “RMS-033” (silicone-based compound produced by Gelest, Inc.), 0.8 parts by weight of a photo-radical generator “Irgacure 907” (produced by Ciba Specialty Chemicals Inc.) and 24.8 parts by weight of a sol a were added to a mixture of 1,227.6 parts by weight of methyl ethyl ketone and 36 parts by weight of cyclohexanone. The mixture was then stirred. The mixture was then filtered through a polypropylene filter having a pore diameter of 0.4 μm to prepare a coating solution for low refractive index layer (LLL-3).

{Preparation of Coating Solution for Low Refractive Index Layer (LLL-4)}

8.3 parts by weight of a mixture of dipentaerythritol pentaacrylate and dipentaerythritol hexaacrylate “DPHA” (produced by NIPPON KAYAKU CO., LTD.), 33.0 parts by weight of the aforementioned perfluoroolefin copolymer (1), 36.7 parts by weight of “MEK-ST-L” {organosilica sol, produced by NISSAN CHEMICAL INDUSTRIES, LTD.; average particle diameter: 40 to 50 nm; solid concentration: 30% by weight}, 4.1 parts by weight of “RMS-033” (silicone-based compound produced by Gelest, Inc.) and 1.2 parts by weight of a photo-radical generator “Irgacure 907” (produced by Ciba Specialty Chemicals Inc.) were added to a mixture of 1,227.2 parts by weight of methyl ethyl ketone and 40 parts by weight of cyclohexanone. The mixture was then stirred. The mixture was then filtered through a polypropylene filter having a pore diameter of 0.4 μm to prepare a coating solution for low refractive index layer (LLL-4).

{Preparation of Coating Solution for Low Refractive Index Layer (LLL-5)}

8.3 parts by weight of a mixture of dipentaerythritol pentaacrylate and dipentaerythritol hexaacrylate “DPHA” (produced by NIPPON KAYAKU CO., LTD.), 33.0 parts by weight of the aforementioned perfluoroolefin copolymer (1), 55 parts by weight of a hollow silica dispersion {particle size: approx. 40 to 50 nm; shell thickness: 6 to 8 nm; refractive index: 1.31; solid concentration: 20%; main solvent: isopropyl alcohol; prepared according to Preparation Example 4 of JP-A-2002-79616 except that the particle size was varied}, 4.1 parts by weight of “RMS-033” (silicone-based compound produced by Gelest, Inc.) and 1.2 parts by weight of a photo-radical generator “Irgacure 907” (produced by Ciba Specialty Chemicals Inc.) were added to a mixture of 1,259.4 parts by weight of methyl ethyl ketone and 39 parts by weight of cyclohexanone. The mixture was then stirred. The mixture was then filtered through a polypropylene filter having a pore diameter of 0.4 μm to prepare a coating solution for low refractive index layer (LLL-5).

{Preparation of Coating Solution for Low Refractive Index Layer (LLL-6)}

8.3 parts by weight of a mixture of dipentaerythritol pentaacrylate and dipentaerythritol hexaacrylate “DPHA” (produced by NIPPON KAYAKU CO., LTD.), 33.0 parts by weight of the aforementioned perfluoroolefin copolymer (1), 36.7 parts by weight of “IPA-ST-L” {organosilica sol, produced by NISSAN CHEMICAL INDUSTRIES, LTD.; average particle diameter: 40 to 50 nm; solid concentration: 30% by weight}, 4.1 parts by weight of “RMS-033” (silicone-based compound produced by Gelest, Inc.) and 1.2 parts by weight of a photo-radical generator “Irgacure 907” (produced by Ciba Specialty Chemicals Inc.) were added to a mixture of 1,277.2 parts by weight of methyl ethyl ketone and 40 parts by weight of cyclohexanone. The mixture was then stirred. The mixture was then filtered through a polypropylene filter having a pore diameter of 0.4 μm to prepare a coating solution for low refractive index layer (LLL-6).

{Preparation of Coating Solution for Low Refractive Index Layer (LLL-7)}

45.0 parts by weight of Si(OC₂H₅)₄ and 6.6 parts by weight of CF₃(CF₃)₇(CH₂)₂Si(OCH₃) were added to 1,155 parts by weight of methyl ethyl ketone. The mixture was then stirred. To the mixture were then added 112.5 parts by weight of a hollow silica dispersion {particle size: approx. 40 to 50 nm; shell thickness: 6 to 8 nm; refractive index: 1.31; solid concentration: 20%; main solvent: isopropyl alcohol; prepared according to Preparation Example 4 of JP-A-2002-79616 except that the particle size was varied} and 180 parts by weight of a 0.1 mol/l hydrochloric acid. The mixture was then stirred. The mixture was then filtered through a polypropylene filter having a pore diameter of 0.4 μm to prepare a coating solution for low refractive index layer (LLL-7).

(Preparation of Low Refractive Layer Coating Solution (LLL-8))

To 783.3 parts by weight (47.0 parts by weight as calculated in terms of solid content) of Opstar JTA113 (heat-crosslinkable fluorine-containing silicone polymer composition solution (solid content: 6%): produced by JSR Co., Ltd.) were added 195 parts by weight of a hollow silica dispersion a, 30.0 parts by weight (9.0 parts by weight as calculated in terms of solid content) of a colloidal silica dispersion (silica; same as MEK-ST except for particle diameter; average particle diameter: 45 nm; solid content concentration: 30%; produced by NISSAN CHEMICAL INDUSTRIES, LTD.) and 17.2 parts by weight (5.0 parts by weight as calculated in terms of solid content) of a sol a. The mixture was then diluted with cyclohexane and methyl ethyl ketone such that the solid content concentration of the entire coating solution reached 6% by weight and the ratio of cyclohexane to methyl ethyl ketone reached 10:90 to prepare a coating solution (LLL-8).

(Preparation of Low Refractive Layer Coating Solution (LLL-9))

To 941.7 parts by weight (56.5 parts by weight as calculated in terms of solid content) of Opstar JTA113 (heat-crosslinkable fluorine-containing silicone polymer composition solution (solid content: 6%): produced by JSR Co., Ltd.) were added 100.0 parts by weight (30.0 parts by weight as calculated in terms of solid content) of a colloidal silica dispersion (silica; same as MEK-ST except for particle diameter; average particle diameter: 45 nm; solid content concentration: 30%; produced by NISSAN CHEMICAL INDUSTRIES, LTD.) and 46.6 parts by weight (13.5 parts by weight as calculated in terms of solid content) of a sol a. The mixture was then diluted with cyclohexane and methyl ethyl ketone such that the solid content concentration of the entire coating solution reached 6% by weight and the ratio of cyclohexane to methyl ethyl ketone reached 10:90 to prepare a coating solution (LLL-9).

(Preparation of Coating Solution For Overcoat Layer (OCLL))

A fluorine-containing polymer having the following structure was synthesized.

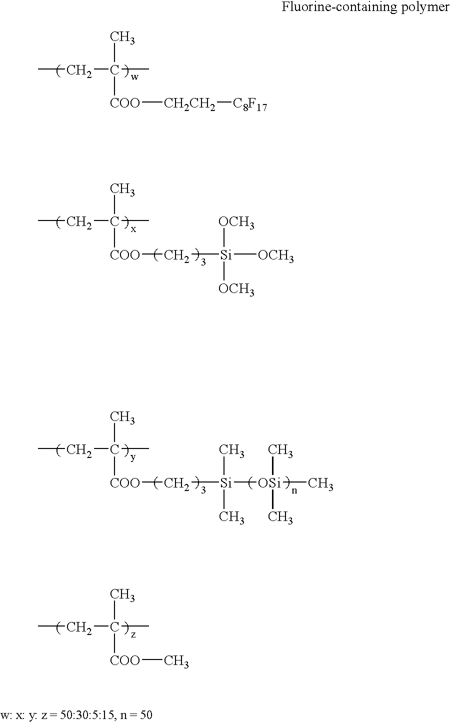

The fluoropolymer thus synthesized had a number-average molecular weight of 40,000 and a weight-average molecular weight of 70,000. The polymer was then dissolved in methyl isobutyl ketone to prepare a 0.1 wt-% solution of the polymer. To the solution was then added p-toluenesulfonic acid in an amount of 1% by weight of the polymer solid content to prepare a coating solution for overcoat layer.

### Example 1-1

(Preparation of Anti-Reflection Film (AF-1))

The coating solution for hard coat layer (HCLL) was spread over a triacetyl cellulose film having a thickness of 80 μm “TD80UF” (produced by Fuji Photo Film Co., Ltd.) using a gravure coater. The coat layer was dried at 100° C., and then irradiated with ultraviolet rays at an illuminance of 400 mW/cm² and a dose of 300 mJ/cm² using a 160 W/cm air-cooled metal halide lamp (produced by EYE GRAPHICS CO., LTD.) while the air in the system was being purged with nitrogen such that the oxygen concentration of the atmosphere reached 1.0 vol-% or less to form a hard coat layer (HCL) to a thickness of 8 μm.

The coating solution for middle refractive index layer (MLL-1), the coating solution for high refractive index layer (HLL-1) and the coating solution for low refractive index layer (LLL-1) were then successively spread over the hard coat layer (HCL) using a gravure coater having three coating stations.

In order to form the middle refractive index layer (ML-1), the coating solution for middle refractive index layer (MLL-1) thus spread was dried at 90° C. for 30 seconds, and then cured by irradiating with ultraviolet rays at an illuminance of 400 mW/cm² and a dose of 400 mJ/cm² using a 180 W/cm air-cooled metal halide lamp (produced by EYE GRAPHICS CO., LTD.) while the air in the system was being purged with nitrogen such that the oxygen concentration of the atmosphere reached 1.0 vol-% or less.

The drying speed was 0.55 g/m²·sec. The middle refractive index layer (ML-1) thus cured had a refractive index of 1.630 and a thickness of 67 nm:

In order to form the high refractive index layer (HL-1), the coating solution for high refractive index layer (HLL-1) thus spread was dried at 90° C. for 30 seconds, and then cured by irradiating with ultraviolet rays at an illuminance of 600 mW/cm² and a dose of 400 mJ/cm² using a 240 W/cm air-cooled metal halide lamp (produced by EYE GRAPHICS CO., LTD.) while the air in the system was being purged with nitrogen such that the oxygen concentration of the atmosphere reached 1.0 vol-% or less.

The drying speed was 0.67 g/m² sec. The high refractive index layer (HL-1) thus cured had a refractive index of 1.905 and a thickness of 107 nm.

In order to form the low refractive index layer (LL-1), the coating solution for low refractive index layer (LLL-1) thus spread was dried at 90° C. for 30 seconds, and then cured by irradiating with ultraviolet rays at an illuminance of 600 mW/cm² and a dose of 600 mJ/cm² using a 240 W/cm air-cooled metal halide lamp (produced by EYE GRAPHICS CO., LTD.) while the air in the system was being purged with nitrogen such that the oxygen concentration of the atmosphere reached 0.1 vol-% or less. The drying speed was 0.35 g/m²·scc. The low refractive index layer (LL-1) thus cured had a refractive index of 1.445 and a thickness of 85 nm. In this manner, an anti-reflection film (AF-1) was prepared.

### Examples 1-2 to 1-4

(Preparation of Anti-Reflection Films (AF-2) to (AF-4))

Anti-reflection films (AF-2) to (AF-4) were prepared in the same manner as in Example 1-1 except that the low refractive index layers (LL-2) to (LL-4) were formed by the coating solutions for low refractive index layer (LLL-2) to (LLL-4), respectively, instead of the coating solution for low refractive index layer (LLL-1). The drying speed of the low refractive index layers (LL-2) to (LL-4) were 0.31 g/m², 0.30 g/m² and 0.36 g/m², respectively. The low refractive index layers (LL-2) to (LL-4) thus cured had a refractive index of 1.445, 1.440 and 1.450, respectively, and each had a thickness of 85 nm.

### Example 1-5

(Preparation of Anti-Reflection Film (AF-5))

An anti-reflection film (AF-5) was prepared in the same manner as in Example 1-1 except that SiO₂ was deposited by a dual magnetron sputtering method using a running sputtering apparatus to form a low refractive index layer (MTL) composed of a thin metal oxide layer instead of spreading the coating solution for low refractive index layer (LLL-1) to form the low refractive index layer (LL-1). During this procedure, the oxygen concentration was controlled by a plasma emission monitoring method. The degree of vacuum was 0.27 Pa. The low refractive index layer thus obtained had a refractive index of 1.460 and a thickness of 85 nm.

### Example 1-6

(Preparation of Anti-Reflection Film (AF-6))

An anti-reflection film (AF-6) was prepared in the same manner as in Example 1-3 except that the coating solution for middle refractive index layer (MLL-1), the coating solution for high refractive index layer (HLL-1) and the coating solution for low refractive index layer (LLL-3) were successively spread using a gravure coater to form the middle refractive index layer (ML-1) and the high refractive index layer (HL-1) and the coating solution for low refractive index layer (LL-3) was then spread using a die coater to form a low refractive index layer (LL-3₂) instead of successively spreading the coating solution for middle refractive index layer (MLL-1), the coating solution for high refractive index layer (HLL-1) and the coating solution for low refractive index layer (LLL-3) using a gravure coater to form the middle refractive index layer (ML-1), the high refractive index layer (HL-1) and the low refractive index layer (LL-3). The drying speed was 0.30 g/m²·sec. The low refractive index layer thus cured had a refractive index of 1.440 and a thickness of 85 nm.

### Comparative Examples 1-1 and 1-2

(Preparation of Anti-Reflection Films (AF-7) and (AF-8))

Anti-reflection films (AF-7) and (AF-8) were prepared in the same manner as in Example 1-1 except that the low refractive index layers (LL-5) and (LL-6) were formed by the coating solution for low refractive index layer (LLL-5) and the coating solution for low refractive index layer (LLL-6), respectively, instead of the coating solution for low refractive index layer (LLL-1). The drying speed of the low refractive index layers (LLL-5) and (LLL-6) were 0.42 g/m²·sec and 0.45 g/m² sec, respectively. The low refractive index layers (LLL-5) and (LLL-6) thus cured had a refractive index of 1.435 and 1.450, respectively, and each had a thickness of 85 nm.

### Example 1-7

(Preparation of Anti-Reflection Film (AF-9))

An anti-reflection film (AF-9) was prepared in the same manner as in Example 1-1 except that the coating solution for low refractive index layer (LLL-7) was spread, and then dried at 120° C. for 1 minute to form the low refractive index layer (LL-7) instead of using the coating solution for low refractive index layer (LLL-1). The drying speed of the low refractive index layer (LL-7) was 0.49 g/m²·sec. The low refractive index layer thus cured had a refractive index of 1.390 and a thickness of 85 nm.

### Example 1-8

(Preparation of Anti-Reflection Film (AF-10))

An anti-reflection film (AF-10) was prepared in the same manner as in Example 1-7 except that the coating solution for overcoat layer (OCLL) was spread over the low refractive index layer (LL-7) prepared in Example 1-7, and then dried at 120° C. for 30 minutes to form an overcoat layer (OCL) to a thickness of 10 nm.

### Example 1-9

(Preparation of Anti-Reflection Film (AF-11))

An anti-reflection film (AF-11) was prepared in the same manner as in Example 1-3 except that the high refractive index layer (HL-1) was not provided, the spread of the coating solution for middle refractive index layer (MLL-1) was varied to form the middle refractive index layer (ML-1₂) and the coating solution for low refractive index layer (LLL-3) was directly spread over the middle refractive index layer (ML-1₂) in a different amount to form the low refractive index layer (LL-3₃). The middle refractive index layer thus cured had a refractive index of 1.630 and a thickness of 100 nm. The low refractive index layer thus cured had a refractive index of 1.440 and a thickness of 100 nm. In the constitution of the anti-reflection film (AF-11), the middle refractive index layer (ML-1₂) is a high refractive index layer in a sense that it has a higher refractive index than the transparent support but is referred to as “middle refractive index layer” in the examples for convenience.

### Example 1-10

(Preparation of Anti-Reflection Film (AF-12))

An anti-reflection film (AF-12) was prepared in the same manner as in Example 1-3 except that the middle refractive index layer (ML-1) and the high refractive index layer (HL-1) were not provided and the coating solution for low refractive index layer (LLL-3) was directly spread over the hard coat layer (HCL) in a different amount to form the low refractive index layer (LL-3₄. The low refractive index layer thus cured had a refractive index of 1.440 and a thickness of 95 nm.

### Example 1-11

(Preparation of Anti-Reflection Film (AF-15))

The coating solution for hard coat layer (HCLL-2) was spread over a triacetyl cellulose film having a thickness of 80 μm (“TD80UF” (produced by Fuji Photo Film Co., Ltd.)) using a gravure coater. The coat layer was dried at 100° C., and then irradiated with ultraviolet rays at an illuminance of 400 mW/cm² and a dose of 100 mJ/cm² using a 160 W/cm air-cooled metal halide lamp (produced by EYE GRAPHICS CO., LTD.) while the air in the system was being purged with nitrogen such that the oxygen concentration of the atmosphere reached 1.0 vol-% or less to form a hard coat layer (HCL-2) to a thickness of 8 μm.

In order to form the low refractive layer (LL-8), the coating solution for low refractive layer (LLL-8) thus spread was dried at 90° C. for 30 seconds, heat-cured at 110° C. for 10 minutes, and then cured by irradiating with ultraviolet rays at an illuminance of 400 mW/cm² and a dose of 300 mJ/cm² using a 240 W/cm air-cooled metal halide lamp (produced by EYE GRAPHICS CO., LTD.) while the air in the system was being purged with nitrogen such that the oxygen concentration of the atmosphere reached 0.1 vol-% or less. The drying speed was 0.33 g/m² sec. The low refractive layer (LL-8) thus cured had a refractive index of 1.422 and a thickness of 89 nm. In this manner, an anti-reflection film (AF-15) was prepared.

### Example 1-12

(Preparation of Anti-Reflection Film (AF-16))

An anti-reflection film (AF-16) was prepared in the same manner as in Example 1-11 except that the hard coat layer coating solution (HCLL-3) and the low refractive layer coating solution (LLL-9) were used instead of the hard coat layer coating solution (HCLL-2) and the low refractive layer coating solution (LLL-8) to prepare a hard coat layer (HCL-3) and a low refractive layer (LL-9), respectively. The drying speed of the hard coat layer (HCL-3) and the low refractive layer (LL-9) were each 0.34 g/m²·sec. The low refractive layer thus cured had a refractive index of 1.445 and a thickness of 88 nm.

### Comparative Example 1-3

(Preparation of Anti-Reflection Film (AF-13))

An anti-reflection film (AF-13) was prepared in the same manner as in Example 1-3 except that the coating solution for low refractive index layer (LLL-3) was spread, and then dried at a rate of 0.06 g/m²·sec to form the low refractive index layer (LL-3₅). The low refractive index layer thus cured had a refractive index of 1.450 and a thickness of 86 nm.

### Comparative Example 1-4

(Preparation of Anti-Reflection Film (AF-14))

An anti-reflection film (AF-14) was prepared in the same manner as in Example 1-2 except that the coating solution for middle refractive index layer (MLL-2) and the coating solution for high refractive index layer (HLL-2) were used to form the middle refractive index layer (ML-2) and the high refractive index layer (HL-2), respectively, instead of using the coating solution for middle refractive index layer (MLL-1) and the coating solution for high refractive index layer (HLL-1). The middle refractive index layer and high refractive index layer thus cured had a refractive index of 1.630 and 1.905, respectively, and a thickness of 67 nm and 107 nm, respectively.

The constitution of the anti-reflection films thus obtained are set forth in Table 1 below.

TABLE 1

| | anti- | Transparent | Anti-reflection layer | | | | | | | | | |
|---|---|---|---|---|---|---|---|---|---|---|---|---|
| | reflection | substrate | Hard coat layer | | Middle refractive index layer | | | | High refractive index layer | | | |
| | film | film *1 | | Thickness | | Drying | Refractive | Thickness | | Drying | Refractive | Thickness |
| | No. | No. | No. | (μm) | No. | speed *2 | index | (nm) | No. | speed *2 | index | (nm) |
| Example | AF-1 | TD80UF | HCL | 8 | ML-1 | 0.55 | 1.630 | 67 | HL-1 | 0.67 | 1.905 | 107 |
| 1-1 | | | | | | | | | | | | |
| Example | AF-2 | ″ | ″ | ″ | ″ | ″ | ″ | ″ | ″ | ″ | ″ | ″ |
| 1-2 | | | | | | | | | | | | |
| Example | AF-3 | ″ | ″ | ″ | ″ | ″ | ″ | ″ | ″ | ″ | ″ | ″ |
| 1-3 | | | | | | | | | | | | |
| Example | AF-4 | ″ | ″ | ″ | ″ | ″ | ″ | ″ | ″ | ″ | ″ | ″ |
| 1-4 | | | | | | | | | | | | |
| Example | AF-5 | ″ | ″ | ″ | ″ | ″ | ″ | ″ | ″ | ″ | ″ | ″ |
| 1-5 | | | | | | | | | | | | |
| Example | AF-6 | ″ | ″ | ″ | ″ | ″ | ″ | ″ | ″ | ″ | ″ | ″ |
| 1-6 | | | | | | | | | | | | |
| Comp. | AF-7 | ″ | ″ | ″ | ″ | ″ | ″ | ″ | ″ | ″ | ″ | ″ |
| Ex. 1-1 | | | | | | | | | | | | |
| Comp. | AF-8 | ″ | ″ | ″ | ″ | ″ | ″ | ″ | ″ | ″ | ″ | ″ |
| Ex. 1-2 | | | | | | | | | | | | |
| Example | AF-9 | ″ | ″ | ″ | ″ | ″ | ″ | ″ | ″ | ″ | ″ | ″ |
| 1-7 | | | | | | | | | | | | |
| Example | AF-10 | ″ | ″ | ″ | ″ | ″ | ″ | ″ | ″ | ″ | ″ | ″ |
| 1-8 | | | | | | | | | | | | |
| Example | AF-11 | ″ | ″ | ″ | ML-1₂ | ″ | ″ | 100 | — | — | — | — |
| 1-9 | | | | | | | | | | | | |
| Example | AF-12 | ″ | ″ | ″ | — | — | — | — | — | — | — | — |
| 1-10 | | | | | | | | | | | | |
| Comp. | AF-13 | ″ | ″ | ″ | ML-1 | 0.55 | 1.630 | 67 | HL-1 | 0.67 | 1.905 | 107 |
| Ex. 1-3 | | | | | | | | | | | | |
| Comp. | AF-14 | ″ | ″ | ″ | ML-2 | ″ | 1.63 | 67 | HL-2 | ″ | 1.905 | 107 |
| Ex. 1-4 | | | | | | | | | | | | |
| Example | AF-15 | ″ | HCL-2 | ″ | — | — | — | — | — | — | — | — |
| 1-11 | | | | | | | | | | | | |
| Example | AF-16 | ″ | HCL-3 | ″ | — | — | — | — | — | — | — | — |
| 1-12 | | | | | | | | | | | | |

| | Anti-reflection layer | | | | | | | |
|---|---|---|---|---|---|---|---|---|
| | Low refractive index layer | | | | | Overcoat layer | | |
| | | Drying | Drying | Refractive | Thickness | | Drying | Thickness |
| | No. | temp. *3 | speed *2 | index | (nm) | No. | temp. *3 | (nm) |
| Example | LL-1 | 90 | 0.35 | 1.445 | 85 | — | — | — |
| 1-1 | | | | | | | | |
| Example | LL-2 | ″ | 0.31 | 1.445 | 85 | — | — | — |
| 1-2 | | | | | | | | |
| Example | LL-3 | ″ | 0.30 | 1.440 | 85 | — | — | — |
| 1-3 | | | | | | | | |
| Example | LL-4 | ″ | 0.36 | 1.450 | 85 | — | — | — |
| 1-4 | | | | | | | | |
| Example | MTL | — | — | 1.460 | 85 | — | — | — |
| 1-5 | | | | | | | | |
| Example | LL-3₂ | 90 | 0.30 | 1.440 | 85 | — | — | — |
| 1-6 | | | | | | | | |
| Comp. | LL-5 | ″ | 0.42 | 1.435 | 85 | — | — | — |
| Ex. 1-1 | | | | | | | | |
| Comp. | LL-6 | ″ | 0.45 | 1.450 | 85 | — | — | — |
| Ex. 1-2 | | | | | | | | |
| Example | LL-7 | 120 | 0.49 | 1.390 | 85 | — | — | — |
| 1-7 | | | | | | | | |
| Example | ″ | ″ | ″ | ″ | ″ | OCL | 120 | 10 |
| 1-8 | | | | | | | | |
| Example | LL-3₃ | 90 | 0.30 | 1.440 | 100 | — | — | — |
| 1-9 | | | | | | | | |
| Example | LL-3₄ | ″ | ″ | ″ | 95 | — | — | — |
| 1-10 | | | | | | | | |
| Comp. | LL-3₅ | ″ | 0.06 | 1.450 | 86 | — | — | — |
| Ex. 1-3 | | | | | | | | |
| Comp. | LL-2 | ″ | 0.31 | 1.445 | 85 | — | — | — |
| Ex. 1-4 | | | | | | | | |
| Example | LL-8 | ″ | 0.33 | 1.422 | 89 | — | — | — |
| 1-11 | | | | | | | | |
| Example | LL-9 | ″ | 0.34 | 1.425 | 88 | — | — | — |
| 1-12 | | | | | | | | |

Transparent substrate film *1: “TD80UF”, produced by Fuji Photo Film Co., Ltd.
Drying speed *2: (g/m² · sec);
Drying temperature *3: (° C.)

(Evaluation of Anti-Reflection Film (AF))

The film samples obtained after the aforementioned saponification were then evaluated for the following properties.

(1) Specular Reflectance and Color

Using a Type V-550 spectrophotometer (produced by JASCO) equipped with an adapter “ARV-474”, the film samples were each measured for specular reflectance at an incident angle of 5° and an emission angle of −5° in the wavelength range of from 380 nm to 780 nm. The measurements of specular reflectance were then averaged over the range of from 450 nm to 650 nm to evaluate the anti-reflection properties. From the reflection spectrum measured were then calculated L*, a* and b* values of CIE1976L*a*b* color space, which indicate the color of specularly reflected light with respect to light from a CIE standard light source D₆₅ incident at an angle of 5°. Among these values, a* value and b* value were used to evaluate the color of reflected light.

(2) White Color

The white color of the various anti-reflection film samples were evaluated in the following manner.

The polarizing film was stuck to the both sides of a glass plate having a size of 10 cm square to make cross-nicol arrangement. The various anti-reflection film samples were each then stuck to the glass plate with the anti-reflection layer side thereof facing upward. These samples were each then visually observed for white color under a fluorescent lamp (8,000 cd/m²) free of louver disposed at a distance of 2 m. The measurements were then ranked as follows.

1: No white color observed, clear;

2: Little or no offensive white color observed, almost clear;

3: Some white color observed;

4: Much white color observed

(3) Amount of Scattering Light

Using a Type GP-5 goniophotometer (produced by MURAKAMI COLOR RESEARCH LABORATORY), the various anti-reflection film samples were each measured for I₅₀ as amount of scattering light. For the measurement of I₅₀, light are incident on the surface of the anti-reflection film in the direction of −10° from the line normal to the surface of the sample. The amount of scattering light from the surface of the anti-reflection film sample in the direction of +50° among all the light reflected by the surface of the anti-reflection film sample was then read out.

(4) Arithmetic Average Roughness (Ra), Ten Point-Average Roughness (Rz), Average Inclination angle

For the measurement of arithmetic average roughness (Ra), ten point-average roughness (Rz) and average inclination angle of the various anti-reflection film samples, a Type SPI3800 scanning probe microscope (produced by Seiko Instruments Inc.) was used.

(5) Reflection

An image display comprising each of the various anti-reflection film samples was allowed to perform black display. A white shirt disposed at a distance of 1.5 m from the image display was reflected on the screen.

The results of image reflection were then evaluated according to the following criterion.

G: White shirt can be slightly seen but is no offensive;

F: Slightly offensive;

P: Very offensive

(6) Observation of Surface Conditions

Using a Type S-570 scanning electron microscope (produced by Hitachi, Ltd.), the various anti-reflection film samples were each observed at an acceleration voltage of 10 kV and 10,000 magnification for agglomeration of particles in the low refractive index layer comprising a inorganic particulate material incorporated therein. The agglomeration of particles was visually observed. The diameter of a bulk of agglomerated particles as a circle was then measured. The measurements were then evaluated according to the following criterion. Examples 1-1 and 1-5 had no inorganic particulate material incorporated therein and thus showed no agglomeration of particles. Therefore, the sign “−” is put in the column of observation of surface conditions for the two examples.

E: Little or no agglomeration observed, uniformly dispersed;

G: Slight agglomeration observed, but uniformly dispersed;

F: Some agglomeration observed, not too uniformly dispersed;

P: Much agglomeration observed, unevenly dispersed

(7) Evaluation of Resistance to Steel Wool Scratch

Using a rubbing tester, the various anti-reflection film samples were each subjected to rubbing test under the following conditions.

Evaluation environmental conditions: 25° C., 60% RH

Rubbing material: A steel wool “Gerade No. 0000” (produced by Japan Steel Wool Co., Ltd.) was wound on the rubbing tip (1 cm×1 cm) of the tester which comes in contact with the sample. The steel wool was fixed to the tip with a band.

Moving distance (one way): 13 cm; rubbing speed: 13 cm/sec; load: 500 g/cm²; contact area of tip: 1 cm×1 cm; number of times of rubbing: 10 reciprocating movements

The sample thus rubbed was then coated with an oil-based black ink on the back side thereof. The rubbed surface of the sample was then visually observed by reflected light. The measurements were then evaluated according to the following criterion.

E: No scratches seen even when observed very carefully;

G: Slight scratches seen when observed very carefully;

GF: Slight scratches seen;

F: Middle level of scratches seen;

FP-P: Scratches seen at a glance

(8) Evaluation of Adhesion

The various anti-reflection film samples were each notched with a cutter knife on the low refractive index layer side thereof to make a checkerboard pattern comprising 11 horizontal lines and 11 vertical lines, i.e., 100 squares in total. A polyester adhesive tape “No. 31B” produced by NITTO DENKO CORPORATION was pressure-bonded to the notched surface of the sample, and then peeled off the notched surface. This adhesion test was effected three times repeatedly on the same area. The area thus examined was then visually observed to see whether or not the squares are peeled. The results were then evaluated according to the following 4-step criterion.

E: None of 100 squares observed peeled;

G: Two or less of 100 squares observed peeled;

F: From 3 to 10 of 100 squares observed peeled;

P: More than 10 of 100 squares observed peeled

(9) Evaluation of Stainproofness

An oil-based pen ink “Mackiecare” (ZEBRA CO., LTD.) was attached to the various anti-reflection film samples on the low refractive index layer side thereof. The ink was then wiped out with a nonwoven cellulose fabric “Bencot M-3” (produced by Asahi Kasei Corporation). The removability of the ink was then evaluated according to the following 2-step criterion.

G: Oil-based pen ink fully removed;

P: Mark of wiping of oil-based pen ink left unremoved

(10) Evaluation of Dustproofness

The various anti-reflection film samples were each used with its transparent support side attached to the surface of CRT in a room having dusts and tissue paper dusts having a size of 0.5 μm or more in an amount of 1,000,000 to 2,000,000 pieces per 1 ft³ (feet cube) for 24 hours. The number of dusts and tissue paper dusts attached to the anti-reflection layer per 100 cm² was then measured. Those showing less than 20 pieces of dusts on the average were ranked A. Those showing from 20 to 49 pieces of dusts on the average were ranked B. Those showing from 50 to 199 pieces of dusts on the average were ranked C. Those showing more than 200 pieces of dusts on the average were ranked D.

(11) Test on Chemical Resistance

The various anti-reflection film samples were each sprayed with a detergent “Magic Rin” (produced by Kao Corporation) on the low refractive index layer side thereof covered by a mask having holes having a diameter of 7 mmφ from a nozzle disposed at a distance of 30 cm. The sample was then allowed to stand for 5 minutes. The solution and marks left on the surface of the sample were then wiped out. The surface thus examined was then observed for abnormality. The results were then evaluated according to the following 3-step criterion.

G: No abnormalities observed on the surface of the sample after test;

F: Some abnormalities observed after test;

P: Definite abnormalities observed after test

(12) Test on Light-Resistance

Using a Type SX-75 sunshine weatherometer (produced by Suga Test Instruments Co., Ltd.), the various anti-reflection film samples were each subjected to light-resistance test under a sunshine carbon arc lamp at an illuminance of 150 W/m² and a humidity of 50% RH for 200 hours.

The samples thus examined were each then subjected to adhesion test in the same manner as in the test (8).

TABLE 2

| | Average | | | | | | | | | | | | | Chem- |
|---|---|---|---|---|---|---|---|---|---|---|---|---|---|---|
| | reflect- | | | | | | Average | | | | | | | ical |
| | ance | Color | White | −Log | Ra | Rz/ | inclination | Reflec- | Surface | Scratch | Adhe- | Stain- | Dist- | resist- |
| | (%) | a*/b* | color | (I₅₀/I) | (nm) | Ra | angle (°) | tion | conditions | resistance | sion | proofness | proofness | ance |
| Example | 0.37 | 1.9/−5.0 | 1 | 6.9 | 2.5 | 4.7 | 0.9 | G | — | G | E | G | B | G |
| 1-1 | | | | | | | | | | | | | | |
| Example | 0.37 | 1.9/−5.0 | 1 | 6.9 | 3.7 | 4.2 | 1.2 | G | E | E | E | G | A | G |
| 1-2 | | | | | | | | | | | | | | |
| Example | 0.34 | 2.3/−4.5 | 2 | 6.8 | 4.5 | 3.5 | 1.8 | G | E | E | E | G | A | G |
| 1-3 | | | | | | | | | | | | | | |
| Example | 0.40 | 1.5/−5.4 | 2 | 6.8 | 4.2 | 3.3 | 1.8 | G | G | E | E | G | A | G |
| 1-4 | | | | | | | | | | | | | | |
| Example | 0.41 | 1.5/−5.4 | 1 | 6.9 | 1.8 | 4.6 | 0.8 | G | — | G | E | P | B | G |
| 1-5 | | | | | | | | | | | | | | |
| Example | 0.34 | 2.2/−4.6 | 2 | 6.8 | 4.2 | 3.4 | 1.7 | G | E | E | E | G | A | G |
| 1-6 | | | | | | | | | | | | | | |
| Comp. | 0.33 | 2.5/−4.0 | 4 | 6.2 | 17.2 | 4.0 | 4.2 | G | P | GF | E | G | C | F |
| Ex. 1-1 | | | | | | | | | | | | | | |
| Comp. | 0.37 | 1.5/−5.4 | 4 | 6.3 | 15.5 | 4.7 | 4.5 | G | P | GF | E | G | C | F |
| Ex. 1-2 | | | | | | | | | | | | | | |
| Example | 0.31 | 4.9/−0.5 | 2 | 6.8 | 6.5 | 4.9 | 2.7 | G | G | F | E | G | D | P |
| 1-7 | | | | | | | | | | | | | | |
| Example | 0.33 | 2.4/−7.5 | 2 | 6.8 | 6.0 | 4.6 | 2.6 | G | G | GF | E | G | B | G |
| 1-8 | | | | | | | | | | | | | | |
| Example | 1.40 | 5.3/−17.5 | 2 | 6.9 | 4.3 | 3.6 | 1.9 | F | E | G | E | G | A | G |
| 1-9 | | | | | | | | | | | | | | |
| Example | 2.43 | 1.0/−1.5 | 2 | 7.0 | 4.7 | 3.8 | 1.9 | P | E | G | E | G | A | G |
| 1-10 | | | | | | | | | | | | | | |
| Comp. | 0.39 | 1.4/−5.5 | 3 | 6.4 | 9.8 | 4.6 | 3.6 | G | P | G | E | G | A | G |
| Ex. 1-3 | | | | | | | | | | | | | | |
| Comp. | 0.38 | 1.8/−4.9 | 3 | 6.5 | 5.5 | 5.3 | 2.1 | G | E | E | E | G | B | G |
| Ex. 1-4 | | | | | | | | | | | | | | |
| Example | 2.2 | 1.1/−0.2 | 1 | 6.9 | 3.3 | 3.7 | 1.8 | F | G | E | E | G | A | G |
| 1-11 | | | | | | | | | | | | | | |
| Example | 1.6 | 2.3/−0.2 | 2 | 6.6 | 5.3 | 4.8 | 2.9 | F | G | E | E | G | A | G |
| 1-12 | | | | | | | | | | | | | | |

As can be seen in Table 2 above, the anti-reflection films of Examples 1-1 to 1-12 exhibited high anti-reflection properties and an average reflectance and an amount of light scattered falling within the range defined herein. These anti-reflection films exhibited an excellent white color. These anti-reflection films exhibited a neutral color of reflected light.

On the contrary, the anti-reflection films of Comparative Examples 1-1 and 1-2 and the anti-reflection film of Comparative Example 1-3, the drying speed of which falling outside the desired range, showed agglomeration of inorganic particulate material in the low refractive index layer and an amount of light scattered falling outside the range defined herein. These comparative anti-reflection films also exhibited a deteriorated color. It is thought that Comparative Examples 1-1 and 1-2 underwent progress of agglomeration of particles due to the coexistence of the hydrophobic perfluoroolefin copolymer (1) and the hydrophilic silica. It is thought that Comparative Example 1-3 underwent progress of agglomeration of particles because the drying speed was so low that it takes much time to raise viscosity until the silica particles become no longer fluidic. Comparative Example 1-4 had coarse particles of titanium dioxide present in the high refractive index layer and the middle refractive index layer and thus exhibited an amount of light scattered falling outside the range defined herein. Thus, the anti-reflection film of Comparative Example 1-4 showed remarkable white color.

The anti-reflection film of Example 1-1, which had no inorganic particulate material present in the low refractive index layer, showed a slightly deteriorated dustproofness. The anti-reflection film of Example 1-5, which comprised a thin metal oxide layer as a low refractive index layer, showed a deteriorated stainproofness. The anti-reflection film of Example 1-7, which comprised a low refractive index layer free of functional fluorine-containing polymer, showed a slightly deteriorated dustproofness and chemical resistance. The anti-reflection film of Example 1-9, which comprised a high refractive index layer having a reduced refractive index (middle refractive index layer (ML-12), and the anti-reflection film of Example 1-10, which was free of high refractive index layer, showed a slightly deteriorated reflection resistance.

All the anti-reflection films of Examples 1-1 to 1-7 exhibited a high light-resistance.

### Example 2

(Evaluation of Image Display)

An image display comprising each of the anti-reflection films prepared in Examples 1-1 to 1-12 exhibited excellent anti-reflection properties and hence an extremely excellent viewability free from white color and other defectives.

### Example 3

(Preparation of Protective Film for Polarizing Plate)

The anti-reflection films prepared in Examples 1-1 to 1-12 were each coated with a 40° C. saponifying solution made of an alkaline solution comprising 57 parts by weight of potassium hydroxide, 120 parts by weight of propylene glycol, 535 parts by weight of isopropyl alcohol and 288 parts by weight of water on the surface of the transparent support on the side thereof opposite the anti-reflection layer of the invention. Thus, the surface of the transparent support was saponified.

The saponified surface of the transparent support was thoroughly washed with water to remove the residual alkaline solution, and then thoroughly dried at 100° C. Thus, a protective film for polarizing plate was prepared.

(Preparation of Polarizing Plate)

(Preparation of Polarizing Layer)

A polyvinyl alcohol film having a thickness of 75 μm (produced by KURARAY CO., LTD.) was dipped in an aqueous solution comprising 1,000 g of water, 7 g of iodine and 10.5 g of potassium iodide for 5 minutes so that it had iodine adsorbed thereto. Subsequently, the film was monoaxially stretched longitudinally by a factor of 4.4 in a 4 wt-% aqueous solution of boric acid, and then dried kept tensed to prepare a polarizing layer.

Subsequently, the aforementioned various anti-reflection films (protective film for polarizing plate) were each stuck to one side of the polarizing layer with a polyvinyl alcohol-based adhesive as an adhesive in such an arrangement that the saponified surface of triacetyl cellulose came in contact with the polarizing layer. A cellulose acylate film “TD-80UF” which had been saponified in the same manner as mentioned above (produced by Fuji Photo Film Co., Ltd.) was stuck to the other side of the polarizing layer with the same polyvinyl alcohol-based adhesive as used above.

(Evaluation of Image Display)

The polarizing plates of the invention thus prepared were each mounted on transmission, reflective or semi-transmission type liquid crystal display of TN, STN, IPS, VA and OCB modes. These image displays were each evaluated. As a result, these image displays exhibited excellent anti-reflection properties and an extremely excellent viewability.

### Example 4

(Preparation of Polarizing Plate)

An optical compensation film “Wide View Film A 12B” (produced by Fuji Photo Film Co., Ltd.) was saponified on the side thereof opposite the optical compensation layer in the same manner as in Example 3.

Subsequently, the various anti-reflection films (protective film for polarizing plate) prepared in Example 3 were each stuck to one side of the polarizing layer prepared in Example 3 with a polyvinyl alcohol-based adhesive as an adhesive in such an arrangement that the saponified surface of triacetyl cellulose came in contact with the polarizing layer. A saponified optical compensation film was stuck to the other side of the polarizing layer with the same polyvinyl alcohol-based adhesive as used above in such an arrangement that the triacetyl cellulose side thereof came in contact with the polarizing layer.

(Evaluation of Image Display)

The polarizing plates of the invention thus prepared were each mounted on transmission, reflective or semi-transmission type liquid crystal display of TN, STN, IPS, VA and OCB modes. These image displays were each evaluated. As a result, these image displays exhibited a higher contrast in the daylight than liquid crystal displays comprising the aforementioned polarizing plate free of optical compensation film mounted thereon, very wide horizontal and vertical viewing angles, excellent anti-reflection properties and extremely excellent viewability and display quality.

As described in detail herein, the formation of an anti-reflection layer according to the invention on a transparent support such as cellulose acylate film makes it possible to provide an anti-reflection film free of white color and excellent in clearness at reduced cost in a large amount.

Further, a polarizing plate and an image display having the aforementioned excellent characteristics can be provided.

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application No. JP2004-248501 filed on Aug. 27 of 2004, the contents of which is incorporated herein by reference.

### INDUSTRIAL APPLICABILITY

An anti-reflection film according to the invention can be applied to a polarizing plate and an image display such as liquid crystal display (LCD) and organic EL display.

1. An anti-reflection film comprising:
a transparent support; and
an anti-reflection layer comprising at least one thin layer having a refractive index different from that of the transparent support,
wherein
the anti-reflection film has an average value of specular reflectance of 3% or less, and
scattering light from a surface of the anti-reflection film, with respect to incident light in an incident direction of −10° from a line normal to a surface of the transparent support, satisfy a relationship (1):
−Log(I₅₀/I)≧6.6
wherein I represents a total amount of the scattering light, and I₅₀ represents an amount of light scattered in a direction of +50° from the line normal to the surface of the transparent support.

2. The anti-reflection film as defined in claim 1, which has an outermost surface having: an arithmetic average roughness Ra of from 0.1 to 15 nm; a ratio of a ten point-average roughness Rz to the arithmetic average roughness of 15 or less, and an average inclination angle of an unevenness profile of 30 or less.

3. The anti-reflection film as defined in claim 1, wherein the at least one thin layer comprises a low refractive index layer having a lower refractive index than that of the transparent support.

4. The anti-reflection film as defined in claim 3, wherein the low refractive index layer is a cured film formed by coating a low refractive index layer-forming composition comprising at least one selected from the group consisting of thermosetting composition and a radiation-curable composition.

5. The anti-reflection film as defined in claim 1, wherein the average value of specular reflectance is 1% or less.

6. The anti-reflection film as defined in claim 3, wherein the low refractive index layer has a refractive index of from 1.20 to 1.49.

7. The anti-reflection film as defined in claim 3, wherein a difference in refractive index between the low refractive index layer and a layer adjacent to the low refractive index layer is from 0.16 to 1.3.

8. The anti-reflection film as defined in claim 3, wherein the at least one thin layer further comprises at least one high refractive index layer having a higher refractive index than that of the transparent support, and the at least one high refractive index layer is between the transparent support and the low refractive index layer.

9. The anti-reflection film as defined in claim 3, wherein
the at least one thin layer has a three-layer structure comprising: the low refractive index layer; a high refractive index layer having a higher refractive index than that of the transparent support; and a middle refractive index layer having an intermediate refractive index between refractive indexes of the transparent support and the high refractive index layer,
the anti-reflection film has such an arrangement that the transparent support, the middle refractive index layer, the high refractive index layer, and the low refractive index layer are stacked in this order, and
the middle refractive index layer, the high refractive index layer and the low refractive index layer satisfy relationships (2), (3) and (4), respectively, with respect to a designed wavelength λ of 400 to 680 nm:
(λ/4)×0.80<n₁d₁<(λ/4)×1.00 (2)
(λ/2)×0.75<n₂d₂<(λ/2)×0.95 (3)
(λ/4)×0.95<n₃d₃<(λ/4)×1.05 (4)
wherein n₁ represents a refractive index of the middle refractive index layer; d₁ represents the thickness in nm of the middle refractive index layer; n₂ represents a refractive index of the high refractive index layer; d₂ represents a thickness in nm of the high refractive index layer; n₃ represents a refractive index of the low refractive index layer; and n₃ represents a thickness in nm of the low refractive index layer.

10. The anti-reflection film as defined in claim 1, wherein specularly reflected light having a wavelength of from 380 nm to 780 nm, with respect to incident light having an incident angle of 5° from a CIE standard light source D65, has a* and b* values falling within a range of from −8 to 8 and from −10 to 10, respectively, in CIE1976L*a*b* color space.

11. The anti-reflection film as defined in claim 3, wherein the low refractive index layer comprises a particulate inorganic material having an average particle diameter of from 5 to 100 nm in an amount of from 5 to 80% by weight.

12. The anti-reflection film as defined in claim 11, wherein the particulate inorganic material is a material subjected to a treatment for improvement of dispersibility with at least one of a hydrolyzate and partial condensate of an organosilane represented by formula (1):
(R¹¹)_{α}—Si(Y¹¹)₄-α
wherein R¹¹ represents a substituted or unsubstituted alkyl or aryl group: Y¹¹ represents a hydroxyl group or hydrolyzable group; and α represents an integer of from 1 to 3.

13. The anti-reflection film as defined in claim 12, wherein the treatment for improvement of dispersibility is performed in the presence of at least any of an acid catalyst and at least one metal chelate compound comprising: at least one selected from the group consisting of alcohol represented by formula R⁰¹ OH and a compound represented by formula R⁰²COCH₂COR⁰³ as a ligand; and a metal selected from the group consisting of Zr, Ti and Al as a central metal, wherein R⁰¹ represents a C₁-C₁₀ alkyl group, R⁰² represents a C₁-C₁₀ alkyl group; and R⁰³ represents a C₁-C₁₀ alkyl or alkoxy group.

14. The anti-reflection film as defined in claim 11, wherein the particulate inorganic material has a hollow structure.

15. The anti-reflection film as defined in claim 3, which comprises an overcoat layer as an outermost layer, the overcoat layer comprising at least one compound selected from the group consisting of a fluorine-containing compound, a silicon-containing compound and a long chain alkyl-containing compound having four or more carbon atoms.

16. The anti-reflection film as defined in claim 8, wherein
the high refractive index layer comprises an inorganic particulate material comprising mainly titanium dioxide, the titanium dioxide containing at least one selected from the group consisting of cobalt, aluminum and zirconium, and
the high refractive index layer has a refractive index from 1.55 to 2.50.

17. A method of producing an anti-reflection film as defined in claim 1.

18. A polarizing plate comprising: a polarizing layer; and at least one protective film, wherein the at least one protective film is an anti-reflection film as defined in claim 1.

19. A polarizing plate comprising: a polarizing layer; and two protective film, wherein one of the two protective film is an anti-reflection film as defined in claim 1, and the other of the two protective film is an optically anisotropic optical compensation film.

20. An image display comprising an anti-reflection film as defined in claim 1, which is disposed on a surface of the image display.

21. The image display as defined in claim 20, which is a liquid crystal display, wherein the liquid crystal display is one of TN, STN, VA, IPS or OCB mode liquid crystal displays and is one of transmission type, reflection type or semi-transmission type liquid crystal displays.
